(19) United States
(12) Patent Application Publication
(10) Pub. No.: US 2006/0055968 A1
(43) Pub. Date: Mar. 16, 2006

(54) Job processing method, data processing system, data processing apparatus, computer program, and storage medium

(75) Inventors: Hirochika Sato, Kawasaki-Shi (JP); Kazuhiko Ushiyama, Edogawa-Ku (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/264,144

(22) Filed: Nov. 2, 2005

Related U.S. Application Data
(63) Continuation of application No. PCT/JP05/12937, filed on Jul. 13, 2005.

(30) Foreign Application Priority Data
Jul. 26, 2004 (JP) 2004-217773
Jul. 5, 2005 (JP) 2005-196815

(51) Int. Cl. G06F 3/12

(52) U.S. Cl. 358/1.15

(57) ABSTRACT

An object of this invention is to improve user friendliness of the box function. In a system having a storage means capable of storing data in a plurality of data storage boxes including first and second boxes, when the first job data transmitted without performing any predetermined operation by the user in the data generation apparatus is stored in the storage means, acceptance of a process request for the first job data from the first user via the first display associated with the first box on a user interface is permitted. When the second job data transmitted after performing the predetermined operation by the user is stored in the storage means, acceptance of a process request for the second job data from the first user via the first display associated with the first box on the user interface is permitted. In addition, acceptance of a process request for the second job data from the second user via the second display associated with the second box on the user interface is permitted.

### TECHNICAL FIELD

The present invention relates to a job processing method for a system including a data processing apparatus capable of storing data in a plurality of boxes, a data processing system, a data processing apparatus, a computer program, and a storage medium.

### BACKGROUND ART

There has conventionally been known a technique of temporarily storing, in the memory (e.g., hard disk) of a data processing apparatus (e.g., image forming apparatus), image data read by a scanner, or image data prepared by bitmapping PDL data sent from a host computer via a network. According to this technique, image data of an arbitrary document is repetitively read out from a memory and printed out.

Some image forming apparatuses of this type can connect a finisher having finishing functions such as stapling, punching, folding, and bookbinding functions.

There is also proposed an image forming apparatus in which the settings of the finishing functions, and job process conditions (e.g., double-sided printing) can be saved as job information together with input image data in the memory (e.g., hard disk) of the apparatus. The function of the data processing apparatus (e.g., image forming apparatus) is also called a box function. By using the box function, a plurality of storage areas (to be referred to as “boxes” hereinafter) can be so assigned as to be used for each user or each department. There is also proposed a method of designating an arbitrary box by the user and printing image data desired by the user under process conditions desired by the user (see, e.g., patent reference 1).
Patent Reference 1: Japanese Patent Laid-Open No. 11-146115

### DISCLOSURE OF INVENTION

### Problems that the Invention is to Solve

However, the box function of the above-mentioned apparatus has a limitation that only one box can be designated as a recording destination (save destination) by one job. For example, when document data is to be saved in a box prepared in the hard disk of the image forming apparatus, document data to be processed (a series of document data by one job) cannot be simultaneously saved in a plurality of boxes. In this situation, to save the same document data in a plurality of boxes in the conventional image forming apparatus, the user must repeat the same operation a plurality of number of times. For example, to save the same job in three boxes, the user must repeat a series of user operations three times: designation of a box, setting of printing conditions (setting of job information), and input of a job into a box.

The data processing apparatus should cope with a situation in which the same job data is distributed and stored in a plurality of boxes desired by the user among a plurality of boxes prepared in the memory of the data processing apparatus. On the assumption of this situation, there should be provided a mechanism capable of distributing and saving the same job data in a plurality of boxes desired by the user by simple operation. The burden on the user is desirably minimized to improve operability.

In addition, it is considered more preferable to deal with the following situation. For example, when a conventional configuration as disclosed in the above reference is adopted, it is expected that the same image data is stored in a plurality of boxes. In the conventional configuration, it is expected that the same image data and their pieces of job information must be saved by the number of boxes. That is, in the conventional configuration, when image data are identical but have different job information, it is expected that the same image data must be repetitively recorded in a plurality of boxes in correspondence with the pieces of job information. Hence, the same image data is stored repetitively in different boxes in a memory (e.g., hard disk) which is a limited resource, thus limiting efficient use of the memory.

Therefore, demands have arisen for a user-friendly, convenient system capable of flexibly meeting various needs from Various users for the box function provided by the data processing apparatus.

The present invention has been made in consideration of the above situation, and has as its object to provide a job processing method, data processing system, data processing apparatus, computer program, and storage medium which can improve user friendliness of the box function.

### Means of Solving the Problems

In order to solve the above problems, according to the present invention, a job processing method for a system including a data processing apparatus having storage means capable of storing data in a plurality of data storage boxes including a first box and a second box is characterized by comprising
when first job data transmitted from a data generation apparatus is stored in the storage means without performing any predetermined operation by a user in the data generation apparatus, permitting acceptance of a process request for the first job data from a first user via first display which is executed by user interface means and associated with the first box, and
when the predetermined operation is performed by the user in the data generation apparatus and second job data transmitted from the data generation apparatus is stored in the storage means, permitting acceptance of a process request for the second job data from the first user via the first display which is executed by the user interface means and associated with the first box, and permitting acceptance of a process request for the second job data from a second user via second display which is executed by the user interface means and associated with the second box.

In order to solve the above problems, the present invention is characterized by a data processing system and data processing apparatus which are characterized by executing the job processing method, a computer program for causing a computer to execute the job processing method, or a computer-readable storage medium which stores the computer program.

### Effect of the Invention

The present invention can improve user friendliness of the box function.

The present invention can flexibly cope with a situation in which the same job data is distributed and stored in a plurality of boxes desired by the user among a plurality of boxes prepared in the storage unit of the data processing apparatus. The present invention can provide a mechanism capable of distributing and saving the same job data in a plurality of boxes desired by the user by simple operation. In addition, the present invention can minimize the burden on the user to improve operability.

Further, for example, the present invention can preferably record a job to process image data in a plurality of boxes by one job, and reduce the amount of data recorded in each box to efficiently use the memory.

Moreover, for example, the present invention can provide a user-friendly, convenient system which can flexibly meet various needs from various users for the box function provided by the data processing apparatus.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

FIG. 1 is a view for explaining the configuration of a network-compatible printing system according to an embodiment of the present invention;

FIG. 2 is a block diagram showing the detailed configuration of an image forming apparatus 100 in FIG. 1 according to the embodiment of the present invention;

FIG. 3 is a sectional view showing an image forming apparatus main body 101 in FIG. 2 on which a finisher is mounted according to the embodiment of the present invention;

FIG. 4 is a view showing an example of the key layout of an operation unit 102 of the image forming apparatus 100 according to the embodiment of the present invention;

FIG. 5 is a view showing an example of the logical use method of an image memory 107 of the image forming apparatus 100 according to the embodiment of the present invention;

FIG. 6 is a view showing an example of a window displayed on an LCD 316 when a box key 305 of the operation unit 102 of the image forming apparatus 100 is touched according to the embodiment of the present invention;

FIG. 7 shows an example of a box content window displayed on the LCD 316 of the operation unit 102 of the image forming apparatus 100 according to the embodiment of the present invention;

FIGS. 8A and 8B are flowcharts for explaining a box registration process sequence using the image forming apparatus 100 according to the embodiment of the present invention;

FIG. 9 is a view showing an example of a recording structure when image data and its job information are stored in a box area;

FIG. 10 is a view showing an example of a recording structure when image data on a new document and its job information are stored in each box area in the state shown in FIG. 9;

FIG. 11 is a flowchart for explaining a detail storage process when a plurality of boxes are designated as recording destinations of new image data and its job information in step S805 of FIGS. 8A and 8B;

FIG. 12 is a view showing an example of an operation window (user interface) which is displayed on the LCD 316 of the operation unit 102 shown in FIG. 4;

FIG. 13 shows an example of a user interface window provided by a host 300 serving as an example of a data generation apparatus according to the embodiment;

FIG. 14 shows another example of the user interface window provided by the host 300 serving as an example of the data generation apparatus according to the embodiment;

FIG. 15 shows still another example of the user interface window provided by the host 300 serving as an example of the data generation apparatus according to the embodiment;

FIG. 16 shows still another example of the user interface window provided by the host 300 serving as an example of the data generation apparatus according to the embodiment;

FIG. 17 shows still another example of the user interface window provided by the host 300 serving as an example of the data generation apparatus according to the embodiment;

FIG. 18 shows an example of a user interface window provided by the image forming apparatus 100 serving as an example of a data processing apparatus according to the embodiment;

FIG. 19 shows another example of the user interface window provided by the image forming apparatus 100 serving as an example of the data processing apparatus according to the embodiment;

FIG. 20 shows still another example of the user interface window provided by the image forming apparatus 100 serving as an example of the data processing apparatus according to the embodiment;

FIG. 21 shows still another example of the user interface window provided by the host 300 serving as an example of the data generation apparatus according to the embodiment;

FIG. 22 shows still another example of the user interface window provided by the image forming apparatus 100 serving as an example of the data processing apparatus according to the embodiment;

FIG. 23 shows still another example of the user interface window provided by the image forming apparatus 100 serving as an example of the data processing apparatus according to the embodiment;

FIG. 24 shows still another example of the user interface window provided by the image forming apparatus 100 serving as an example of the data processing apparatus according to the embodiment;

FIG. 25 shows still another example of the user interface window provided by the image forming apparatus 100 serving as an example of the data processing apparatus according to the embodiment;

FIG. 26 shows still another example of the user interface window provided by the image forming apparatus 100 serving as an example of the data processing apparatus according to the embodiment;

FIG. 27 shows still another example of the user interface window provided by the image forming apparatus 100 serving as an example of the data processing apparatus according to the embodiment;

FIG. 28 shows still another example of the user interface window provided by the image forming apparatus 100 serving as an example of the data processing apparatus according to the embodiment;

FIG. 29 shows still another example of the user interface window provided by the image forming apparatus 100 serving as an example of the data processing apparatus according to the embodiment;

FIG. 30 shows still another example of the user interface window provided by the image forming apparatus 100 serving as an example of the data processing apparatus according to the embodiment;

FIG. 31 is a view for explaining an example of the data structure status of a box prepared in the hard disk 107;

FIG. 32 shows still another example of the user interface window provided by the image forming apparatus 100 serving as an example of the data processing apparatus according to the embodiment;

FIG. 33 shows still another example of the user interface window provided by the image forming apparatus 100 serving as an example of the data processing apparatus according to the embodiment;

FIG. 34 shows still another example of the user interface window provided by the image forming apparatus 100 serving as an example of the data processing apparatus according to the embodiment; and

FIG. 35 shows still another example of the user interface window provided by the image forming apparatus 100 serving as an example of the data processing apparatus according to the embodiment.

### BEST MODE FOR CARRYING OUT THE INVENTION

An image forming apparatus according to an embodiment of the present invention will be described in detail below with reference to the accompanying drawings.

The following embodiment will exemplify an image forming apparatus serving as a digital multi-functional apparatus having a plurality of functions (to be also referred to as “modes”) such as a copy function, print function, and facsimile function, and a printing system having the image forming apparatus.

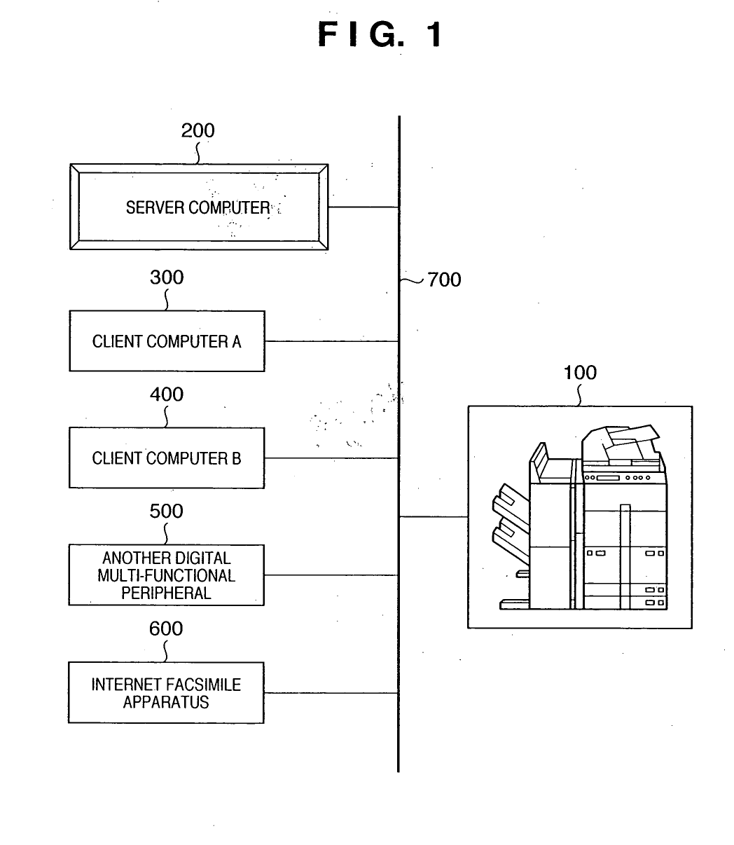

FIG. 1 is a view for explaining the configuration of a network-compatible printing system according to the embodiment of the present invention. In FIG. 1, an image forming apparatus 100 can communicate various data (transmit/receive data) via a communication medium 700 such as a network with a server computer 200, client computers A (300) and B (400) such as host computers, a digital multi-functional peripheral 500 serving as another image forming apparatus having, e.g., the same configuration and functions as those of the image forming apparatus 100, and an Internet facsimile apparatus 600. The image forming apparatus 100 may communicate data wirelessly.

The image forming apparatus 100 has a plurality of modes (plurality of functions) such as a copy mode, print mode, and facsimile mode. The image forming apparatus 100 can cause its printer unit to perform a printing process via the storage unit (e.g., hard disk) of the apparatus 100 for job data read by the scanner unit of the apparatus 100, job data output from the client computers 300 and 400, job data output from the scanner of the digital multi-functional peripheral 500, job data output from the Internet facsimile apparatus 600, or the like. Further, the image forming apparatus 100 can transfer the job data to anther apparatus via the communication unit of the apparatus 100, and execute various output processes.

As a mechanical structure, the image forming apparatus 100 comprises an auto document feeder (so-called ADF) capable of successively, sequentially reading a plurality of document sheets automatically from the first page. The image forming apparatus 100 comprises a plurality of sheet feed units (sheet feed cassettes) in its printer unit. The sheet feed units can store printing sheets of different medium types (different in printing paper size, printing paper type, and the like). A sheet can be selectively fed from a sheet feed unit desired by the user, and subjected to printing by the printer unit.

The image forming apparatus 100 has a so-called sorting function of performing a sorting process for sheets printed by the printer unit, a stapling function of performing a stapling process for printing sheets, a punching function of performing a punching process (to be also referred to as a “punch process”) for a printing sheet printed by the printer unit, and a saddle stitch function of performing a folding process and bookbinding process for a sheet printed by the printer unit. The printer unit is equipped with a finisher as a sheet processing device for executing these sheet process functions.

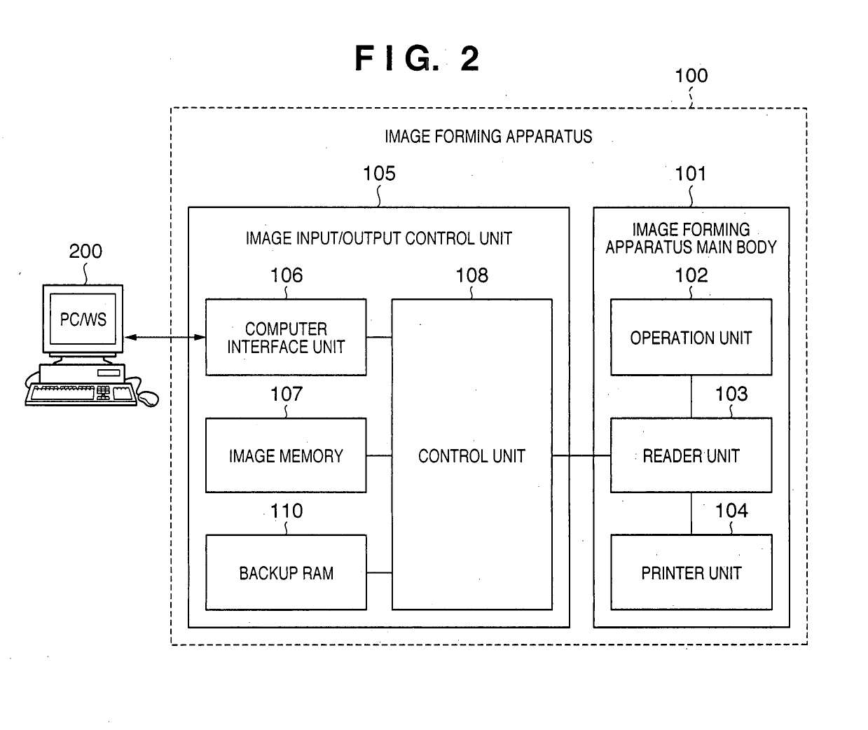

FIG. 2 is a block diagram showing the detailed configuration of the image forming apparatus 100 in FIG. 1 according to the embodiment of the present invention. As shown in FIG. 2, the image forming apparatus 100 according to the embodiment is roughly formed from an image forming apparatus main body 101 and image input/output control unit 105. The image forming apparatus main body 101 comprises an operation unit 102, reader unit (scanner unit) 103, and printer unit 104.

The operation unit 102 is used to operate the image forming apparatus main body 101 and image input/output control unit 105. For example, the operation unit 102 comprises a touch panel type liquid crystal display unit and mechanical hard keys, and prompts the operator to make various settings. The reader unit 103 has a document feeder such as an ADF, executes a read process for a document image set on the document table, and outputs the read image data to the printer unit 104 and image input/output control unit 105. The printer unit 104 prints image data from the reader unit 103 and image input/output control unit 105 on a printing medium such as a printing sheet under printing process conditions set for job data.

The image input/output control unit 105 comprises a control unit 108 connected to the reader unit 103, a computer interface unit 106 connected to the network 700, an image memory 107, and a backup RAM 110.

The computer interface unit 106 functions as an external communication unit, and is an interface between the print server (server computer) 200 which is formed from a personal computer, work station (PC/WS), or the like, another external apparatus (each apparatus connected to the communication medium 700 shown in FIG. 1), and the control unit 108. The computer interface unit 106 rasterizes code data (PDL) which is transferred from the server computer 200 and represents an image into image data which can be printed by the printer unit 104, and transfers the image data to the control unit 108. The computer interface unit 106 transmits/receives various data (e.g., command data, status request information, status information, and time data) other than image data to/from these external apparatuses. The data flow between the reader unit 103, the computer interface unit 106, and the image memory 107 is controlled by the control unit 108.

The backup RAM 110 holds data even upon power-off, and saves important data which must be backed up in the image forming apparatus main body 101 and image input/output control unit 105. That is, the backup RAM 110 comprises a storage area capable of storing and holding a plurality of job data (a series of image data), and can store and hold image data, job data, and the like input from the reader unit 103 and external apparatus.

As described above, according to the embodiment, a plurality of print job data can be stored in the backup RAM 110 and sequentially processed. For example, even while the printer unit 104 executes printing operation for a given print job, print job data (image data) can be accepted on request from an external apparatus or the reader unit (scanner unit) 103 of the image forming apparatus 100.

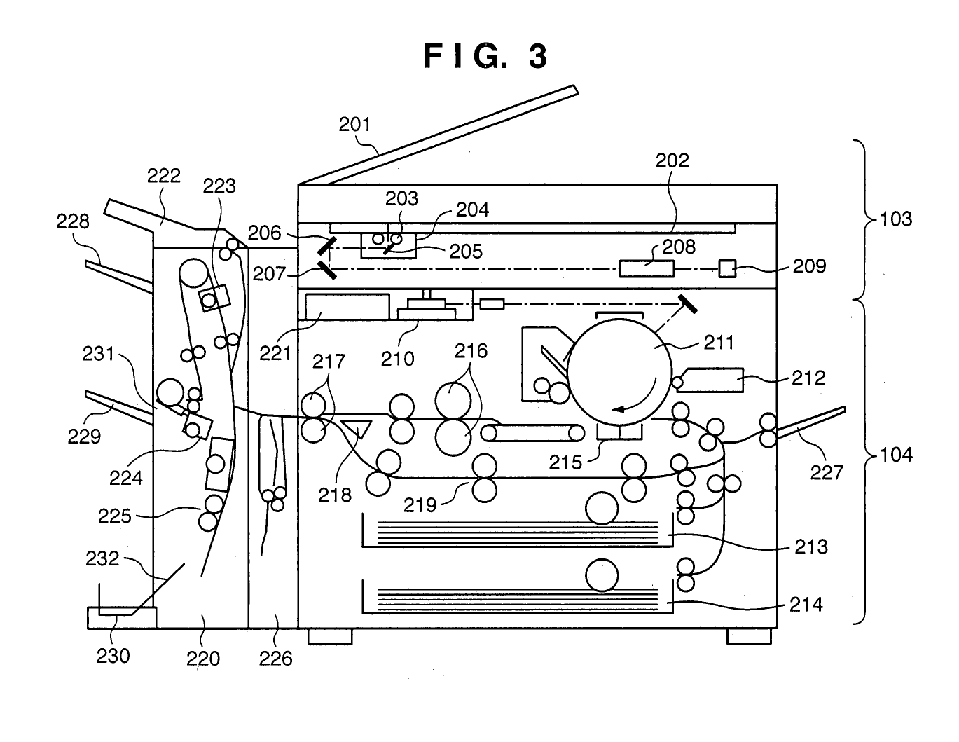

FIG. 3 is a sectional view showing the image forming apparatus main body 101 in FIG. 2 on which a finisher is mounted according to the embodiment of the present invention. As shown in FIG. 3, a document feed device 201 feeds document sheets one by one from the first sheet onto a platen glass 202, and at the end of document read operation, discharges the document sheet from the platen glass 202.

When a document is conveyed onto the platen glass 202, a lamp 203 is turned on, and a scanner unit 204 starts moving to expose and scan the document. Light reflected by the document is guided to a CCD image sensor (to be referred to as a “CCD” hereinafter) 209 by mirrors 205, 206, and 207 and a lens 208. The scanned document image is read by the CCD 209.

A laser driver 221 drives a laser-emitting unit 210, and causes the laser-emitting unit 210 to emit a laser beam corresponding to output image data. The laser beam irradiates a photosensitive drum 211, and a latent image corresponding to the laser beam is formed on the photosensitive drum 211. A developer is attached from a developing unit 212 to the latent image on the photosensitive drum 211. For example, a color image forming apparatus is equipped with developing units of four colors: yellow, magenta, cyan, and black.

A printing sheet is fed from any one of cassettes 213 and 214 and a manual sheet feed stage 227 at the timing synchronized with the start of irradiation with a laser beam. The printing sheet is conveyed to a transfer unit 215, and the developer attached to the photosensitive drum 211 is transferred onto the printing sheet. The printing sheet bearing the developer is conveyed to a fixing unit 216, and the developer is fixed onto the printing sheet by the heat and pressure of the fixing unit 216. The printing sheet having passed through the fixing unit 216 is discharged via discharge rollers 217.

When double-sided printing is set, a printing sheet is conveyed to the discharge rollers 217, the rotational direction of the discharge rollers 217 is reversed, and then the printing sheet is guided to a sheet refeed convey path 219 by a flapper 218. The printing sheet guided to the sheet refeed convey path 219 is fed to the transfer unit 215 at the above-mentioned timing.

When the image forming apparatus is equipped with a Z-folding unit 226, a printing sheet is conveyed to the Z-folding unit and Z-folded in accordance with an operation from the operation unit 102. When the image forming apparatus is equipped with a finisher 220, discharged printing sheets are bundled and sorted, punched by a puncher 223, or stapled by a stapler 224 in accordance with designation by the user. When a saddle stitcher 225 is used, printing sheets are stitched at the center, folded at the center, and bookbound.

An inserter 222 can feed, as a cover or slip sheet, a sheet which has undergone printing in advance, and in addition, can convey a paper sheet without any damage because the paper sheet does not pass through the printing sheet path of the printer unit. For a job which does not use the saddle stitcher 225, a paper sheet passes through a delivery port 231 and is discharged to either of movable trays 228 and 229. Both of the movable trays 228 and 229 can move vertically, and when a paper sheet is to be output to the movable tray 228, the movable tray 228 is moved down to the position of the delivery port 231. For a job which uses the saddle stitcher 225, a paper sheet passes through the delivery port 232 and is discharged to a booklet tray 230.

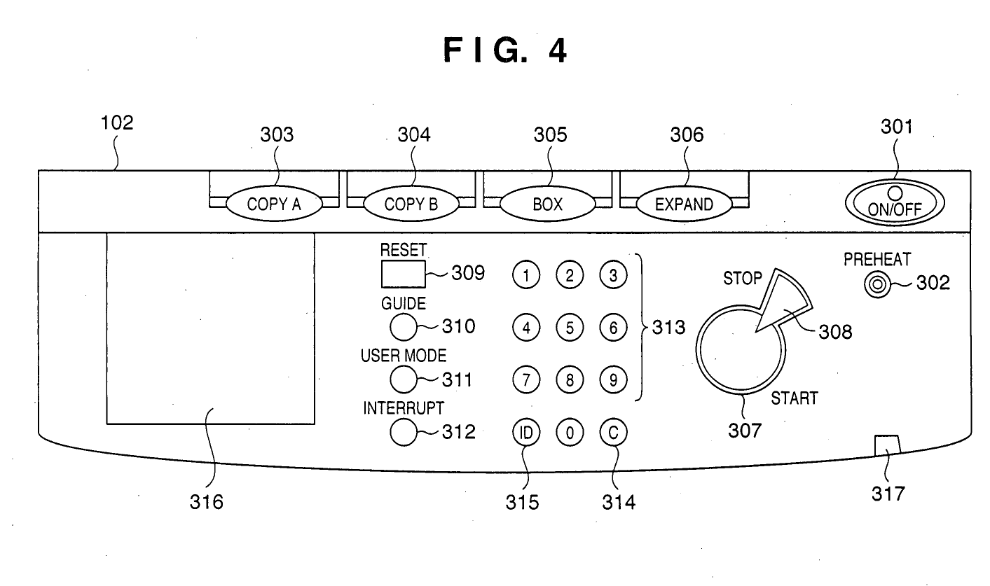

FIG. 4 is a view showing an example of the key layout of the operation unit 102 of the image forming apparatus 100 according to the embodiment of the present invention. As shown in FIG. 4, the operation unit 102 comprises an LCD 316 serving as a display unit, and a mechanical hard key area. In FIG. 4, reference numeral 301 denotes a power switch which controls power supply to the main body. Reference numeral 302 denotes a preheat key which is used to switch the ON/OFF state of the preheat mode. Reference numeral 303 denotes a copy A mode key which is used to select a copy A mode from a plurality of functions. Reference numeral 304 denotes a copy B mode key which is used to select a copy B mode from a plurality of functions. Copy A and copy B provide the same copy function, but the embodiment describes the two copy modes separately for easy understanding of the user in order to permit input of the next copy when read of one copy by the scanner ends.

Reference numeral 305 denotes a mail box key which is used to select a mail box mode from a plurality of functions. For the mail box function, a recording area is ensured in the internal memory of the image forming apparatus for each user or each department, and PDL data or scanned image data is stored in the recording area. The mail box function allows the user to output the stored data at an arbitrary timing. Reference numeral 306 denotes an expansion key which is used to manipulate PDL data.

The keys 303 to 306 are used to invoke various function windows (to be described later) and display them on the LCD 316. The user can check the status of each executed job from a window displayed on the LCD 316. Reference numeral 307 denotes a copy start key which is used to designate the start of copying. Reference numeral 308 denotes a stop key which is used to suspend or stop copying. Reference numeral 309 denotes a reset key which is used to return to a standard mode on standby.

Reference numeral 310 denotes a guide key which is used when the user wants to know, e.g., details of each function of the image forming apparatus. Reference numeral 311 denotes a user mode key which is used when the user changes basic settings of the system. Reference numeral 312 denotes an interrupt key which is used to interrupt a job in execution (e.g., during copying) and execute another job (e.g., another copying). Reference numeral 313 denotes a ten-key pad which is used to input a numerical value. Reference numeral 314 denotes a clear key which is used to clear a numerical value. Reference numeral 315 denotes an ID key which is used to shift to an ID input mode when the copying machine is used.

The LCD 316 functions as an LCD touch panel which is a combination of a liquid crystal screen and touch sensor, and displays a setting window unique to each mode. The user touches a key or the like on the LCD 316, and can input various detailed settings. The LCD 316 also displays the operation statuses of various jobs and the like. Reference numeral 317 denotes a tally lamp which represents a network communication state. The tally lamp 317 normally lights in green, blinks in green during communication, and lights or blinks in red when a network error occurs. Note that the UI is not limited to a touch panel type, and may be implemented by a key-operable configuration with a pointing device such as a mouse. In any form, the UI suffices to provide both a display function of displaying various types of information and an operation instruction function of inputting various instructions from the user.

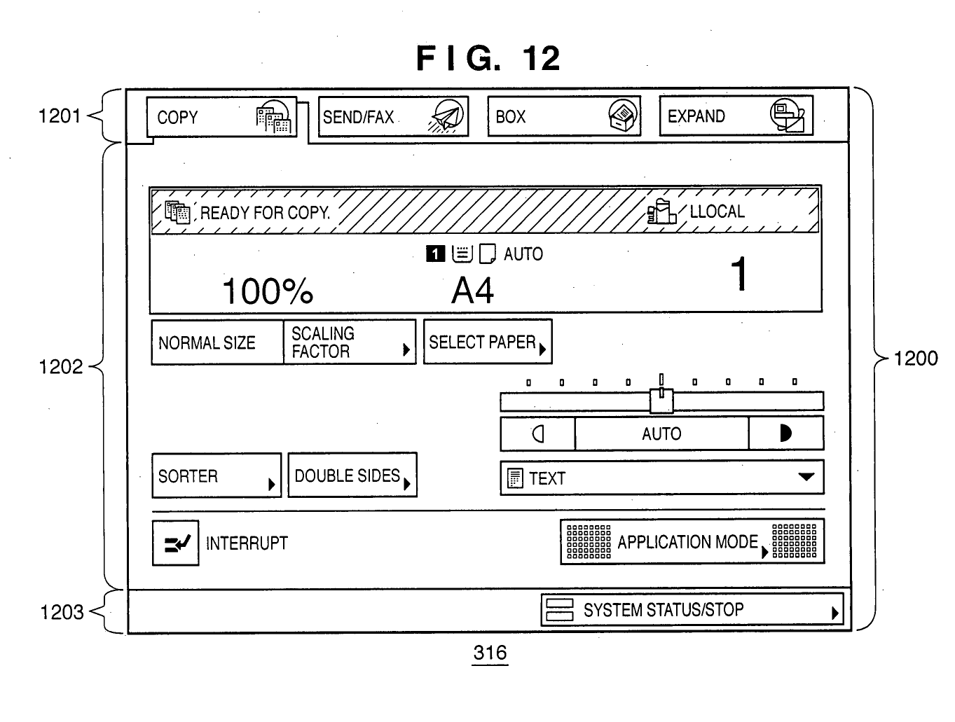

Various operation window examples which are displayed on the LCD 316 of the operation unit 102 under display control by the control unit 108, and various operation control examples based on user operation via these windows will be explained with reference to FIG. 12 and the like.

FIG. 12 is a view showing an example of an operation window (user interface) which is displayed on the LCD 316 of the operation unit 102 shown in FIG. 4. As shown in FIG. 12, a display window 1700 displayed on the LCD 316 mainly has three display building components.

One display building component is a function selection area 1201 having operation instruction keys (operation buttons) for prompting the user to select a desired operation mode from a plurality of operation modes (to be also referred to as functions) of the image forming apparatus 100. The second display building component is a process condition setting area 1202 having operation instruction keys for allowing the user to set various process conditions (e.g., print setting parameters) for job data (image data) to be processed in an operation mode selected via the function selection area 1201. The third building component is a status display area 1203 capable of notifying the user of various types of status information representing the operation status of the image forming apparatus 100 (including operation status information (e.g., during read of image data or during printing), various types of error information (e.g., document jam, printing sheet jam, and staple jam), and various types of warning information (e.g., shortage of toner and shortage of paper)).

In this manner, the embodiment provides these three display building components as contents of a window displayed on the LCD 316. The display of the process condition setting area 1202 is so controlled as to represent display contents corresponding to a mode selected in the function selection area 1201. The display of the function selection area 1201 is so controlled as to function even upon a shift to another window (e.g., a function can be selected on an operation window which displays the function selection area 1201 even upon a shift to another window). The display of the status display area 1203 is so controlled as to allow the user to always confirm status information of the image forming apparatus regardless of a shifted window (e.g., a status line 1703 is displayed on the display unit regardless of a switched window).

The image forming apparatus 100 has a copy mode in which job data (image data) from the reader unit 103 such as a scanner is printed by the printer unit 104 via the image memory 107 such as a hard disk. The image forming apparatus 100 also has an external print mode in which job data from an external apparatus such as the client computer 300 or 400, digital multi-functional peripheral 500, or facsimile apparatus 600 is printed by the printer unit 104 via the image memory 107 such as a hard disk. The image forming apparatus 100 also has a box mode in which job data output from the reader unit 103 or job data output from the external apparatus is stored and held in a predetermined storage area (box area) in the image memory 107 such as a hard disk, and after the job data is stored in the box, desired job data is selected via the operation unit 102, printed by the printer unit 104, or transmitted to an external apparatus via the computer interface unit 106. The image forming apparatus 100 according to the embodiment has a plurality of operation modes including at least two operation modes. However, the image forming apparatus is not limited to this, and may be of a single-functional type having only one operation mode.

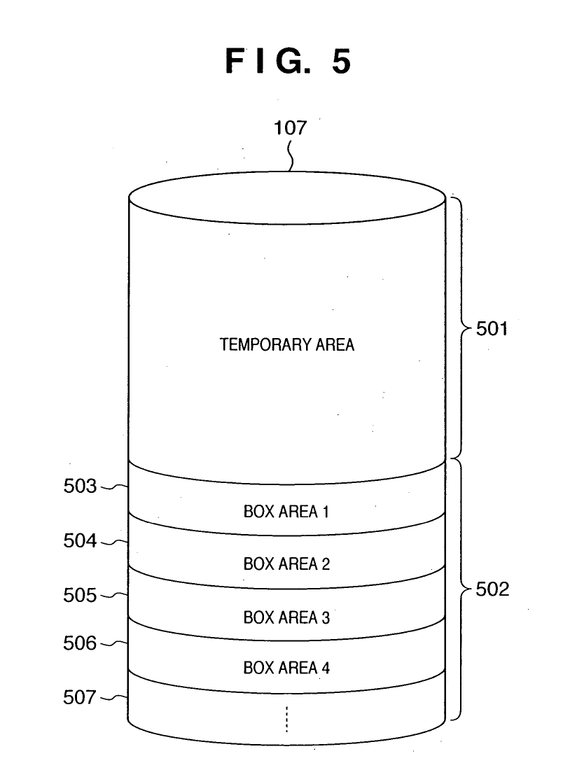

FIG. 5 is a view showing an example of the logical use method of the image memory 107 of the image forming apparatus 100 according to the embodiment of the present invention. In the embodiment, the recording area in the image memory 107 such as a hard disk is logically separately used as a temporary area 501 and box area 502 in accordance with the use purpose. The temporary area 501 is a recording area which temporarily records PDL-rasterized data or image data from the scanner in order to, for example, change the output order of image data or output a plurality of copies by one scanning.

The total box area 502 is a recording area for using the box function, and is divided into a plurality of smaller recording areas (boxes) 503 to 507, as shown in FIG. 5. The boxes 503 to 507 are assigned to respective users or respective departments of a company or the like. By designating a box, the user can input a PDL job or scan job in the box, actually confirm the contents of a box, change settings, and print out.

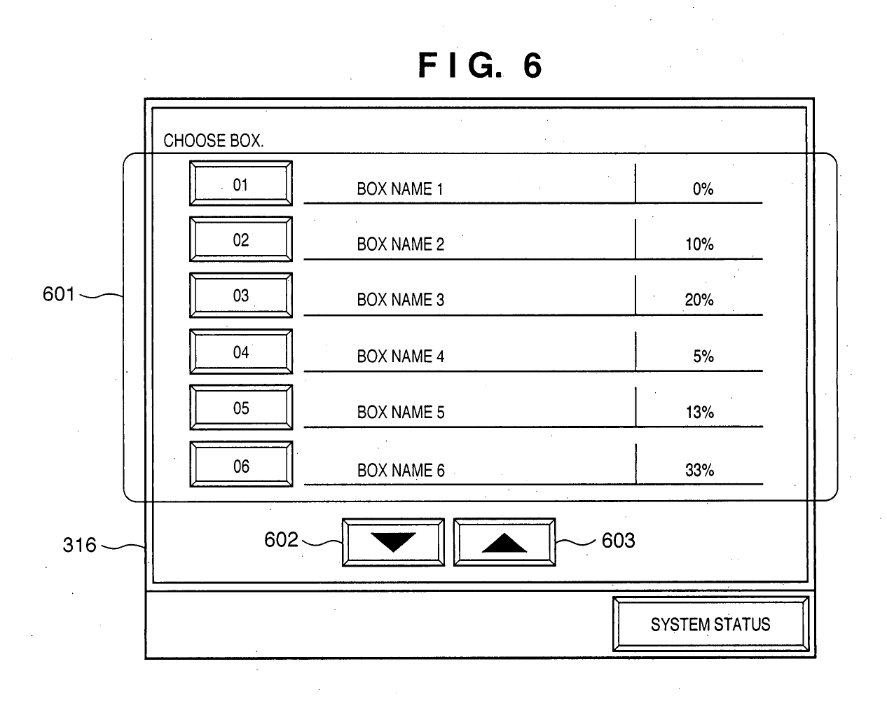

FIG. 6 is a view showing an example of a window displayed on the LCD 316 when the box key 305 of the operation unit 102 of the image forming apparatus 100 is touched according to the embodiment of the present invention. This window prompts the user to select a box. In FIG. 6, a display area 601 displays various types of information such as the box number and box name of each box and the capacity of the box which occupies the total box area 502 in the image memory 107. Reference numerals 602 and 603 denote up and down scroll keys which are used to scroll the window when boxes exceeding various displays represented by reference numeral 601 are registered.

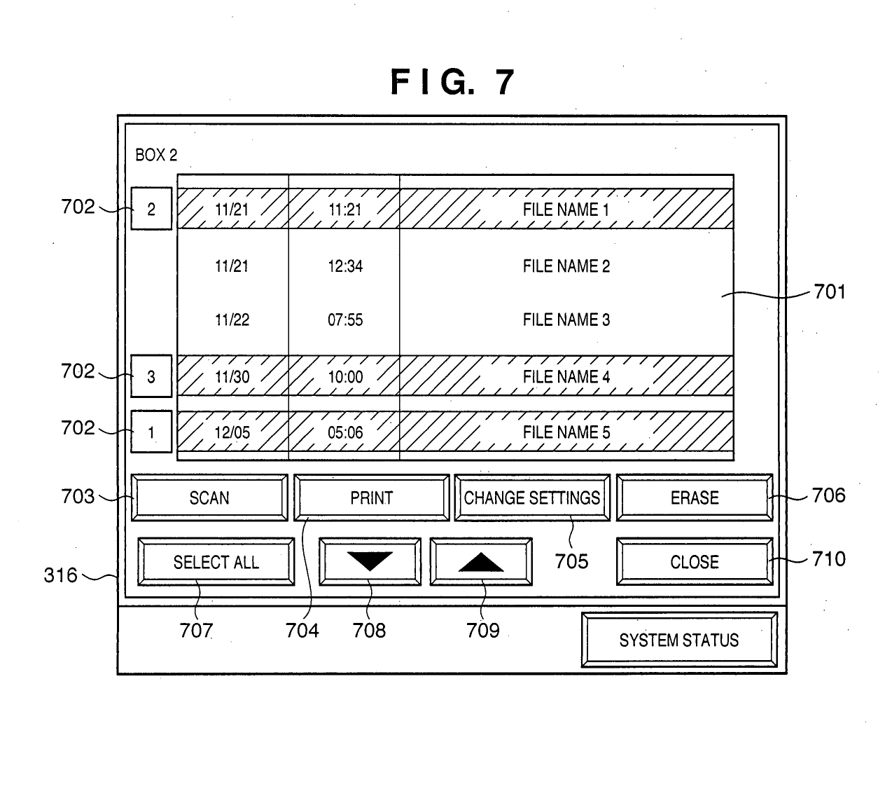

When the user touches one of box numbers in the window displayed on the LCD 316 shown in FIG. 6, the window changes to a box content window shown in FIG. 7, and the user can access each box. FIG. 7 shows an example of the box content window displayed on the LCD 316 of the operation unit 102 of the image forming apparatus 100 according to the embodiment of the present invention. In FIG. 7, reference numeral 701 denotes a list of files which are stored in a box, and the list 701 represents the registration date and time of each file, its file name, and the like. For example, to select a desired file, the file name of the file is touched. Then, the currently selected file is highlighted. This display is based on toggle operation, and when a selected file name is touched again, selection is canceled.

Reference numeral 702 denotes display which represents the selection order of selected files. In the window example shown in FIG. 7, “file name 5”, “file name 1”, and “file name 4” are selected in an order named. Reference numeral 703 denotes a scan key which is used to input an image from the scanner into a currently open box, and shifts the window to a scan setting window (not shown). Reference numeral 704 denotes a print key which is used to print a file selected from the list 701.

Reference numeral 705 denotes a setting change key which is used to change the print settings of a selected file. The setting change key 705 can be touched only when the number of selected files is one. Note that setting change items by the setting change key 705 include the number of print copies and addition of the print mode.

Reference numeral 706 denotes an erase key which is used to erase a file selected from the list 701. Reference numeral 707 denotes a select-all key which is used to select all files displayed in the list 701. When all files are selected with the select-all key 707, the selection order is kept unchanged from, e.g., a display order in the list 701. Alternatively, the order may be designated after selection. Reference numerals 708 and 709 denote up and down scroll keys which are used to scroll the window 701 when files exceeding the display of the window 701 are registered. Reference numeral 710 denotes a close key which is used to return to the window shown in FIG. 6.

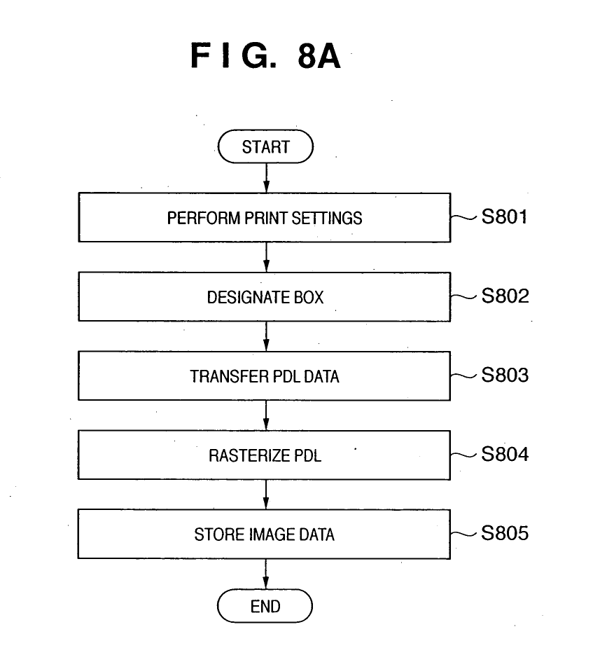

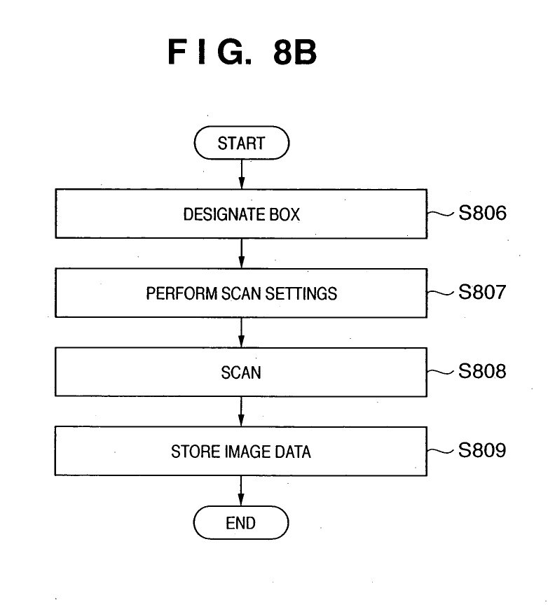

FIGS. 8A and 8B are flowcharts for explaining a box registration process sequence using the image forming apparatus 100 according to the embodiment of the present invention. The process of registration in a box includes registration of an image (to be referred to as a “PDL image” hereinafter) based on PDL data input from a host computer 109 via a network, and registration of a scanned image from the scanner. The respective registration processes are shown in FIGS. 8A and 8B.

When a PDL image is to be registered, the user performs print settings on the PC 109 (step S801). The contents of print settings are, e.g., the number of copies, paper size, scaling factor, single-/double-sided printing, page output order, sort output, and stapling/non-stapling. By setting a box number on the PC 109, an area in the box area 502 of the image memory 107 is designated (step S802). For example, when a box number “1” is designated, the box area 503 in the total box area 502 is designated. When box numbers “1” and “2” are designated, the box areas 503 and 504 in the total box area 502 are designated.

Simultaneously when the user instructs the PC 109 to print, driver software installed in the PC 109 converts code data to be printed into so-called PDL data, and transfers the PDL data to the image input/output control unit 105 of the image forming apparatus together with the print setting parameters set in step S801 (step S803). The transferred PDL data is rasterized into image data (step S804).

After rasterization of the image data is completed in step S804, the rasterized image data are sequentially recorded (stored) in the total box area 502 of the image memory 107 (step S805). For example, for the box number “1”, the image data are recorded in the box area 503. At this time, the print setting parameters set in step S801 are also recorded in the box area 503. For example, for the box numbers “1” and “2”, the rasterized image data and print setting parameters are recorded in the box areas 503 and 504. For the box numbers “2” and “3”, the rasterized image data and print setting parameters are recorded in the box areas 504 and 505. Details of the process of recording image data and print setting parameters when a plurality of box numbers are designated will be described later.

When a scanned image is to be registered, the number of a box to which image data is input is designated (step S806). Then, scan settings such as an image process are designated (step S807). The start of scanning is designated, and the reader unit 103 reads a document (step S808). The image read in step S808 is stored in a box area designated in step S806 (step S809).

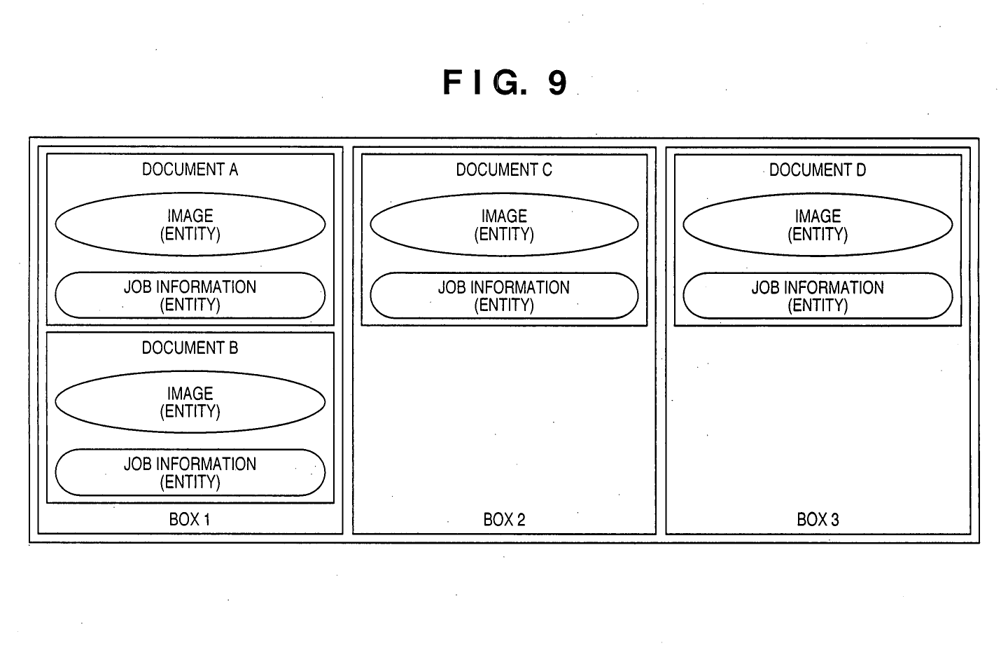

Details of the process of recording image data and print setting parameters when a plurality of box numbers are designated will be explained with reference to FIGS. 9 to 11. FIG. 9 is a view showing an example of a recording structure when image data and its job information are stored in a box area. In FIG. 9, documents A and B are recorded in box area 1 shown in FIG. 6; document C, in box area 2; and document D, in box area 3.

Each of documents A to D shown in FIG. 9 means document information. Each document information contains an image data file (image (entity)) and job information (job information (entity)). The job information contains finishing information (e.g., the number of print copies and stapling), print attributes associated with an entire document (e.g., the number of pages contained in the document and double-sided information), and print attributes associated with each page (e.g., the resolution of the page, paper size, and the number of pixels).

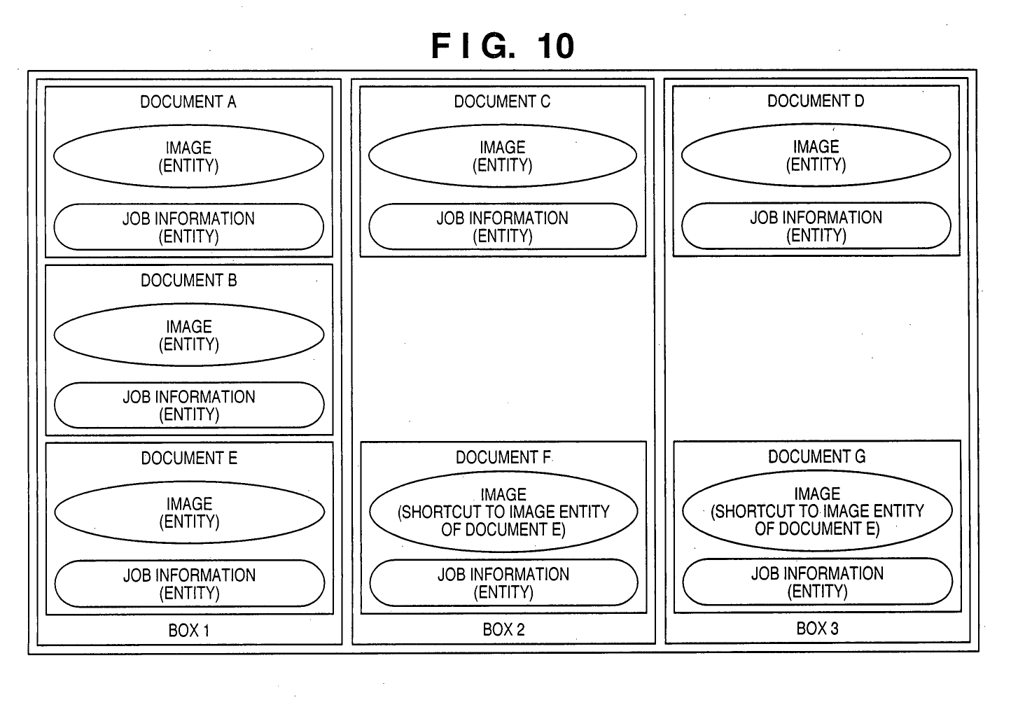

The state of each box area after a plurality of jobs for which box areas 1 to 3 are designated as recording destinations of a new document are input to box areas in the state shown in FIG. 9 will be explained. FIG. 10 is a view showing an example of a recording structure when image data on a new document and its job information are stored in each box area in the state shown in FIG. 9.

In FIG. 10, image data input from the host computer 109 in accordance with a job which designates a plurality of boxes, and job information of the image data are recorded as document E in box area 1. A shortcut to the image data recoded in box area 1, and a copy of the job information recorded in box area 1 are recorded as document F in box area 2. Further, a shortcut to the image data recoded in box area 1, and a copy of the job information recorded in box area 1 are recorded as document G in box area 3.

The image forming apparatus according to the embodiment has a recording structure in which, for image data which may have a large data amount, a shortcut to the image data is recorded instead of its copy, thereby efficiently using the memory. In the embodiment, not a shortcut but a copy of job information is recorded in a box area because a setting change function operable with the setting change key 705 shown in FIG. 7 can be utilized. Since the setting change function can change the number of output copies contained in job information and add finishing settings, different pieces of job information for processing an image must be given to respective documents even for the same image.

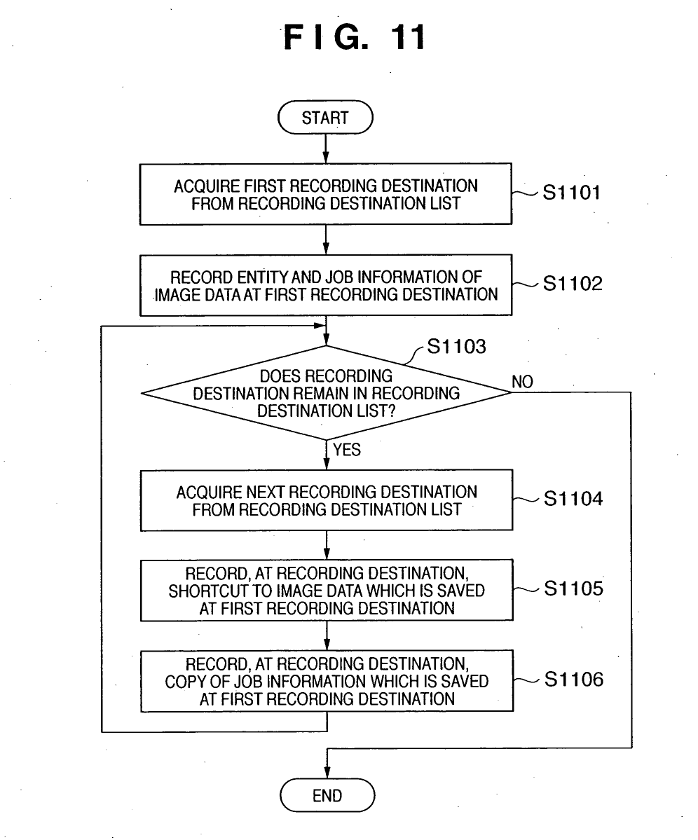

FIG. 11 is a flowchart for explaining a detail storage process when a plurality of boxes are designated as recording destinations of new image data and its job information in step S805 of FIGS. 8A and 8B.

A box area which is registered at the start of a list of a plurality of recording destinations for recording new image data supplied from the host computer 109 and its job information is acquired (step S1101). The new image data and its job information are recorded in the acquired box area (step S1102). It is determined whether an unrecorded box area exists in the recording destination list (step S1103). If an unrecorded box area exists (YES), the flow advances to step S1104; if no unrecorded box area exists (NO), the flow ends.

In step S1104, one of unrecorded box areas is acquired from the list of remaining recording destinations. A shortcut to the image data recorded in step S1102 is created and recorded in the acquired box area (step S1105). A copy of the job information recorded in step S1102 is created and recorded in the box area (step S1106), and then the flow returns to step S1103. In this way, image data and its job information are recorded when a plurality of boxes are designated as recording destinations of the image data and its job information.

By using the image forming apparatus according to the embodiment, when pieces of job information are given for the same image data, these pieces of job information for executing a process of the image data are recorded in respective box areas. The original image data is recorded in any box, and a shortcut to the original image data is recorded in the remaining boxes. The same image data need not be repetitively recorded in boxes which require the same image data, and a hard disk or the like necessary to record repetitive image data can be efficiently used.

A concrete supplementary explanation of control which is disclosed in the embodiment and includes the explanations of FIGS. 9 to 11 will be made. Especially, operations and user interfaces for use by the image forming apparatus 100 serving as an example of the data processing apparatus and a data generation apparatus serving as a data transmitting side which transmits data of a job to be processed to the apparatus 100 when the box function according to the embodiment is implemented will be exemplified. In other words, an example of operation control of the whole data processing system according to the embodiment including the data processing apparatus and data generation apparatus will be explained.

Concrete examples of the data generation apparatus serving as a data generation source in the embodiment are the computers 200, 300, and 400 and the devices 500 and 600 in FIG. 1. The reader unit 103 mounted in the image forming apparatus 100 also functions as a data generation source, and corresponds to an example of the data generation apparatus. This is because the reader unit 1 also generates image data and transmits data to the printer unit 104, and in addition, the operation unit 102 serving as an example of the user interface is set on the housing of the reader unit 1. Note that any system/apparatus configuration can be adopted as far as it can implement various control operations disclosed in the embodiment.

In this case, control will be explained using the client computer 300 (to be referred to as the host 300 hereinafter) in which downloading of the printer driver of the image forming apparatus 100 is completed. As a method of downloading the printer driver of the apparatus 100, for example, data is downloaded from a homepage via the Internet, or a storage medium such as a CD-ROM is set in the host 300 and data is downloaded from the storage medium.

First, for example, an application such as document creation software is activated in the host 300. The host 300 opens a file of document data to be processed on the display unit (display) of the operation unit of the host 300.

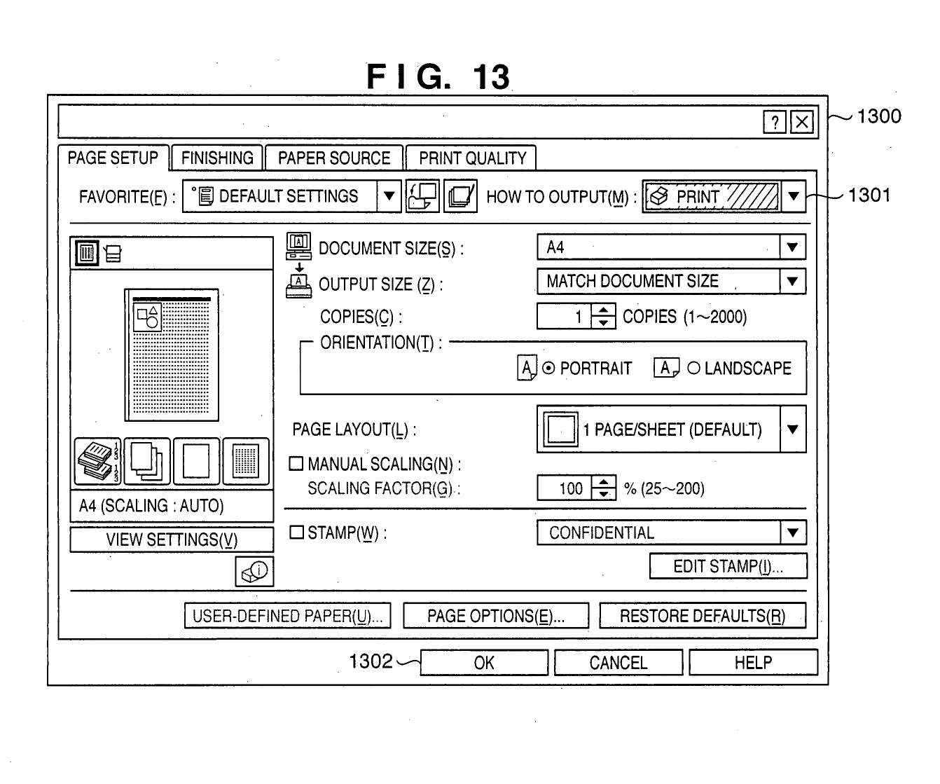

Then, assume that the user of the host 300 performs predetermined key operation by using the operation instruction unit of the host 300 (e.g., the keyboard of the host 300 or a pointing device such as a mouse). In response to this, the control unit of the host 300 displays a window 1300 in FIG. 13 on the display unit of the host 300. The user interface window in FIG. 13 is an example of the printer driver window of the image forming apparatus 100.

In the embodiment, the control unit of the host 300 controls the host 300 so that an operation mode to be executed by the image forming apparatus 100 can be selected by the user via a mode selection key 1301 in the window 1300 displayed on the display unit of the host 300.

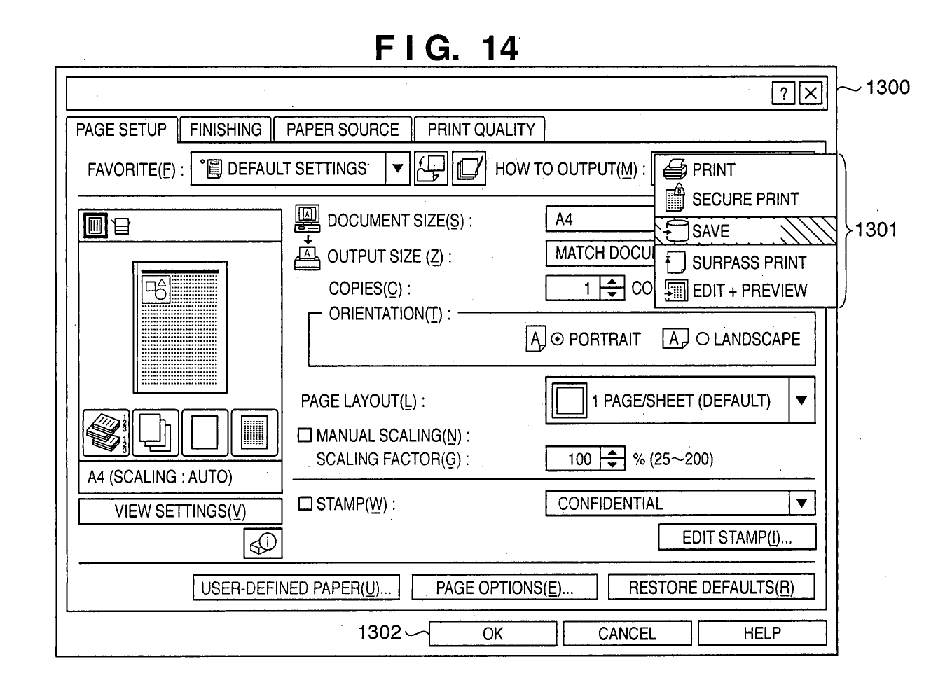

For example, in response to the click of the key 1301 by the user of the host 300 with the mouse, the control unit of the host 300 causes the display unit of the host 300 to execute display as shown in FIG. 14.

For example, the user selects the “print mode” via the mode selection column 1301 and clicks an OK key 1302. In this case, the control unit of the host 300 transmits, to the image forming apparatus 100 via the network 700 as data of a job to be processed by the image forming apparatus 100, (1) print data (in this example, document data), (2) job information such as printing conditions, and (3) a print mode execution command and the like.

Upon reception of the job data via the interface unit 106, the control unit 108 controls the image forming apparatus 100 to execute an operation corresponding to an instruction from the host 300. More specifically, the “print mode” is designated as an operation mode by the host 300. Hence, the control unit 108 causes the printer unit 104 to execute a printing process for print data of the job via the hard disk of the image memory 107 on the basis of printing conditions set via the printer driver window 1300 of the host 300.

In the embodiment, an operation mode for job data to be processed which is input from the data generation apparatus is controlled to be selected by the user of the data generation apparatus via the mode selection column 1301 of the printer driver 1300. In addition to the print mode, a secure print mode, overtaking print mode, and the like are also controlled in a selectable manner.

Further, in the embodiment, the “save mode” is controlled to be selected by the user via the mode selection column 1301 of the printer driver 1300 serving as an example of the user interface unit.

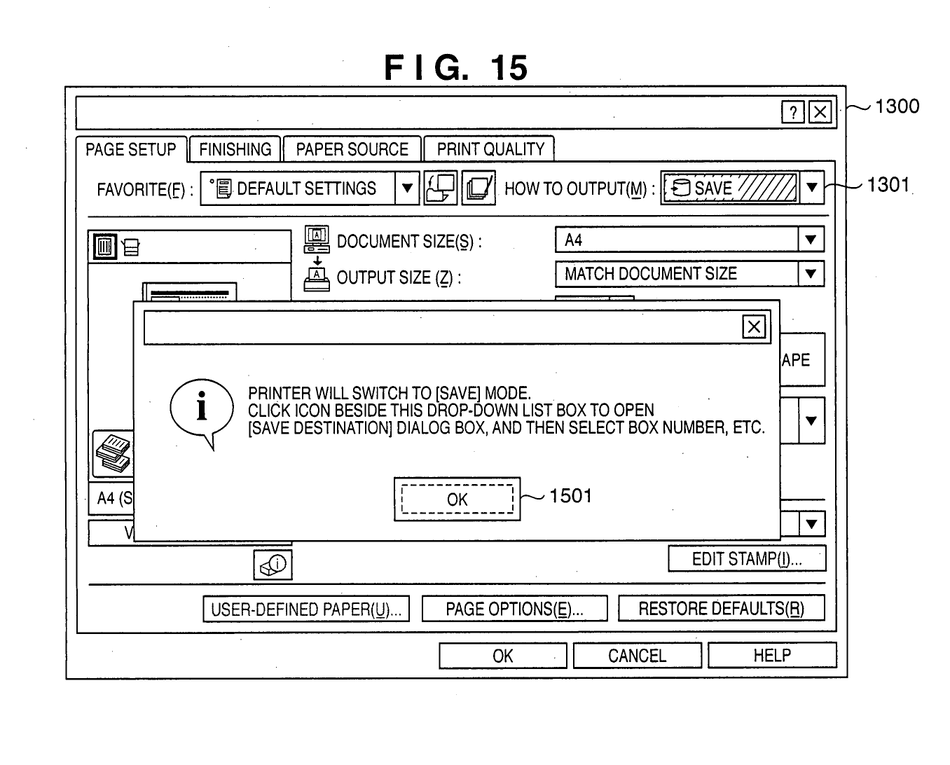

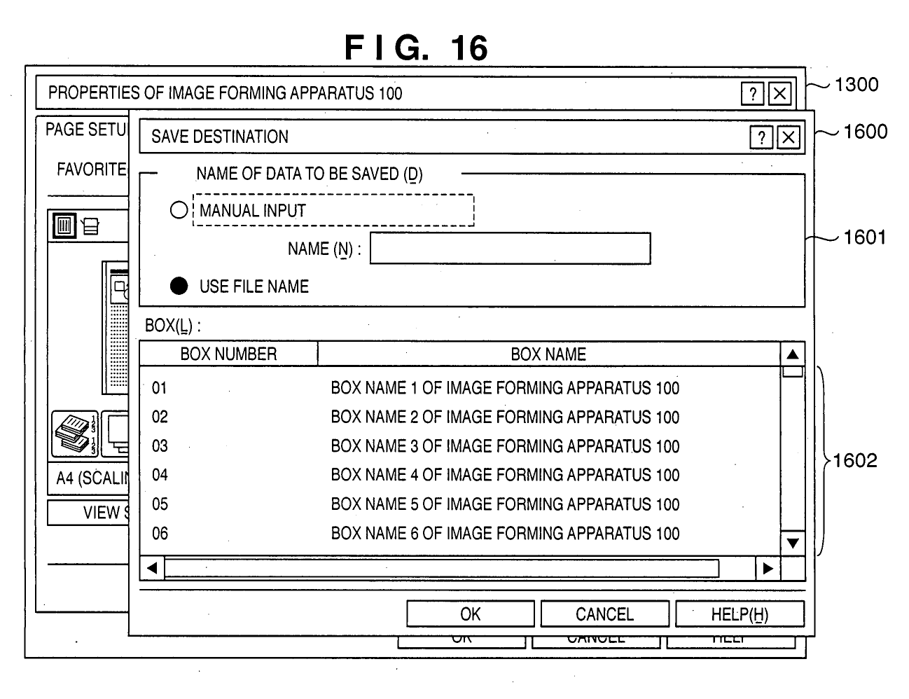

For example, the user selects the “save mode” via the mode selection column 1301 of the printer driver window 1300 shown in FIG. 14, and clicks the OK key 1302. In response to this, the control unit of the host 300 displays a dialog window as shown in FIG. 15 on the display unit of the host 300. The dialog window shows the guidance of an operation to be performed by the user, and prompts the user to confirm the operation. In response to the click of a key 1501 by the user of the host 300, the control unit of the host 0300 displays a box setting window 1600 shown in FIG. 16 on the display unit of the host 300.

The window 1600 in FIG. 16 is displayed by the host 300 under the control of the control unit of the host 300 when the save mode is selected by the user via the printer driver window 1300 in the host 300.

The window 1600 is an example of a user interface for allowing the user of the host 300 to select which of a plurality of boxes (100 boxes in the embodiment) present in the internal hard disk of the image memory 107 of the image forming apparatus 100 is to save job data to be transmitted from the host 300. The user can execute, e.g., the following operation via the window 1600 in the host 300 serving as an example of the data generation apparatus.

(1) The name of job data (print data) to be saved in the box of the image forming apparatus 100 from the host 300 can be input by the user of the host 300 via a name entry column 1601 of the window 1600. At this time, the user can select whether the file name of a file created by the application of the host 300 is directly used or the file name is changed and input from the keyboard via the window 1600.

(2) When job data to be transmitted from the host 300 is to be saved in a box in the hard disk of the image forming apparatus 100, which of a plurality of boxes is to save the job data to be processed can be selected by the user of the host 300 via a box selection list 1602.

Details of operation (2) will be explained. A list of boxes provided by the image forming apparatus 100 serving as a job data receiving side is displayed in the box selection list 1602 of the box setting window 1600 which is displayed on the display unit of the host 300. The box numbers of boxes which are provided by the image forming apparatus, and box names which have been registered in advance by the user via the operation unit 102 of the image forming apparatus 100 are displayed in the list 1602 so that the user can identify the boxes. The information reflects information which is acquired via a network from, for e.g., a currently selected image forming apparatus, i.e., the apparatus 100. For example, in the list 1602, a name “box name 1 of the image forming apparatus 100” is registered in association with box number 1. Note that a box whose box name is not registered can also be utilized.

In the embodiment, the control unit of the host 300 controls the host 300 so as to cope with two operations when the user of the host 300 selects only one box for saving job data and selects a plurality of boxes.

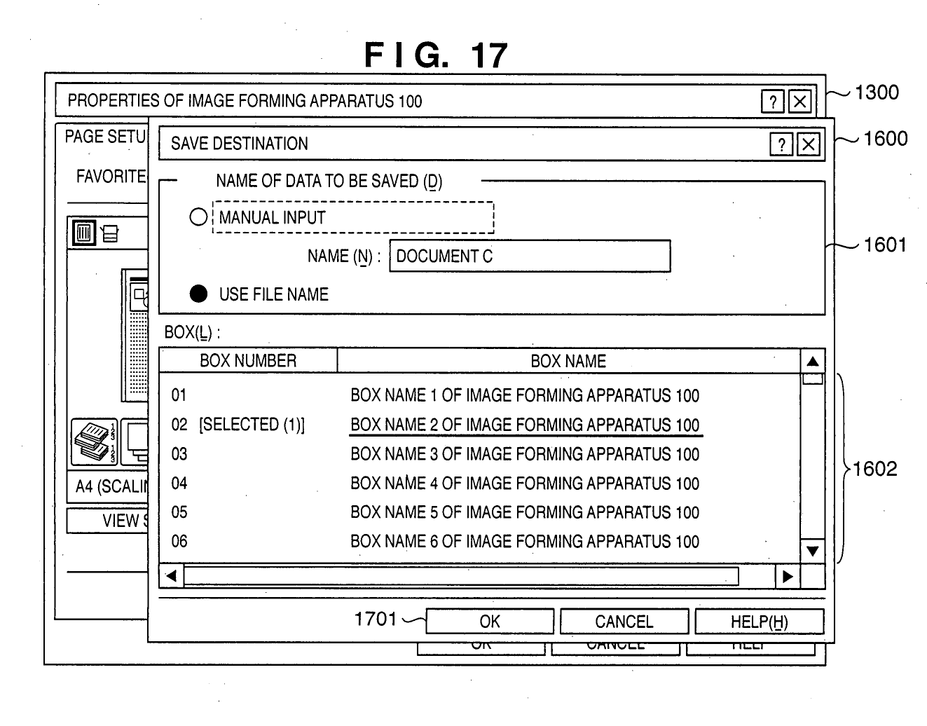

The former operation will be explained with reference to FIGS. 9 and 17. A case wherein document data transmitted from the host 300 is saved in the box of box number 2 among a plurality of boxes (e.g., 100 boxes) ensured in the hard disk of the image forming apparatus 100 will be exemplified.

For example, when data of document C which is created by the host 300 and made up of six pages is to be saved in box 2 while the file name is directly utilized, the user of the host 300 checks a column “use a file name” in the name entry column 1601 of the box setting window 1600 by mouse operation. In response to this, the control unit of the host 300 sets the file name of document C in the name entry column 1601, as shown in FIG. 17. After that, box number 2 is selected via the box selection list 1602 by key operation by the user of the host 300. In response to box selection operation, the control unit of the host 300 controls the display unit of the host 300 so as to reflect the selection status in the list 1602. In the display state of FIG. 17, only one box of box number 2 is selected at present.

When an OK key 1701 of the window 1600 is clicked upon setting a series of process conditions to the image forming apparatus 100 by the user in the host 300, the control unit of the host 300 returns to the printer driver window 1300 in FIG. 13.

In response to the click of the OK key 1302 of the window 1300 by the user of the host 300, the host 300 transmits the job data to the image forming apparatus 100. More specifically, the host 300 transmits (1) image data (6-page print data) of document C, (2) job information such as process conditions for data of document C (including various printing process conditions such as paper size “A3 size”, the number of output copies “three copies”, finishing setting “sort”, and double-sided printing setting), and (3) command data which notifies the control unit 108 of the image forming apparatus 100 of “the operation mode of the image forming apparatus 100 is the save mode, and a box to save the data is the box of box number 2”.

When the image forming apparatus 100 receives job data input from the host 300 upon a series of settings, the control unit 108 controls the image forming apparatus 100 in the following manner on the basis of various instructions from the host that are contained in the job data.

(1) Entity image data and job information of document C (six pages) that are received from the host 300 are associated with each other and saved in a storage area (box area 504 in FIG. 5) assigned to the box of box number 2 in the hard disk 107 of the image forming apparatus 100. The data storage status in the box area 504 of box 2 at this time is, e.g., a state as shown in FIG. 9.

(2) The user interface unit (including the operation unit 102 and display unit 316 in FIG. 4) of the image forming apparatus 100 is controlled so that various manipulations to the job data saved in the box of box number 2 can be executed by the user of the image forming apparatus 100 via the operation unit 102 of the image forming apparatus 100.

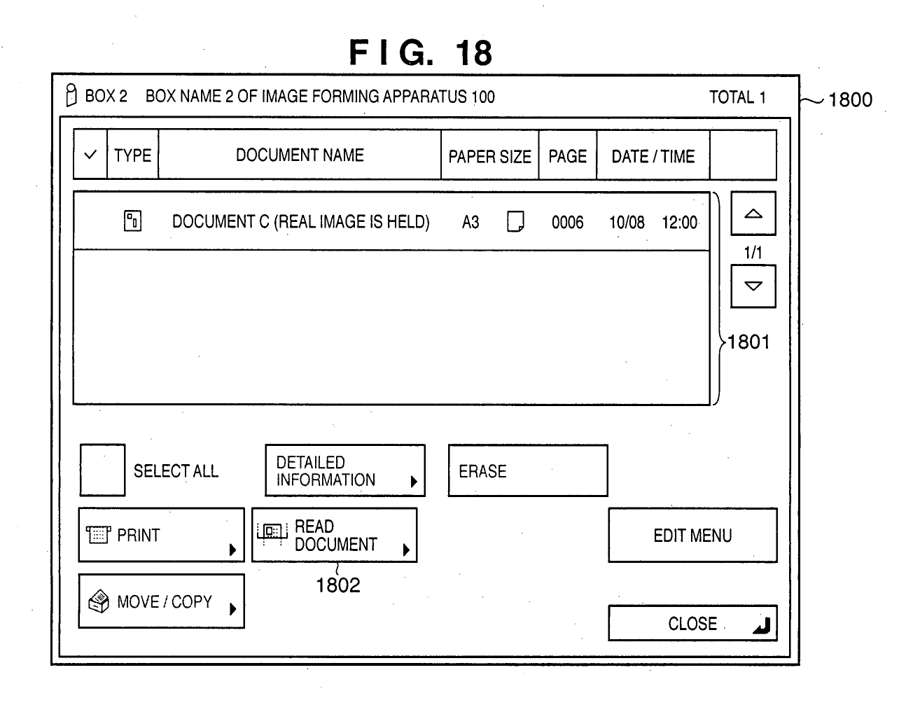

A concrete example of operation (2) will be described. For example, when the user touches a “box” key in the window of FIG. 12 which is displayed on the display unit 316 of the operation unit 102 of the image forming apparatus, the control unit 108 of the image forming apparatus 100 displays the box selection window in FIG. 6 on the display unit 316. When the user selects the box of box number 2 from the box selection list 601, the control unit 108 displays a box document selection window 1800 in FIG. 18 on the display unit 316.

The window 1800 is a user interface for allowing the user to execute various manipulations for data in a box selected by the user in the box selection window of FIG. 6. A user instruction to store data in the currently selected box (in this case, box 2) via the window 1800 can be accepted via a document read key 1802. Also, various instructions such as an instruction to print, by the printer unit 104, data which is saved in the box area 502 of the hard disk 107 in association with the box, and an instruction to transmit data to an external apparatus can be accepted from the user.

Note that data which is saved in the box area 502 of the hard disk 107 in association with the box is not only actual entity image data which is saved in the box. In the embodiment, the data also includes entity image data which is stored in the box area of another box and can be read out from the hard disk 107 of the apparatus 100 on the basis of the shortcut function of the embodiment.

In the example of FIG. 18, the user selects the box of box number 2 in the window of FIG. 6, and the control unit 108 displays the document selection window 1800 for the box of box number 2 on the display unit 316.

In the embodiment, the user can select document data to be output via a document selection list 1801 of the box document selection window 1800. In addition, the control unit 108 controls the display unit 316 to display a list of selectable candidates. Further, the control unit 108 controls the display unit 316 to display information which allows the user to identify which document is stored in a selected box. In this example, the control unit 108 controls the display unit 316 to display name information of document C, paper size information of the job, the number of pages, and the date and time of storage in the box on the basis of an instruction from the prin driver of the host 300, as described with reference to FIGS. 13 to 17.

In the embodiment, the display unit 316 also displays identification information for allowing the user to identify which of the currently selected box or another box saves actual entity image data of document data whose information is displayed in the box document selection window 1800 during browsing. For example, the control unit 108 controls the display unit 316 to display “real image is held” near the display area of the document name in the document selection list 1801.

In this fashion, the control unit 108 displays, on the display unit 316, identification information for allowing the user to identify that entity image data of document data whose name is document C is saved in the currently selected box (box area 504) corresponding to box number 2. In addition, the control unit 108 displays, on the display unit 316, information for allowing the user to identify that the document has been saved on October 8, 12:00. The control unit 108 also displays, on the display unit 316, information for allowing the user to identify that the document is made up of six pages in A3 size.

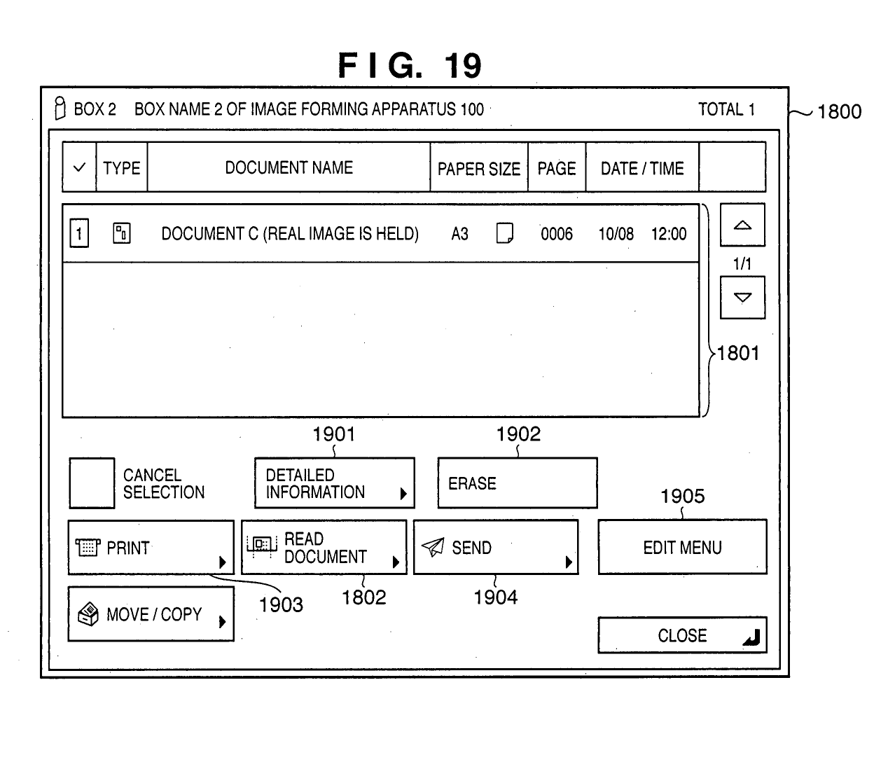

Assume that the user selects document C from the list 1801 in the window 1800 of FIG. 18. More specifically, the display unit 316 is a touch panel, and document C can be selected by touching the display line of document C in the list with a user's finger. In response to this operation, the control unit 108 changes the window to a display state as shown in FIG. 19. FIG. 19 shows a display state when the user selects a desired document in the window of FIG. 18.

As shown in FIG. 19, in response to selecting a document by the user from the list 1801, the control unit 108 changes the display state of the list 1801 so that the user can identify which document has been selected.

In response to selecting the document by the user from the list 1801, the control unit 108 displays, below the display area of the list 1801 in the window 1800, a display key for allowing the user to input various instructions to the selected document.

For example, as shown in FIG. 19, the control unit 108 displays a detailed information key 1901 for allowing the user to input an instruction to display, on the display unit 316, detailed information of a document selected from the list 1801 of the window 1800. The control unit 108 displays an erase key 1902 for allowing the user to input an instruction to erase, from the hard disk 107, document data selected from the list 1801 of the window 1800. The control unit 108 displays a print key 1903 for allowing the user to input an instruction to execute a printing process by the printer unit 104 for document data selected from the list 1801 of the window 1800. The control unit 108 displays a send key 1904 for allowing the user to input an instruction to execute a transmission process by the interface unit 106 for document data selected from the list 1801 of the window 1800. The control unit 108 displays an edit key 1905 for allowing the user to input an instruction to execute an editing process and preview display for document data selected from the list 1801 of the window 1800.

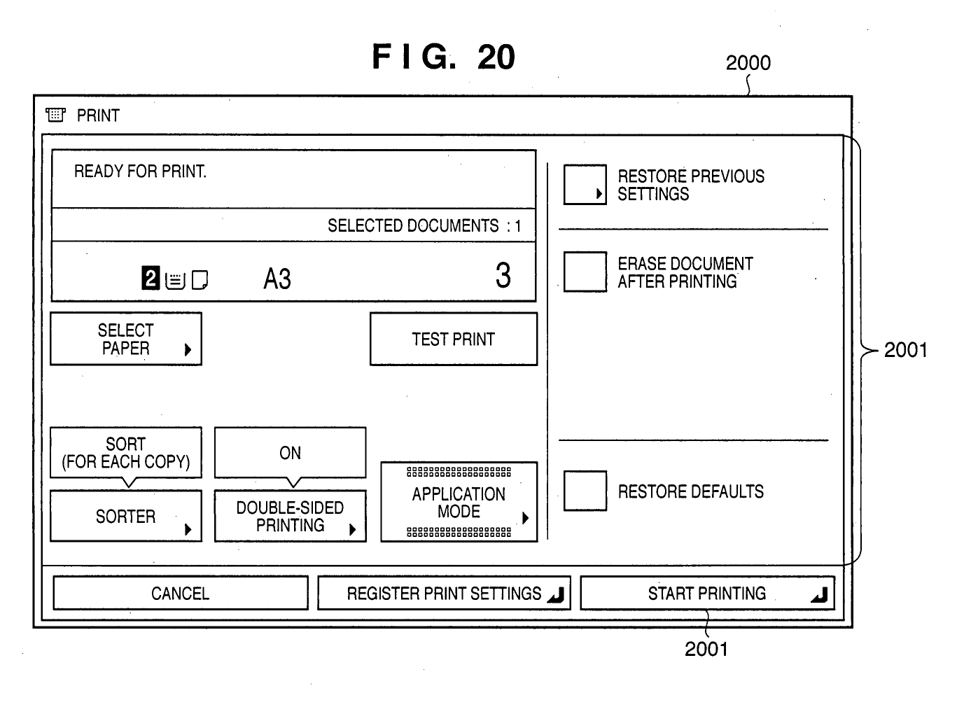

For example, the user touches the print key 1903 in the window state of FIG. 19. In response to this, the control unit 108 displays a window 2000 shown in FIG. 20 on the display unit 316. The window 2000 in FIG. 20 is a print setting window displayed on the display unit 316 when the printer unit 104 executes a printing process for a document selected by the user from the list 1801 of the box document selection window 1800.

The control unit 108 controls display so that process conditions (job information) that have been set in advance for a document selected from the list 1801 are referred to from the box area and the parameters are reflected in the window 2000.

For example, currently selected document C of six pages is input from the host 300 to box 2 in the save mode after various printing process conditions (e.g., paper size “A3 size”, the number of output copies “three copies”, finishing setting “sort”, and double-sided printing setting) are set via the printer driver 1300 of the host 300. These parameters are reflected and displayed in a display area 2001 of the window in FIG. 20.

In addition, the control unit 108 displays, in the window 2000, a display key for allowing the user to change process conditions which have already been set for a selected document (in this example, paper size “A3 size”, the number of output copies “three copies”, finishing setting “sort”, and double-sided printing setting). For example, a “select paper” key, “sorter” key, “double-sided print” setting key, and the like are displayed in the area 2001 of the window 2000, as shown in FIG. 20. The control unit 108 also displays, in the window 2000, a print start key 2002 for accepting from the user an instruction to actually start a printing process by the printer unit 104.

When the user changes process conditions for the selected document and then touches the print start key 2002, the control unit 108 causes the printer unit 104 to execute a printing process for currently selected document C under the process conditions which have been changed via the window 2000. When the user touches the print start key 2002 without changing the process conditions for the selected document by the user, the control unit 108 causes the printer unit 104 to execute a printing process for currently selected document C under the preset process conditions (in this example, paper size “A3 size”, the number of output copies “three copies”, finishing setting “sort”, and double-sided printing setting).

Actual entity image data of document C is stored in the box storage area 504 corresponding to box number 2 in the hard disk 107. Further, job information (including various printing process condition data, document name data, the box storage date and time, and page count information described above) for document F is also registered in the box area 504 in association with the image data of document C. In response to operation by the user, the control unit 108 reads out the entity image data and job information of document C from the box area 504 of the hard disk 107, and causes the apparatus 100 to process document C on the basis of an instruction which is input by the user via the operation unit 102.

The description with reference to FIGS. 13 to 20 is directed to control executed when only one of a plurality of boxes prepared in the hard disk 107 of the image forming apparatus 100 (corresponding to an example of the data processing apparatus) is selected by the user of the host 300 (corresponding to an example of the data generation apparatus) via the user interface of the host 300, and job data is input from the host 300 to the box of the image forming apparatus 100. The series of box operations can also be provided to another box.

For example, document A is selected by the user in a host computer (300, 400, or the like). Also, the “save mode” is selected via the operation mode selection column 1301 of the printer driver 1300. One “box 1 of the image forming apparatus 100” is selected via the box selection window 1600 of the printer driver 1300. Various process conditions for document A are set via the printer driver 1300. Then, the OK key 1302 of the printer driver 1300 is clicked to transmit job data from the host to the image forming apparatus 100.

In this case, the control unit 108 saves data (entity image data) of document A, and job information set for document A (including information (e.g., the number of pages) unique to image data, and printing process conditions set by the user for the image data) in the box area 503 corresponding to box number 1 in the hard disk 107. If the user selects the box of box number 1 via the window in FIG. 6 that is displayed on the display unit 316 of the operation unit 102 of the image forming apparatus, the control unit 108 controls to display the box document selection window 1800 for box number 1 so as to execute the same processes as those described with reference to FIGS. 18 to 20.

For example, document D is selected by the user in a host computer (300, 400, or the like). The “save mode” is selected via the operation mode selection column 1301 of the printer driver 1300. One “box 3 of the image forming apparatus 100” is selected via the box selection window 1600 of the printer driver 1300. Various process conditions for document D are set via the printer driver 1300. Then, the OK key 1302 of the printer driver 1300 is clicked to transmit job data from the host to the image forming apparatus 100.

In this case, the control unit 108 saves data (entity image data) of document D, and job information set for document D (including information (e.g., the number of pages) unique to image data, and printing process conditions set by the user for the image data) in the box area 505 corresponding to box number 3 in the hard disk 107. If the user selects the box of box number 3 via the window in FIG. 6 that is displayed on the display unit 316 of the operation unit 102 of the image forming apparatus, the control unit 108 controls to display the box document selection window 1800 for box number 3 so as to execute the same processes as those described with reference to FIGS. 18 to 20.

A data structure as shown in FIG. 9 can be obtained by control for performing the above operations.

Similar to the above example, the user selects one box via the user interface of the host 300 as a box for saving job data to be processed. In this case, the control unit 108 of the image forming apparatus 100 permits the apparatus 100 to process job data under the condition that the user operates the box via the operation unit 102 of the apparatus. In the example of FIG. 18, the control unit 108 permits the apparatus 100 to execute various processes such as a printing process, erase process, editing process, and transmission process for image data of document C only when the user selects and operates the box of box number 2 via the box selection list 601 displayed on the display unit 316. In other words, the user executes an operation other than an operation of selecting the box of box number 2, for example, executes an operation of selecting another box via the box selection list 601. In this case, the control unit 108 inhibits execution of a process for image data of document C.

Referring to FIG. 9, execution of various processes for job data of documents A and B which are saved in the box area 503 of box 1 is permitted when the user selects box number 1 via the operation unit 102 of the image forming apparatus 100. To the contrary, when a box other than box 1 is selected, processes for job data of documents A and B are inhibited. Also, execution of various processes for job data of document D which is saved in the box area 505 of box 3 is permitted when the user selects box number 3 via the operation unit 102 of the image forming apparatus 100. To the contrary, when a box other than box 3 is selected, processes for job data of document D are inhibited.

The embodiment is premised on a configuration capable of executing the above-mentioned series of control operations, and can also provide the following series of control operations using the box function.

In the example of FIG. 17, only one box is selected via the box setting window 1600 of the printer driver window 1300. The embodiment also controls to permit the user to select two or more boxes as save destinations via the box setting window 1600 of the printer driver window 1300. A concrete example will be described.

For example, control when data of document E which is created by the host 300 and made up of four pages is saved in three boxes 1, 2, and 3 of the image forming apparatus 100 while the file name is directly utilized will be explained.

The user of the host 300 activates an application for document E, and selects the “save mode” in the mode selection column 1301 of the printer driver window 1300 which is displayed on the display unit of the host 300. In response to this, the control unit of the host 300 displays the box setting window 1600 on the display unit of the host 300 (see a series of display change control operations for the printer driver 1300 of the host in FIGS. 13→14→15→16).

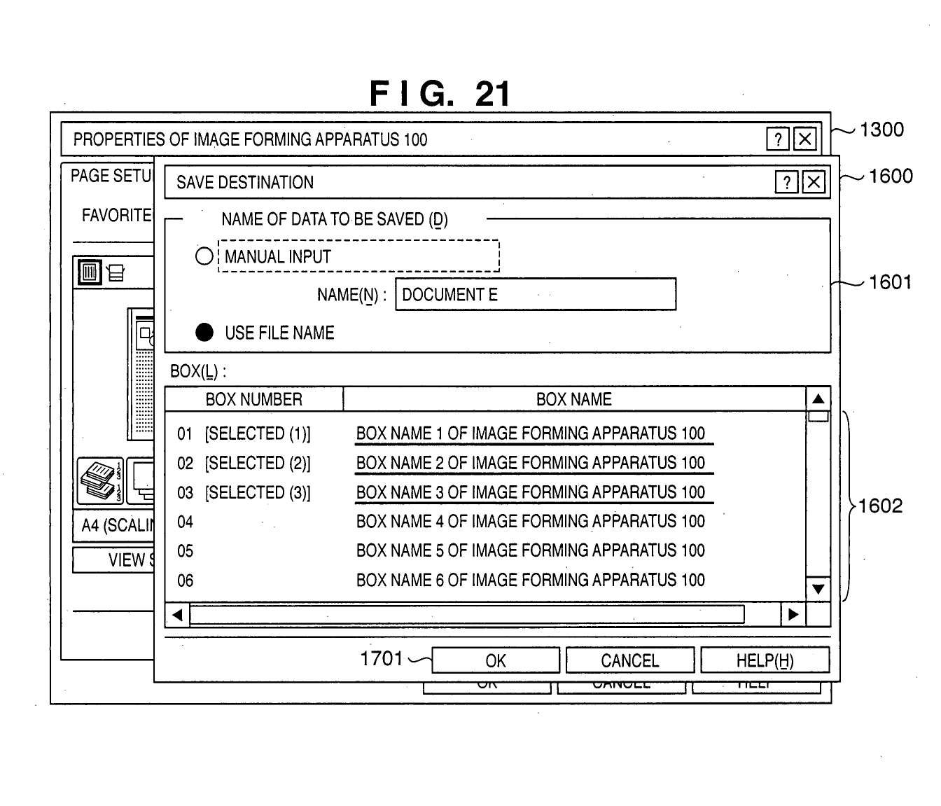

Referring to FIG. 16, the user of the host 300 checks the column “use a file name” in the name entry column 1601 of the box setting window 1600 by mouse operation. Further, the user selects a box of “box number 1” via the box selection list 1602 of the box setting window 1600, then selects a box of “box number 2”, and finally selects a box of “box number 3”. In response to the series of user operations, the control unit of the host 300 controls the display unit of the host 300 to change the display contents of the box setting window 1600 to those associated with these user operations. An example of the display contents is shown in FIG. 21.

As shown in FIG. 21, the embodiment controls to allow the user to identify that three boxes, i.e., box 1 (box area 503), box 2 (box area 504), and box 3 (box area 505) in the hard disk 107 of the image forming apparatus 100 have been selected as save destinations of document data having a file name “document E” via the box setting window 1600 of the host 300. The control unit of the host 300 executes this display control for the display unit of the host 300.

In selecting a plurality of boxes from the list 1602, the pointer is adjusted to a display line corresponding to a desired document, the display line is clicked by mouse operation, and save destination boxes can be selected one by one on the list 1602. The control unit of the host 300 also monitors the selection order of selected boxes, and controls the display contents of the list 1602 to allow the user to identify the selection order, too. In the example of FIG. 21, display control is executed so that the user can identify that “box 1” has been selected first sequentially from the top, then “box 2” has been selected, and finally “box 3” has been selected.

When the user of the host 300 clicks the OK key 1701 upon the completion of selecting three boxes by the above-described series of operations, the window returns to the basic window of the printer driver.

At the same time, job process conditions for 4-page document E are also set. In this case, printing process conditions such as paper size “A4 size”, the number of output copies “five copies”, finishing settings “staple & sort”, and single-sided printing are set.

Upon the completion of the series of setting operations for the job of document E to be processed, the user clicks the OK key 1302 of the printer driver window 1300. In response to this, the control unit of the host 300 accepts from the user of the host 300 an instruction to transmit data of document E, and the host 300 transmits job data of document E to the image forming apparatus 100.

More specifically, the host 300 transmits (1) image data (4-page print data) of document E, (2) job information such as process conditions for data of document E (including various printing process conditions such as paper size “A3 size”, the number of output copies “five copies”, finishing setting “staple”, and single-sided printing setting), and (3) command data which notifies the control unit 108 of the image forming apparatus 100 of “the operation mode of the image forming apparatus 100 is the save mode, and boxes to save the data are three boxes of box numbers 1, 2, and 3”.

When the image forming apparatus 100 receives job data on document E from the host 300, the control unit 108 of the image forming apparatus 100 controls the image forming apparatus 100 in the following manner on the basis of various instructions from the host that are contained in the job data.

(1-1) Entity image data and job information (entity) of document E (four pages) that are received from the host 300 are associated with each other and saved in a storage area (box area 503 in FIG. 5) assigned to the box of box number 1 in the hard disk 107 of the image forming apparatus 100. The job information contains various printing process condition data for document E (e.g., “A4 size”, “five copies”, “staple”, and “single-sided printing setting”).

(1-2) As instruction command data for reading out entity image data of document E (four pages) from the hard disk 107, data (defined as document F in the example of FIG. 10) functioning as a “shortcut to the image entity of document E” is saved in a storage area (box area 504 in FIG. 5) assigned to the box of box number 2 in the hard disk 107 of the image forming apparatus 100. Entity data of job information is saved in box 2.

(1-3) As instruction command data for reading out entity image data of document E (four pages) from the hard disk 107, data (defined as document G in the example of FIG. 10) functioning as a “shortcut to the image entity of document E” is saved in a storage area (box area 505 in FIG. 5) assigned to the box of box number 3 in the hard disk 107 of the image forming apparatus 100. Entity data of job information is saved in box 3.

By processes (1-1) to (1-3), the data structure in the box area 502 of the hard disk 107 is changed from the state in FIG. 9 to that in FIG. 10.

(2-1) The user interface unit (including the operation unit 102 and display unit 316 in FIG. 4) of the image forming apparatus 100 is controlled to allow the user of the image forming apparatus 100 to execute, via the operation unit 102 of the image forming apparatus 100, various manipulations to the job data for which entity image data of document E and job information (entity) for document E have been saved in the box (box area 503) of box number 1.

(2-2) The user interface unit (including the operation unit 102 and display unit 316 in FIG. 4) of the image forming apparatus 100 is controlled to allow the user of the image forming apparatus 100 to execute, via the operation unit 102 of the image forming apparatus 100, various manipulations to the job data for which “data (defined as document F) functioning as a shortcut to document E” and job information (entity) of document E have been saved in the box (box area 504) of box number 2.

(2-3) The user interface unit (including the operation unit 102 and display unit 316 in FIG. 4) of the image forming apparatus 100 is controlled to allow the user of the image forming apparatus 100 to execute, via the operation unit 102 of the image forming apparatus 100, various manipulations to the job data for which “data (defined as document G) functioning as a shortcut to document E” and job information (entity) of document E have been saved in the box (box area 505) of box number 3.

The control unit 108 controls the image forming apparatus 108 to parallel-execute (simultaneously) a total of six processes: storage control processes (1-1) to (1-3) and operation control processes (2-1) to (2-3) on the basis of an instruction set by the user of the host 300 via the box setting window 1600 in FIG. 21 from the host 300.

That is, these processes are a control sequence when the same document data (in this example, document E) is simultaneously saved in a plurality of boxes (in this example, boxes 1, 2, and 3). This control sequence will also be called a plural-box simultaneous storage mode. A control sequence (sequence when one box is selected as a save destination) which has been described with reference to FIG. 17 will also be called a single-box storage mode. The embodiment provides these two modes which can be selectively executed for the box function, and controls to execute a mode corresponding to box setting operation by the user that is executed via the user interface of the data generation apparatus (e.g., host 300).

Process (1-1) is performed in steps S1101 and S1102 of FIG. 11. Processes (1-2) and (1-3) are performed in steps S1103 to S1106 of FIG. 11.

An example of operation control (2-1) will be explained in more detail. Three boxes are selected via the box setting window 1600 of the host 300 in FIG. 21. At this time, the first selected box corresponds to box number 1. When the user instructs the image forming apparatus 100 to execute an output process for data in the box of box number 1, the following control is adopted. Note that the data storage status of each box is set to the state in FIG. 10.

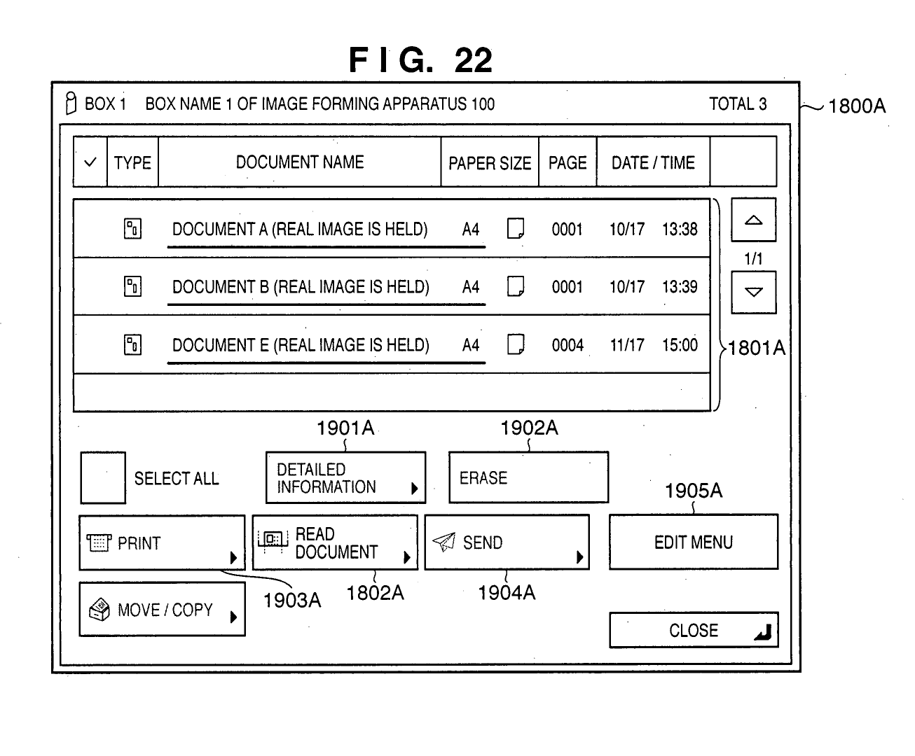

When the user touches the box key in the window of FIG. 12 which is displayed on the display unit 316, the control unit 108 displays the box selection window 601 in FIG. 6 on the display unit 316. In response to selecting the box of box number 1 by the user via the box selection window 601 in FIG. 6, the control unit 108 displays a box document selection window for the box of box number 1 on the display unit 316. An example of the box document selection window is shown in FIG. 22.

As shown in FIG. 10, three jobs are stored in the box of box number 1, and entity image data of each job is saved in the box (box area 503). The control unit 108 causes the display unit 316 to execute display corresponding to the storage status of jobs in the box. As shown in FIG. 22, the display unit 316 displays a total of three documents A, B, and E as documents saved in box 1. The control unit 108 causes the display unit 316 to execute display for allowing a user who operates box 1 to identify pieces of information of the three documents (paper size and page count information are storage date & time information). In addition, the control unit 108 causes the display unit 316 to execute display “real image is held” so that the user can identify that real image data of all the documents are saved in the box area 503 of box 1.

The control unit 108 controls the display unit 316 to gray out keys 1901A to 1905A of a window 1800A before the user selects a job from a list 1801A. With this setting, the control unit 108 controls not to accept any input instruction from the user via the keys 1901A to 1905A. In response to selecting a desired document by the user via the document selection list 1801A of the document selection window 1800A for box 1 in FIG. 22, the operation keys 1901A to 1905A are effectively displayed in the window 1800A. After a document is selected, the control unit 108 controls to permit acceptance of various instructions from the user via the keys 1901A to 1905A.

That is, even when box 1 is operated, the control unit 108 controls the apparatus 100 to execute various processes (detailed information display process, erase process, printing process, transmission process, editing process, preview process, and the like) for a desired document selected by the user from box 1 after the user selects the desired document via the list 1801A, similar to the examples of FIGS. 19 and 20.

For example, in response to selecting document E by the user via the list 1801A of the document selection window 1800A for box 1, the user touches the effectively displayed print key 1903A. In this case, the control unit 108 reads out entity image data of document E from the box area 503 corresponding to currently operated box 1 in the hard disk 107, and causes the printer unit 104 to print the image data.

An example of the above-described operation control (2-2) will be explained in more detail. Three boxes are selected as document save destinations of document E via the box setting window 1600 of the host 300 in FIG. 21. At this time, the second selected box corresponds to box number 2. When the user instructs the image forming apparatus 100 to execute an output process for data in the box of box number 2, the following control is adopted. Note that the storage statuses of data in boxes 1 to 3 are set to the state in FIG. 10.

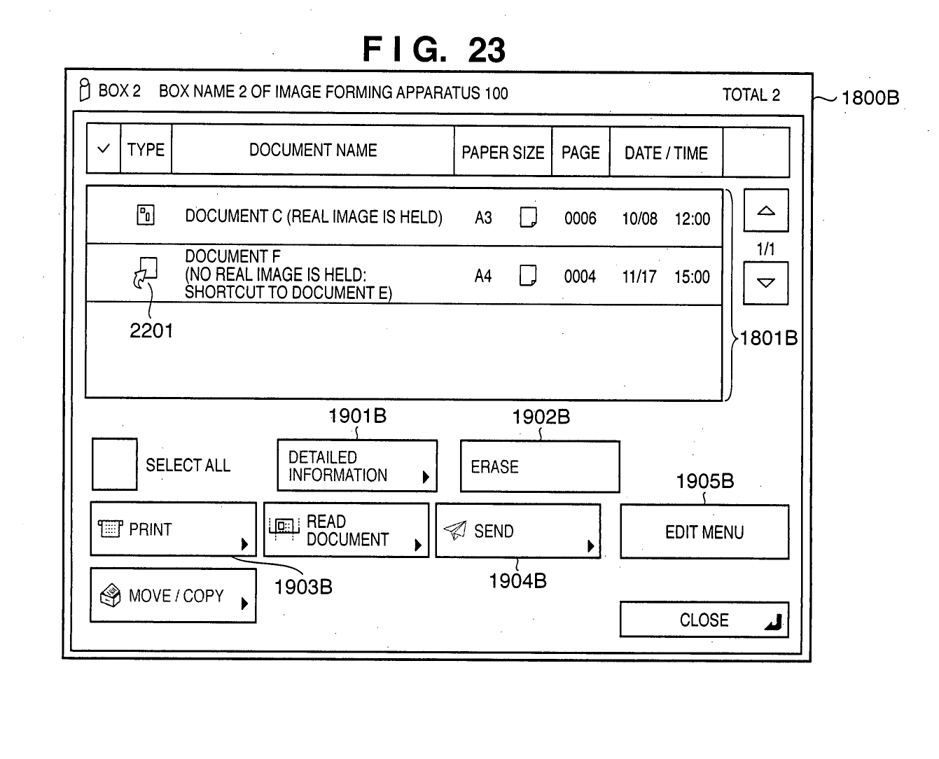

When the user touches the box key of the window in FIG. 12 which is displayed on the display unit 316, the control unit 108 displays the box selection window 601 in FIG. 6 on the display unit 316. In response to selecting the box of box number 2 by the user via the box selection window 601 in FIG. 6, the control unit 108 displays, on the display unit 316, a box document selection window for operating the box of box number 2. An example of the box document selection window is illustrated in FIG. 23.

As shown in FIG. 10, two jobs are stored in the box of box number 2. Of the two jobs, entity image data of document C is saved in the box, but entity image data of document F does not exist in the box. Document F is data which is defined by the control unit 108 as “data functioning as a shortcut to document E”. However, entity data of job information for document F (data functioning as a shortcut to document E) is saved in the box (box area 504). The job information is assigned to document E to be read out from the hard disk 107 on the basis of the shortcut function of document F. The job information contains, e.g., bibliographic information of document E (document name, the number of pages, and box storage date & time data), and process condition data of document E (a series of printing process condition data set by the host 300 for document E: e.g., paper size “A4 size”, the number of output copies “five copies”, finishing setting “staple”, and “single-sided printing setting”).

The control unit 108 causes the display unit 316 to execute display corresponding to the storage status of jobs in box 2. As illustrated in a box document selection window 1800B of FIG. 23, the display unit 316 displays a total of two documents C and F (no real image is held) as documents saved in box 2. In addition, the control unit 108 causes the display unit 316 to execute display for allowing a user who operates box 2 to identify pieces of information of the two documents (paper size and page count information are storage date & time information). The control unit 108 causes the display unit 316 to execute display “real image is held” in the list 1801A so that the user can identify that real image data of document C is saved in the box area 504 of box 2. Further, the control unit 108 causes the display unit 316 to display text information “no real image is held: a shortcut to document E” in the list 1801A so that the user can identify that no real image data of document F is saved in the box area 504 of box 2 and document F functions as a shortcut to document E. In order to clarify a message to this effect, the control unit 108 controls the display unit 316 to display a shortcut icon 2201 different in display form from the icon of document C whose real image is saved.

Keys 1901B to 1905B of the box document selection window 1800B for operating box 2 are grayed out so as not to accept any instruction input from these keys by the user before a job is selected by the user from the list 1801B. In response to selecting a desired document by the user via the document selection list 1801B of the document selection window 1800B for box 2 in FIG. 23, the operation keys 1901B to 1905B are effectively displayed in the window 1800B. Accordingly, acceptance of various instructions from the user is permitted.

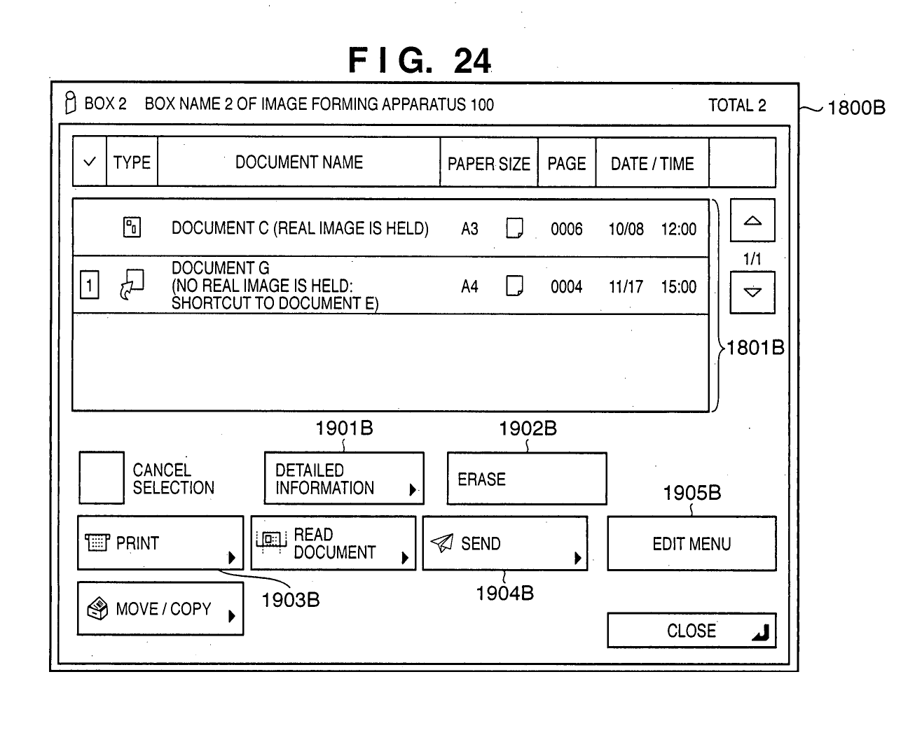

For example, the user selects document F (management data serving as a shortcut to document E) via the document selection list 1801B of the box document selection window 1800B for operating box 2 in FIG. 23. In response to selecting document F, the control unit 108 controls the display unit 316 to change the display state of the document selection window 1800B from the state in FIG. 23 to that in FIG. 24. As shown in FIG. 24, the display in which document F is selected is reflected in the list 1801B. All the keys 1901B to 1905B are effectively displayed so that various manipulations to data in box 2 can be accepted from the user. The control unit 108 controls to accept various instructions from the user via the keys 1901B to 1905B. Similar to the above process, the control unit 108 controls the image forming apparatus 100 to execute a process corresponding to process contents requested by the user for a desired document selected by the user from box 2.

For example, in response to a touch on the detailed information key 1901B by the user, entity image data linked to document F, i.e., detailed information (printing conditions of document E and the like) of job information of document E is displayed. If the key 1903B is touched, a printing process for document E serving as entity image data linked to document F is executed. If the key 1904B is touched, a data transmission process for document E serving as entity image data linked to document F is executed.

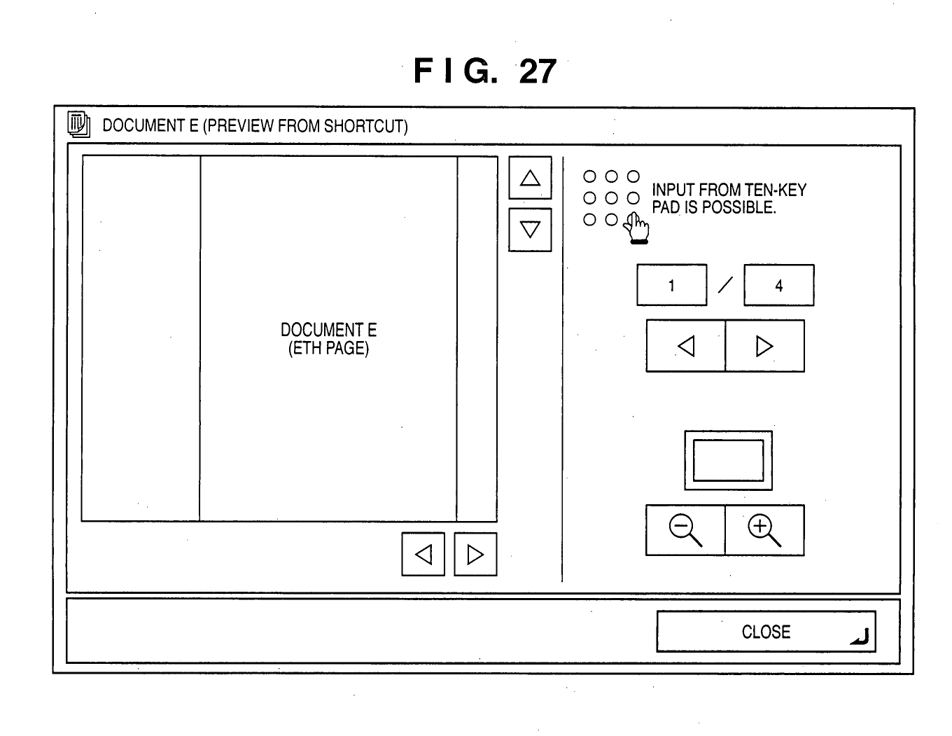

For example, when the key 1905B is touched, the control unit 108 reads out data of document E serving as entity image data linked to document F from the area 503 of box 1, and causes the display unit 316 to preview the data. An example of the preview is illustrated in FIG. 27. As shown in FIG. 27, even when the preview function is executed, a message such as “preview from a shortcut” is displayed so that the user can identify whether image data read out by the shortcut function is previewed on the display unit 316. In this fashion, if the key 1905B is touched, an editing process and preview process for data of document E serving as entity image data linked to document F can be executed.

If the erase key 1902B is touched, an erase process for document F is controlled. Note that an erase process when document F which is data functioning as a shortcut is selected is different from the above-described one, and will be described later.

A process when a document functioning as a shortcut is selected will be described in detail. For example, in the state of FIG. 24, a user who operates a box corresponding to box number 2 selects document F (shortcut key to document E) via the document selection window 1800B for the box of box number 2 that is displayed on the display unit 316 of the image forming apparatus.

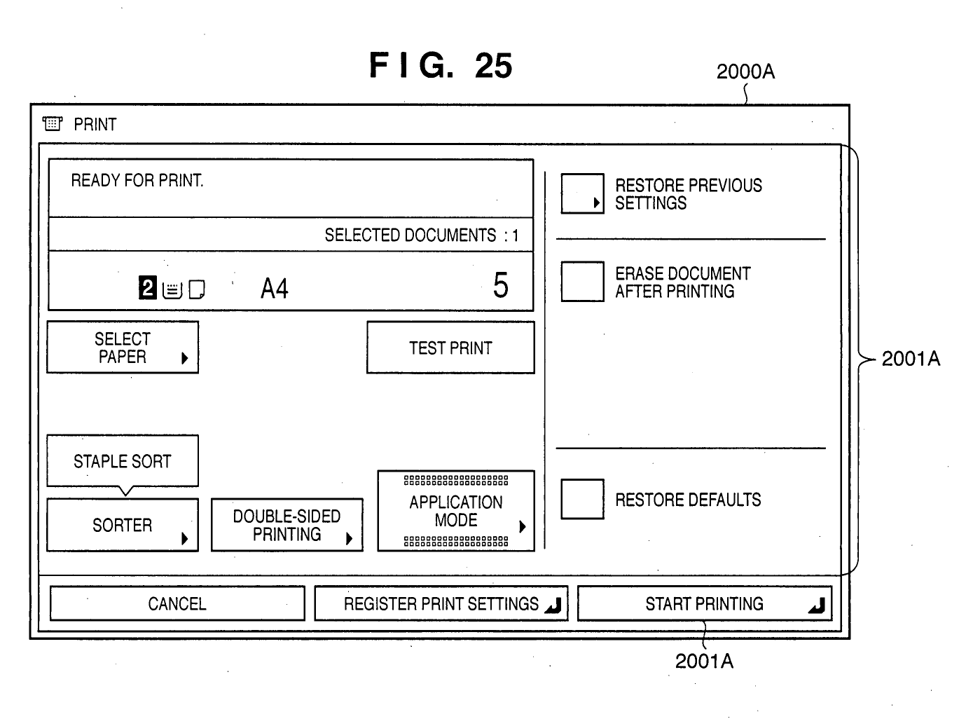

As shown in FIG. 24, assume that a user who operates the box of box number 2 selects document F (shortcut key to document E), and touches the print key 1903B which is effectively displayed in the window 1800. In response to this, the control unit 108 displays a setting window 2000A shown in FIG. 25 on the display unit 316.

The setting window 2000A in FIG. 25 is a user interface window which allows the user to determine a process for document data to be read out from the hard disk 107 (i.e., electronic data of document E whose entity image data is saved in the box area 503) in response to selection of document F (shortcut key to document E) by the user.

In displaying the window 2000A on the display unit 316, the control unit 108 reads out, from the hard disk 107, job information corresponding to document data selected via the list 1081B of the document selection window 1800B.

Entity image data (document E) of document F to be processed is saved in box 1 (box area 503) different from currently selected box 2. In contrast, job information for the entity image data (document E) of document F is saved in box 2 (box area 504). Hence, the control unit 108 controls to read out the job information from the box area 504 and reflect the job information in the window 2000A.

In a display area 2001A of the window 2000A, the control unit 108 executes display for prompting the user to confirm process conditions which have been set in advance for the document data. That is, printing conditions for document E that are set by the printer driver 1300 of the host 300 contain various process condition parameters such as paper size “A4 size”, the number of output copies “five copies”, finishing settings “staple”, and “single-sided printing setting”. The control unit 108 reads out the job information from the box area 504, refers to the job information, and reflects it in the window 2000A. This can achieve an effect of prompting a user who operates the operation unit 102 to confirm process conditions which have already been set for a selected document.

Also, the control unit 108 causes the display unit 316 to execute display for changing, by the user via the window 2000A, process conditions which have been set for a document in advance. For example, when the user selects a “paper selection key” in the window 2001A, a paper setting window (not shown) is displayed to allow the user to change the paper setting via the paper setting window. In response to user operation of the ten-key pad 313 of the operation unit 102, the number of output copies of a document can also be changed. When the user touches a “sorter” key in the window 2001A, the finishing setting of the document can also be changed. Further, for example, in response to user operation of a “double-sided print” key in the window 2001A, the user can determine whether to perform single- or double-sided printing for the document.

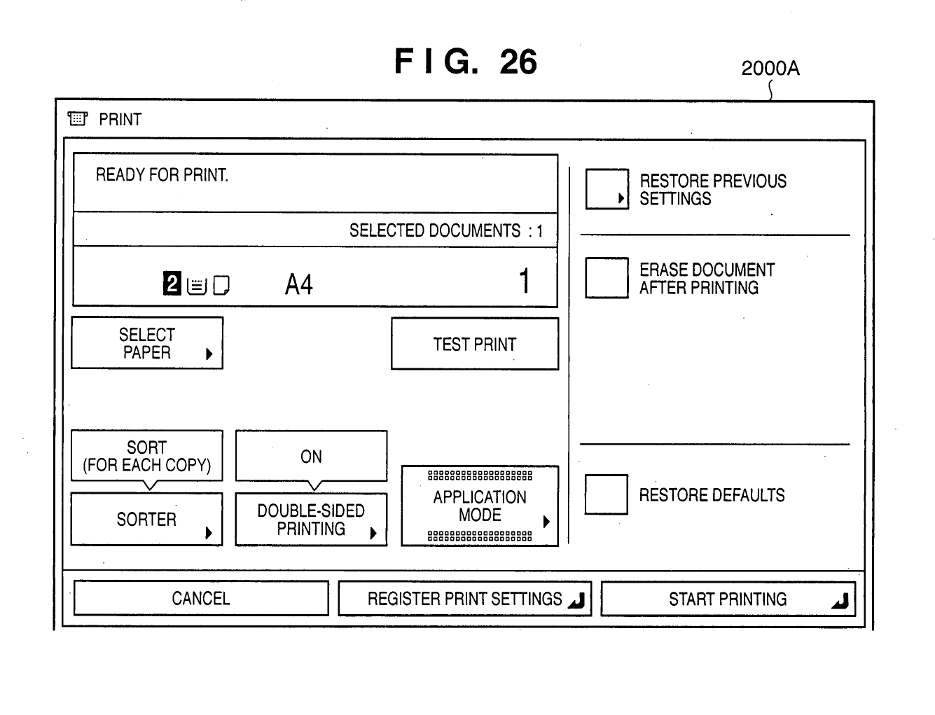

For example, the user performs the following operation via the window 2001A for printing conditions of document E which is read out by document F (shortcut key to document E). For example, the paper size setting is maintained at “A4 size” which has been set in advance. The number of output copies is changed from “five copies” to “three copies”. The finishing setting is changed from “staple” to “sort”. The printing side setting is changed from “single-sided printing” to “double-sided printing”. The control unit 108 accepts the user setting change, and controls the display unit 316 to reflect the changed parameters in the window 2001A. On the basis of the setting change instruction from the user, the control unit 108 controls the display unit 316 to change the display contents of the window 2001A to those as shown in FIG. 26.

Assume that the user performs a series of box operations via various user interfaces described above, and touches a print start key 2002A of the print setting window 2000A in FIG. 25. In response to this, the control unit 108 reads out, from the box area 502 in the hard disk 107, entity image data of a document selected by the user from the list 1801B of the document selection window 1800B in FIG. 24. The control unit 108 causes the printer unit 104 to execute a printing process for the readout image data of the job on the basis of a series of process conditions which are set by the user via the area 2001A of the print setting window 2000A in FIG. 25. At this time, the control unit 108 performs, e.g., the following process.

(1) A process of confirming a box to be operated by the user is done. In this example, it is determined that the box of box number 2 is a selected box, on the basis of box selection operation executed by the user via the box selection window in FIG. 6.

(2) A process of confirming a selected document by the user is performed. In this example, it is determined that document F is selected data, on the basis of document selection operation executed by the user via the list 1801A of the document selection window 1800B in FIG. 24.

(3) A process of reading out entity image data of the selected document from the hard disk 107 is performed. On the basis of registration information on box data such as information on the recording destination list used in the above-described process of FIG. 11 and information on a management table which manages the data structure of box data shown in FIG. 10, it is confirmed whether entity image data of the document to be processed exists in the storage area of the currently selected box. In this case, it is determined that entity image data of document F does not exist in the box area 504 of currently selected box number 2, but document F is data defined as a shortcut function to document E. It is also determined that a box which saves the entity image data is the box (box area 503) of box number 1.

In this manner, the control unit 108 executes read control of data in the image forming apparatus 100 on the basis of the fact that document F selected by the user via the document selection list 1801A of the box document selection window 1800B for the box of box number 2 is data functioning as a shortcut. More specifically, the control unit 108 controls to read out, as entity image data of document F from the box (box area 503 in the hard disk 107) of box number 1, document E which is associated with the shortcut function of document F selected by the user via an operation window for the box of box number 2.

The control unit 108 causes the printer unit 2 to execute a printing process for the image data of document E that is read out from the box area 503 of box number 1 in the hard disk 107, under printing process conditions set by the user via the print setting window 2000A which is displayed on the display unit 316 in order to operate the box of box number 2.

For example, printing conditions (parameters which are reflected in the UI of FIG. 25 and have been set by the host 300) which have been set in advance for document E are changed by the user, as shown in FIG. 26. Then, the user touches the print start key 2002A in the window 2000A. In this case, the control unit 108 controls the printer unit 104 to execute double-sided printing and execute a sort process as a finishing process for the number of output copies=1 while the paper size is kept at A4 size. To the contrary, the user touches the print start key 2002A in the window 2000A without changing printing conditions which have been set for document E (while maintaining parameters which are reflected in the UI of FIG. 25 and have been set by the host 300). In this case, the control unit 108 controls the printer unit 104 to execute single-sided printing without executing double-sided printing and execute a staple process as a finishing process for the paper size=A4 size and the number of output copies=5.

According to the embodiment, when data selected in a selected box (box of box number 2 in the above example) is data (document F in the above example) functioning as a shortcut, the image forming apparatus 100 is controlled so that entity image data (document E stored in the box of box number 1 in the above example) of another box associated with the shortcut function can be output.

Moreover, according to the embodiment, when data to be output by the shortcut function (in the above example, image data of document E that is output in accordance with selection of document F by the user from a setting window for box 2 and has entity image data stored in box 1) is actually output, the apparatus 100 is controlled so that process conditions which have been set in advance for the data can be directly utilized. In the above example, the image forming apparatus 100 is controlled so that document E can be directly printed under process conditions which are reflected in the print setting window 2000A of FIG. 25.

Furthermore, according to the embodiment, the image forming apparatus 100 is controlled so that even a document which is simultaneously stored in a plurality of boxes can be output for each box under process conditions desired by a user who performs box operation.

For example, when the user of box 1 operates, real image data (document E) can be printed under process conditions desired by the user of box 1 via an operation window (e.g., the window 1800A in FIG. 22) for box 1. When the user of box 2 operates, real image data (document E) can be printed under process conditions desired by the user of box 2 via an operation window (e.g., the window 1800B in FIG. 24) for box 2.

Naturally in the embodiment, even when another box to which image data is simultaneously distributed from the host 300 in the plural-box simultaneous storage mode is to be operated, the control unit 108 controls to execute the same operation as the above-described box operation. The above description is directed to a concrete example of operation control (2-3).

For example, the data storage status of box (box area 505) of box number 3 has a data storage structure as shown in FIG. 9 before a job of document E is input from the host 300. That is, only entity image data of document D and job information for document D are stored. After that, the host 300 instructs the apparatus 100 via the box setting window 1600 of the printer driver of the host 300 in FIG. 21 to input document E not only to boxes 1 and 2 but also to box 3. Upon reception of the instruction, the control unit 108 controls the hard disk 107 to also save data functioning as a shortcut to document E in the box (box area 505) of box number 3.

As a result, the data storage status of box (box area 505) of box number 3 after the apparatus 100 receives the job of document E from the host 300 changes to the data storage structure shown in FIG. 10. That is, virtual data which functions as a shortcut to document E and is defined as document G, and entity data of job information for document E are saved in box 3 in addition to document D.

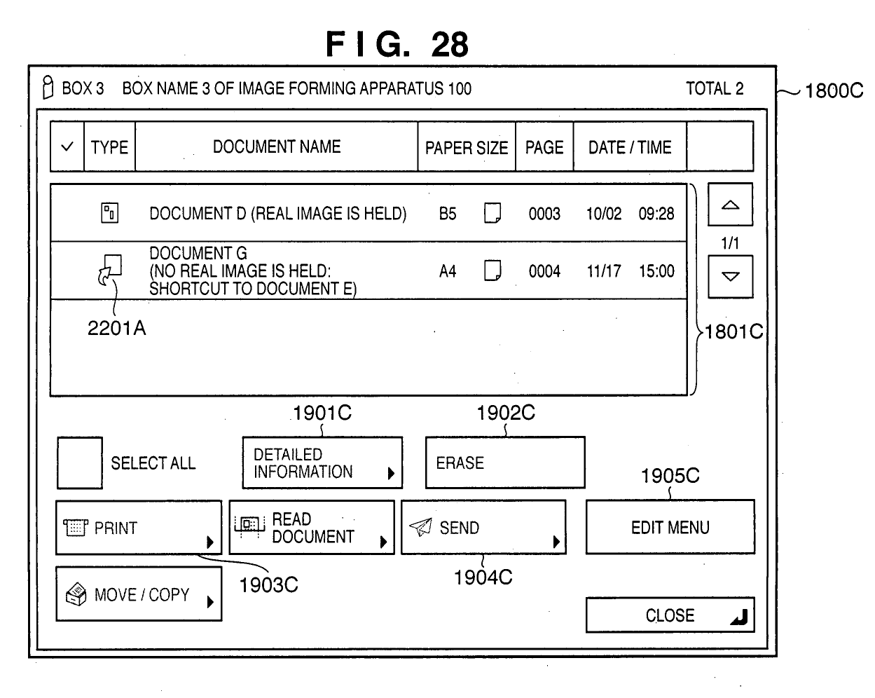

Thereafter, the user selects box 3 via the box selection list 601 in FIG. 6 that is displayed on the display unit 316. In response to this, the control unit 108 displays, on the display unit 316, a document selection window 1800C for the box of box number 3 as shown in FIG. 28.

A window display as shown in FIG. 28 is also controlled by the control unit 108. For example, for document D whose entity image data is stored in currently selected box 3 (box area 505), “real image is held” is displayed in a list 1800C. For document G whose entity image data is not stored in box 3, “no real image is held: a shortcut to document E” is displayed in the list 1800C. Similar to document F in box 2, a shortcut icon 2201A is displayed.

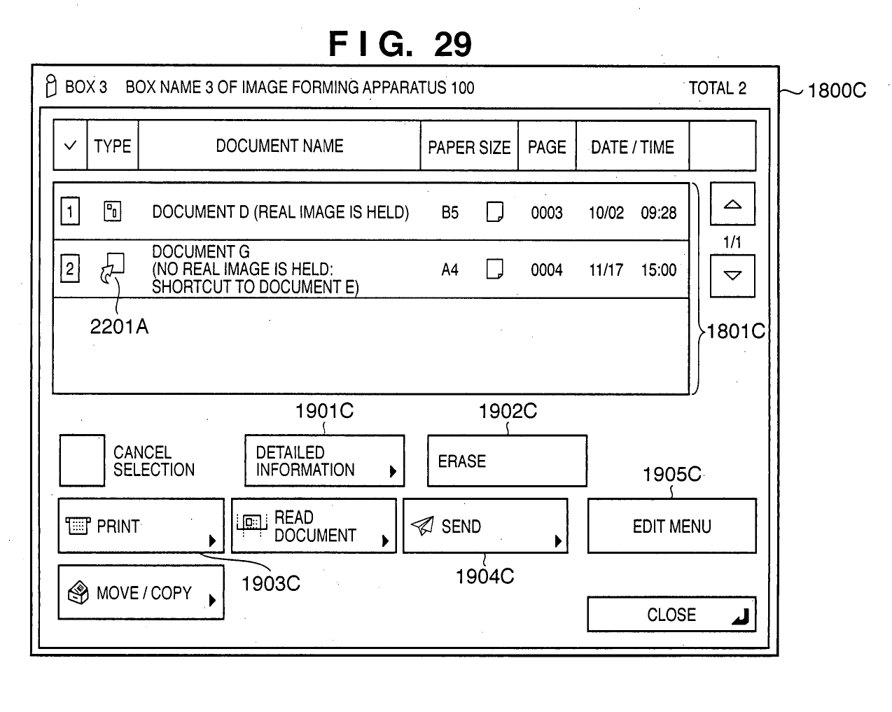

The image forming apparatus 100 according to the embodiment has a continuous printing function of allowing the user to select a plurality of documents in a box, reading out the selected documents from the hard disk 107 at once, and continuously outputting the documents. For example, two documents D and G are selected via a list 1801C of the document selection window 1800C of box 3. As shown in FIG. 29, the control unit 108 effectively displays various keys 1901C to 1905C in the window 1800C. When the user selects a plurality of documents, the selection order of these documents is displayed on the left side of the list 1800C, as shown in FIG. 29.

When the user touches a print key 1903C of the window 1800C, a print execution instruction is accepted. Then, the control unit 108 refers to, e.g., a management table for managing the data management structure in FIG. 10, and recording destination list information used in the process of FIG. 11. Consequently, for example, the control unit 108 determines that document D is saved in box 3. In contrast, the control unit 108 determines that entity image data of document G does not exist in currently selected box 3 and document G is shortcut function data for reading out document E whose entity image data is stored in box 1.

The control unit 108 also controls the printing order when a plurality of documents are continuously printed. For example, when a plurality of documents are selected by the user from the list 1801C, as shown in FIG. 29, the control unit 108 controls to continuously print the selected documents in the same order as the document selection order by the user. In the example of FIG. 29, document D is selected first, and then document G is selected. Thus, the control unit 108 prints document D first, and then document F. In this order, these documents are continuously printed at once.

For this purpose, a series of image data (3-page job) of document D which is selected first from the list 1800C are read out from the box area 505 of currently selected box 3, and the data are printed by the printer unit 104. Thereafter, a series of image data linked to document G which is selected next from the list 1800C, i.e., document E (4-page job) is read out from the box area 503 of box 1 different from currently selected box 3, and the data are printed by the printer unit 104.

As described above, the embodiment is so configured as to continuously print a plurality of documents selected by the user via a box. The embodiment also employs a function of continuously printing at once a document whose entity image data is saved in a selected box and a document whose entity image data is saved in another box. As for the printing conditions of documents, the documents may be printed under preset process conditions, or the settings may be changed to continuously print the documents. In any case, the control unit 108 controls to utilize pieces of job information on jobs of documents D and E which are saved in box 3.

Control associated with job information will be explained.

In the embodiment, as described above, the control unit 108 controls the apparatus 100 so that a series of image data which are stored in a box can be output in response to user operation executed via the user interface window of a different box. The control unit 108 controls the apparatus 100 not to save entity image data in the different box, but to save process conditions for the series of image data as job information in the different box. In the above example, entity image data of document E that is saved in the box area 503 of box number 1 is not saved in either the box area 504 of box number 2 or the box area 505 of box number 3.

However, process conditions for document E are saved as job information in the box areas 504 and 505. With this configuration, in an output process for the series of image data which are stored in the box, the process conditions which have been set in advance for the data can be controlled changeably via the user interface window of the different box. Under the changed process conditions, the output process for the data can be executed. This configuration is adopted to cope with, e.g., the following situation.

Assume that the user of the host 300 who selects the plural-box simultaneous storage mode via the printer driver 1300 in FIG. 21 is the owner of box 1 in the image forming apparatus 100. Also, assume that a user who utilizes box 2 of the image forming apparatus 100 and a use who utilizes box 3 exist.

In this situation, assume that the user of the host 300 saves document E to be processed in his box 1, and wants the users of boxes 2 and 3 to utilize data of document E. The user of the host 300 will be called a distributing user, and the users of boxes 2 and 3 will be called distributed users. As for process conditions for data of document E, document E may be used in an output form designated by the distributing user, or each distributed user may want to output document E in his desired output form.

The embodiment can cope with even this situation. For this purpose, the embodiment allows the distributing user to select which of a plurality of boxes subjected to distribution is to save actual data to be processed when the data to be processed is stored in the hard disk 107 of the apparatus 100 in the plural-box simultaneous storage mode. In other words, which of boxes is to save data functioning as a shortcut can be determined on the basis of a setting instruction from the distributing user.

This control will be explained with reference to the above example. The control unit of the host 300 serving as an example of the data generation apparatus displays the box setting window 1600 as shown in FIG. 16 on the display unit of the host 300. The control unit controls to allow the user to select a plurality of boxes as data save destinations.

When the user of the host 300 selects a plurality of boxes via the list 1602, as shown in FIG. 21, the control unit of the host 300 monitors the selection order of the boxes selected by the user. The control unit controls the image forming apparatus 100 so that entity data of data to be processed is saved in a box area corresponding to a box which is selected first by the user of the host 300 via the list 1602.

That is, when the user of the host 300 makes box settings as shown in FIG. 21 and the host 300 inputs job data to be processed to the image forming apparatus 100, the control unit 108 of the image forming apparatus 100 executes various control operations described above.

More specifically, entity image data of document E is saved in a box (box area 503) of box number 1 that is selected first by the user of the host 300 via the list 1602 displayed on the display unit of the host 300. In a box (box area 504) which is selected second via the list 1602 and corresponds to box number 2, data which is defined as document F and functions as a shortcut to document E is saved as data for allowing the user of box 2 to input an instruction to output the entity image data of document E from the hard disk 107. In a box (box area 505) which is selected third via the list 1602 and corresponds to box number 3, data which is defined as document G and functions as a shortcut to document E is saved as data for allowing the user of box 3 to input an instruction to output the entity image data of document E from the hard disk 107. The series of data storage control operations are executed by the control unit 108.

The control unit 108 saves, as entity data in each of boxes 1, 2, and 3, job information containing a series of process conditions set for document E by the user of the host 306. In the above example, a series of process condition parameters (e.g., paper size “A4 size”, the number of output copies “five copies”, “execute single-sided printing”, and finishing setting “staple”), and various types of information on document E (e.g., the box storage date and time, and page count information) are saved as job information in each box.

The reason that data is registered as documents F and G in boxes instead of using the repetitive document name is to deal with a data management trouble which may occur when, for example, a plurality of data are saved with the same name in the hard disk 107. However, this file naming method need not always be employed as far as no trouble occurs and user needs can be satisfied.

In the embodiment, which of the plural-box simultaneous storage mode and single-box storage mode is to be executed can be determined in accordance with the number of boxes selected via the box setting window 1600 displayed on the display unit of the host 300. More specifically, when the user selects only one box via the list 1602 and a job is input, as shown in FIG. 17, the job is processed in the single-box storage mode. To the contrary, when the user selects a plurality of boxes via the list 1602 and a job is input, as shown in FIG. 21, the job is processed in the plural-box simultaneous storage mode.

However, the embodiment may selectively execute these modes by a determination method other than the above one. For example, the display unit of the host 300 displays a display window having two keys: a key to select the single-box storage mode by the user and a key to select the plural-box simultaneous storage mode by the user immediately after the user selects, e.g., the “save mode” in the mode selection column 1301 of the printer driver 300. These keys are alternatively controlled on the window, and a selected storage mode is determined as a mode to be executed. In this fashion, either of the two modes may be explicitly designated by the user.

The shortcut function in the above-described box function will be explained.

According to the embodiment, when user operation is done for data in a box via the user interface of the image forming apparatus, data functioning as a shortcut can be selected. For example, this process corresponds to selection of document F shown in FIG. 24 and selection of document G shown in FIG. 29. Further, the shortcut function data allows the user to use the apparatus 100 and execute a desired process for entity image data to be read out from the hard disk 107. A series of control operations for data input to a box are executed by the control unit 108.

In the embodiment, a box area for saving entity image data is prepared in the hard disk 107 of the image forming apparatus 100 serving as an example of the data processing apparatus. In the above example, this box corresponds to the box (box area 503) of box number 1 that holds entity image data of document E. A box which saves entity image data to be read out by the shortcut function will be called a “first box (or first type box)”.

A box area which does not save any entity image data is also prepared in the hard disk 107 of the image forming apparatus 100. In the above example, the box (box area 504) of box number 2 and the box (box area 505) of box number 3 correspond to boxes which do not hold any entity image data of document E but store data functioning as a shortcut. A box which saves data functioning as a shortcut for allowing the user to input an entity image data read instruction will be called a “second box (or second type box)”.

With this configuration, the embodiment performs various control operations described above. Main control operations will be listed below.

[Control 1]

Data of the first job (to be also referred to as the first type job) transmitted from the data generation apparatus without performing any predetermined operation by the user of the data generation apparatus via the user interface unit of the data generation apparatus is controlled to be accepted by the data processing apparatus.

In the above example, control 1 corresponds to a configuration in which the control unit 108 controls the image forming apparatus 100 to accept job data transmitted from the host 300 without selecting a plurality of boxes (but selecting only one box) by the user of the host 300 via the box setting window 1600 displayed on the display unit of the host 300.

A job which is input from the host 300 via a series of UI operations in FIGS. 13→14→15→16→17 corresponds to an example of the first type job. In other words, jobs such as jobs of documents A, B, C, and D in FIG. 9 are controlled.

[Control 2]

Data of the second job (to be also referred to as the second type job) transmitted from the data generation apparatus upon performing predetermined operation by the user of the data generation apparatus via the user interface unit of the data generation apparatus is controlled to be accepted by the data processing apparatus.

In the above example, control 2 corresponds to a configuration in which the control unit 108 controls the image forming apparatus 100 to accept job data transmitted from the host 300 upon selecting a plurality of boxes by the user of the host 300 via the box setting window 1600 displayed on the display unit of the host 300.

A job which is input from the host 300 via a series of UI operations in FIGS. 13→14→15→16→21 corresponds to an example of the second type job. In other words, a job of document E in FIG. 10 is controlled.

[Control 3]

The control unit 108 controls the data processing apparatus to accept, from the user via display associated with the first box, a process request for the first job data when the first type job data is saved in the hard disk 107 of the data processing apparatus. The control unit 108 controls the apparatus 100 to execute, for entity image data of the first job, a process corresponding to an instruction from the user that has been accepted via the display.

In the above example, when job data of documents A and B are transmitted from the host 300, the control unit 108 saves these job data in the box area 503 of box number 1. These jobs are input from the host 300 by selecting only box 1 as a save destination by the host 300 via the box setting window 1600. The control unit 108 causes the display unit 316 to execute display for allowing the user to execute operation of data in the box of box number 1 in response to selection of the box of box number 1 by the user of the apparatus 100 via the box selection window 601 in FIG. 6. For example, the document selection window 1800A for box number 1 in FIG. 22 corresponds to this display.

Manipulation for a series of image data of document A and those of document B in the hard disk 107 is made acceptable from the user via the setting window 1800A. The control unit 108 controls to selectively accept various instructions from the user via the keys 1901A to 1905A of the setting window 1800A. Hence, the apparatus 100 can execute processes (printing process, transmission process, erase process, editing process, and the like) desired by the user for documents A and B. In other words, the control unit 108 inhibits data manipulation for documents A and B from the setting window 1800B for the box of box number 2 and the setting window 1800C for the box of box number 3. Display control is executed to inhibit the user from selecting documents A and B from, e.g., the lists 1801B and 1801C.

This also applies to a job of document C. The control unit 108 controls to execute various manipulations for job data of document C only via the operation window 1800B (see FIGS. 18, 19, 23, 24, and the like) of box number 2. Manipulation for job data of document C cannot be done from a setting window of another box other than that of box 2. This also applies to a job of document D. The control unit 108 controls to execute various manipulations for job data of document D only via the operation window 1800C (see FIGS. 28, 29, and the like) of box number 3. Manipulation for job data of document D cannot be done from a setting window of another box other than that of box 3.

[Control 4]

The control unit 108 controls the data processing apparatus to accept, from the user via display associated with the first box, a process request for the second job data when the second type job data is saved in the hard disk 107 of the data processing apparatus. In addition, the control unit 108 controls the data processing apparatus to accept, from the user even via display associated with the second box, a process request for the second job data. The control unit 108 controls the apparatus 100 to execute, for entity image data of the second job, a process corresponding to an instruction which has been accepted from the user via the display associated with the first box. Also, the control unit 108 controls the apparatus 100 to execute, for entity image data of the second job, a process corresponding to an instruction which has been accepted from the user via the display associated with the second box.

In the above example, when job data of document E is transmitted from the host 300 (see the UI in FIG. 21), the control unit 108 saves the job data of document E (containing a series of image data of 4-page document E) in box 1 (box area 503) which is selected first via the list 1602 of the window 1600 of the host 300. The control unit 108 controls the image forming apparatus 100 to accept, from the user via the display associated with the box of box number 1, a process request for entity image data of document E.

For example, the document selection window 1800A of box 1 in FIG. 22 is displayed on the display unit 316 in response to selection of the box of box number 1 by the user of the apparatus 100 via the box selection list 601 in FIG. 6, as described above. As a result, the user can select document E via the list 1801A from a plurality of document data associated with box 1. The control unit 108 effectively displays the keys 1901A to 1905A upon selection of document E by the user via the list 1801A. A request to execute a process for entity image data of document E can be accepted from the user via the keys 1901A to 1905A. When a process request is accepted from the user via any one of the keys 1901A to 1905A, the control unit 108 reads out the entity image data of document E from the box area 503 of the hard disk 107. The control unit 108 controls the apparatus 100 to execute a process corresponding to the process request from the user for the entity image data of document E. Processes desired by the user (e.g., printing process, transmission process, detailed information process, and erase process) can be executed for document E.

The control unit 108 executes not only the above-described series of control operations but also the following series of control operations. Like the above example, the control unit 108 controls the image forming apparatus 100 to accept a process request for entity image data of document E from the user via display associated with a distributed box for job data of document E other than the box of box number 1. For example, the control unit 108 controls the apparatus 100 to accept a process request for entity image data of document E from both the operation window of distributed box 2 and that of distributed box 3.

For example, the document selection window 1800B of box 2 in FIG. 23 is displayed on the display unit 316 in response to selection of the box of box number 2 by the user of the apparatus 100 via the box selection window 601 in FIG. 6, as described above. The user can select, via the list 1801B from a plurality of document data associated with box 2, document F functioning as a shortcut for reading out entity image data of document E from the hard disk 107. The control unit 108 effectively displays the keys 1901B to 1905B upon selection of document F (shortcut key to document E) by the user via the list 1801B (see FIG. 24). A request to execute a process for entity image data of document E can be accepted from the user via the keys 1901B to 1905B.

When a process request is accepted from the user via any one of the keys 1901B to 1905B, the control unit 108 reads out the entity image data of document E from the box area 503 of the hard disk 107. The control unit 108 controls the apparatus 100 to execute a process corresponding to the process request from the user for the entity image data of document E. Processes desired by the user (e.g., printing process, transmission process, and detailed information process) can be executed for document E. Note that the entity image data of document E is a job which is stored in box 1 different from currently operated box 2. For this reason, when box 2 is to be operated, execution of a process to erase entity image data of document E is inhibited.

The same operation as that of box 2 can also be executed for box 3 serving as the other distribution destination. For example, the document selection window 1800C for box 3 in FIG. 28 is displayed on the display unit 316 in response to selection of the box of box number 3 by the user of the apparatus 100 via the box selection window 601 in FIG. 6, as described above. The user can select, via the list 1801C from a plurality of document data associated with box 3, document G functioning as a shortcut for reading out entity image data of document E from the hard disk 107. The control unit 108 effectively displays the keys 1901C to 1905C upon selection of document G (shortcut key to document E) by the user via the list 1801C (see FIG. 29). A request to execute a process for entity image data of document E can be accepted from the user via the keys 1901C to 1905C.

When a process request is accepted from the user via any one of the keys 1901C to 1905C, the control unit 108 reads out the entity image data of document E from the box area 503 of the hard disk 107. The control unit 108 controls the apparatus 100 to execute a process corresponding to the process request from the user for the entity image data of document E. Note that the entity image data of document E is a job which is stored in box 1 different from currently operated box 3. Thus, even when box 3 is operated, execution of a process to erase real image data of document E is inhibited.

The embodiment provides the configuration described with reference to FIGS. 1 to 29. This configuration can flexibly deal with a situation in which the same job data is simultaneously distributed and saved in a plurality of boxes desired by the user among a plurality of data storage boxes prepared in the memory of a data processing apparatus having the box function, such as the image forming apparatus according to the embodiment. With this configuration, the same job data can be distributed and saved in a plurality of boxes desired by the user by simple operation. The burden on various users who utilize the box function can be minimized to improve operability.

By providing control of the shortcut function in the box function, a job to process image data can be preferably recorded in a plurality of boxes by one job, and the amount of data recorded in each box can be reduced to efficiently use the memory.

The embodiment can, therefore, provide a user-friendly, convenient system which can flexibly meet various needs from various users for the box function provided by the data processing apparatus such as the apparatus 100.

The above description mainly concerns control of a printing process when the user selects data functioning as a shortcut in performing box-operation via the user interface of the image forming apparatus 100.

Control of a data erase process when the user selects data functioning as a shortcut in performing box operation via the user interface of the image forming apparatus 100 will be explained. The data erase process will be described with reference to FIG. 24. This control is also performed by the control unit 108.

FIG. 24 shows a state in which the control unit 108 displays the keys 1901B to 1905B in the document selection window 1800B in response to selection of document F via the document selection list 1801B of the window 1800B for box 2 by a user who operates the box of box number 2.

When the user selects document F corresponding to document E whose entity image data is saved in box number 1 is selected by the user in the box document selection window 1800B for the box of box number 2, and the user touches the erase key 1902B of the window 1800B, the control unit 108 controls not to respond to an erase process request from the user.

More specifically, the control unit 108 controls the apparatus 100 to inhibit execution of an erase process for entity image data to be read out from the memory in accordance with shortcut function data defined by document F, i.e., real image data of document E that is saved in the box area 503 of box number 1 (4-page text data input from the host 300 via the printer driver in FIG. 21). The erase process includes a process of inhibiting read of data from the memory even if the user performs any box operation via the operation unit 102 of the image forming apparatus. An example of the erase process method is a complete data erase method of overwriting, with arbitrary data, real data which is stored in the memory and is to be erased. Another example is a simple data erase method of substantially inhibiting read of real data by performing data manipulation for management information in a management table (e.g., FAT table) associated with the data though the real data to be erased remains in the memory.

The reason why the control unit 108 inhibits erase, from the hard disk 107, of entity image data of document E to be read out from the hard disk 107 by user selection of document F corresponding to data functioning as a shortcut to document E will be described below.

For example, real image data of data is not saved in the currently operated box, i.e., the box (box area 504) of box number 2. The real image data of data is stored in another box (in this example, box 1). Thus, erase is inhibited to prevent a situation in which the user of a box other than the currently operated box of box number 2, e.g., the user of box 1 or the user of box 3 cannot utilize real image data of data. An error may occur when erase of real image data of document E corresponding to entity image data of document F is permitted via the operation window 1800B for the box of box number 2 in FIG. 24. For example, the user of box number 1 may not be able to output document E via an operation window (document selection window 1800A in FIG. 22) for the box of box number 1. Also, the distributed user of box number 3 may not be able to output document E via an operation window (document selection window 1800C in FIG. 28) for the box of box number 3.

In order to prevent such an error, according to the embodiment, the control unit 108 controls to inhibit execution of an erase process for entity image data when a job selected via a box operation window is a job functioning as a shortcut for outputting entity image data saved in another box. In other words, the control unit 108 controls to permit execution of an erase process for entity image data when a job selected via a box operation window is a job for outputting entity image data saved in the currently selected box. For example, when the user selects document C via the list 1801B of the window 1800B in FIG. 23 corresponding to the operation window of box 2 and touches the erase key 1902B, the control unit 108 permits erase of entity image data of document C from the hard disk 107. For example, when the user selects document D via the list 1801C of the window 1800C in FIG. 28 corresponding to the operation window of box 3 and touches an erase key 1902C, the control unit 108 permits erase of entity image data of document D from the hard disk 107.

In order to further enhance the effects of the embodiment, user friendliness of a distributed user will be considered. Assume that the user of box 2 corresponding to a distributed user does not need document E whose entity image data is saved in another box. According to the embodiment, the control unit 108 controls to cope with even this situation.

For example, the document selection window 1800B for box 2 is displayed on the display unit 316, and the user selects document F from the list 1801B of the window 1800B. In response to this, the control unit 108 changes the window state from the state in FIG. 23 to that in FIG. 24. Entity image data of the selected document is document E, and is saved in box 1. For this reason, even if the user touches the erase key 1902B which is effectively displayed in the window 1800B of FIG. 24, the control unit 108 controls to inhibit erase of entity image data of document E associated with document F from the hard disk 107. In this case, the control unit 108 controls the display unit 316 to erase, from the window, the list display of document F from a document list displayed in the list 1801B of the window 1800B.

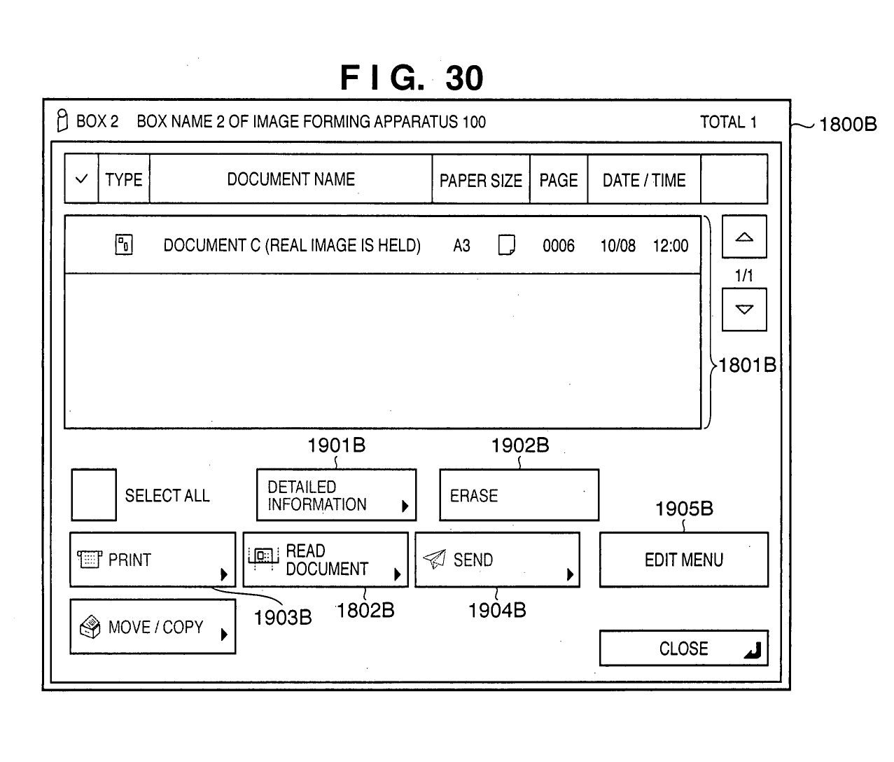

More specifically, when the user selects document F from the list 1801B of the window 1800B in FIG. 24 and touches the erase key 1902B, the display of document F is erased from the list 1802B of the window. This result is illustrated in FIG. 30. In response to this operation, data in the memory is also updated. More specifically, the control unit 108 controls the hard disk 107 to delete data functioning as a shortcut to document E and job information of document F from the box area 504 of box number 2. Accordingly, the data structure of box number 2 changes from the state in FIG. 10 to that in FIG. 9. That is, only data of document C is saved in box 2.

When the user selects, via a box document selection window, data functioning as a shortcut for reading out entity image data saved in another box from the hard disk 107, and inputs an instruction to erase the data, the control unit 108 controls the display unit 316 to inhibit an erase process for the entity image data, but permits deletion of the data from the list of the window.

This can avoid a situation in which a distributed user who receives data in the plural-box simultaneous storage mode cannot delete unnecessary data among document data associated with his box from a document selection list in his box selection window because the data is job data shared by another box to which the data is input in the simultaneous storage mode. Unnecessary data can be deleted from the list, and only necessary data can construct a list, providing a convenient user interface capable of easily selecting a document by the user.

By executing the above control, the control unit 108 controls to inhibit data manipulation for document E via the operation window 1800B for the box of box number 2 but continuously permit data manipulation for document E via an operation window for another box.

More specifically, the control unit 108 executes display control as shown in FIG. 30 to the display unit 316, and inhibits acceptance of a process request for document E via the operation window 1800B for the box of box number 2. To the contrary, when the operation window 1800A of box 1 is displayed, the control unit 108 controls the display unit 316 to execute the display shown in FIG. 22. The control unit 108 inhibits data manipulation for document E via an operation window for the box of box number 2. However, the control unit 108 controls to permit acceptance of a process request for document E from the user via an operation window for the box of box number 1.

Similarly, when the operation window 1800C of box 3 is displayed, the control unit 108 controls the display unit 316 to execute the display shown in FIG. 28. The control unit 108 inhibits data manipulation for document E via an operation window for the box of box number 2, but permits acceptance of a process request for document E from the user via an operation window for the box of box number 3. By executing the above series of control operations in the embodiment, the following effects can be obtained.

For example, the embodiment can prevent an error which may occur when the user of box 2 corresponding to a distributed box executes data manipulation for document E corresponding to a job input in the plural-box simultaneous input mode. An example of this error is that the user of box 1 or 3 corresponding to another distributed box cannot read out document E from the hard disk 107 even by box operation because document E has already been erased from the hard disk 107. The embodiment can prevent generation of this error by employing the above-described control.

By adopting the above-described control, the embodiment can prevent generation of a situation in which the user of the box of box number 2 wants to “delete document E from the document selection list of his box because he will not use document E”, but cannot delete document E from the document selection window for the user of box 2 because the user of distributed box 1 or 3 may use document E.

In this manner, the embodiment can prevent various problems which may occur when the plural-box simultaneous input mode is implemented, and the effects of flexibly meeting various needs from various users who use the box function according to the embodiment can be further enhanced.

The embodiment can provide various mechanisms, and these mechanisms are based on specifications which consider various user needs from various users who use the box function. The embodiment can also be applied to an apparatus which cannot execute all the mechanisms described in the embodiment.

For example, the embodiment can deal with a situation in which the same job data is simultaneously distributed and saved in a plurality of boxes desired by the user among a plurality of data storage boxes prepared in the memory of the data processing apparatus having a function such as the box function. The embodiment attains an effect capable of implementing distribution and save of the same job data in a plurality of boxes by simple operation by a user who wants them. For this reason, the following configuration may also be satisfactory as far as no attention need be paid to the resource (e.g., memory capacity) of the apparatus among the above-mentioned points.

The above example is a control example in which data functioning as a shortcut to entity image data is saved in a distributed box in the plural-box simultaneous storage mode. Instead of this control example, the following control may be executed. The description starts from a state at which the box setting window in FIG. 21 is displayed on the display unit of the host 300. A series of control operations by the host 300 before the window in FIG. 21 is displayed on the display unit of the host 300 are the same as those described above, and a description thereof will be omitted.

For example, as shown in FIG. 21, three boxes, 1, 2, and 33 are selected by the user of the host 300 via the list 1602 of the box setting window 1600 as save destinations of document data of document E which is transmitted from the host 300. The user clicks the OK key 1701, and job data of document E is output from the host 300. After the job data of document E is received by the image forming apparatus 100, the control unit 108 analyzes the job data. The control unit 108 determines that the job data is a job in the plural-box simultaneous storage mode and save destinations are three boxes 1 to 3. The control unit 108 simultaneously saves the job data of document E in the three boxes on the basis of an instruction from the host 300. At this time, the control unit 108 controls the hard disk 107 to execute the following series of data storage control operations.

Entity image data (4-page document data, similar to the above example) and job information (containing a series of process parameters such as printing conditions of document E) of document E are saved in the box area 503 of box number 1. In parallel with (at the same time as) a series of data save processes in box 1, the control unit 108 causes the apparatus 100 to execute the following data storage control.

For example, electronic copy data of entity image data of document E is created using a proper memory work area such as the temporary area 501 of the hard disk 107. Upon the completion of the electronic data copy creation process, the control unit 108 saves the electronic copy data of entity image data of document E with a file name “document F” in the box area 504 of box number 2.

That is, data having the file name “document F” in this example is not virtual data functioning as a shortcut to document E. Document F is entity image data having the same contents as those of entity image data of document E.

The entity image data as copy data of entity condition image data of document E is saved with the file name “document F” in the box area 504 of box number 2. At the same time, the control unit 108 also saves job information of document E in the box area 504 in association with document F.

The control unit 108 controls to execute the same work as the above one for the box area 505 of box number 3 corresponding to another distributed box. More specifically, after a creation process for entity image data corresponding to electronic copy data of entity image data of document E is completed in the temporary area 501, the electronic copy data of entity image data of document E is saved with a file name “document G” in the box area 505 of box number 3. In addition, the control unit 108 also saves job information of document E in the box area 505 in association with document G.

The embodiment may also be applied to this configuration which controls the apparatus 100 to distribute and save copy data of entity image data in a plurality of boxes selected in the plural-box simultaneous storage mode.

If the plural-box simultaneous storage mode is executed by this data storage method of storing electronic copy data of entity image data in a distributed box, the data storage statuses of boxes 1, 2, and 3 in the hard disk 107 become different from a data structure as shown in FIG. 10.

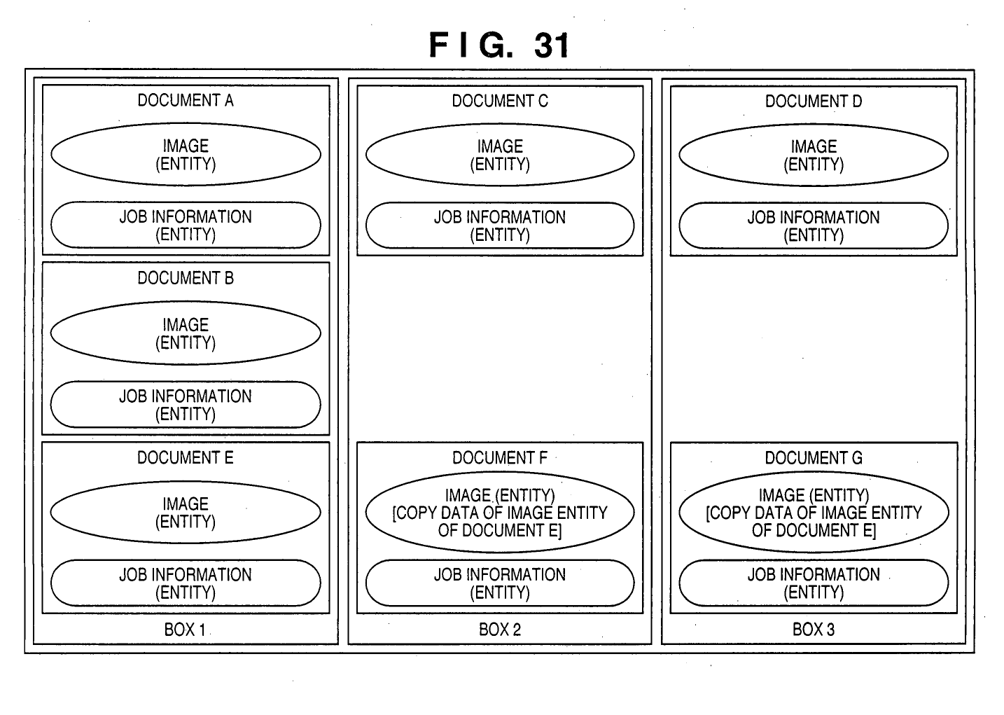

For example, when job data of document E input from the host 300 in the plural-box simultaneous storage mode is stored in a box by the data storage method, the data structures of boxes 1 to 3 become a data structure as shown in FIG. 31. Although the data structure of box 1 is identical to that in FIG. 10, those of boxes 2 and 3 do not save any shortcut function data but save entity image data corresponding to electronic copy data of document E, unlike FIG. 10. In the embodiment, the control unit 108 controls the hard disk 107 to cope with even a case wherein the plural-box simultaneous storage mode is executed by this storage method.

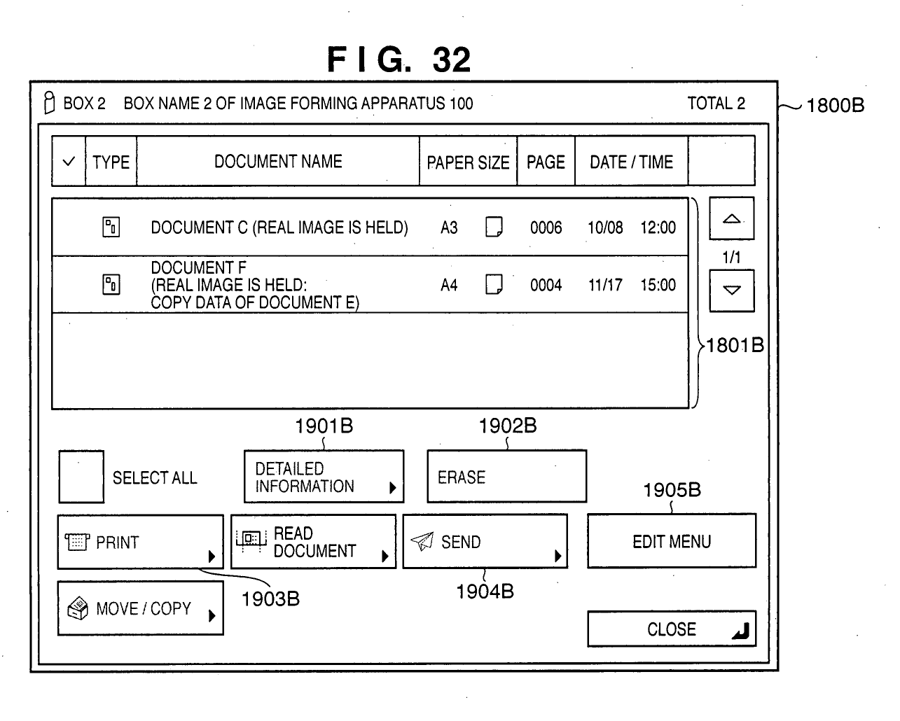

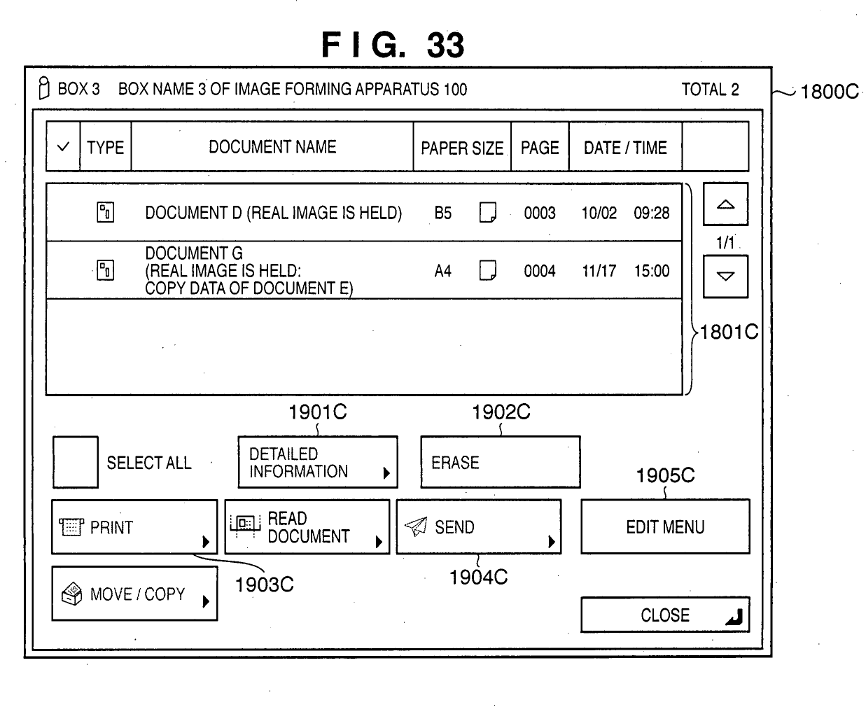

When the same job data is simultaneously saved in a plurality of boxes by the data storage method, the control unit 108 executes user interface operation control which is synchronized with data storage control. For example, the control unit 108 controls the display unit 316 to execute displays in FIGS. 32 and 33 on the basis of a criterion such as the data structure status in FIG. 31 or FAT information. This control will be explained.

When box 2 is selected in the box selection list 601 of FIG. 6 that is displayed on the display unit 316 of the image forming apparatus 100, the control unit 108 displays the document selection window 1800B shown in FIG. 32 on the display unit 316 as an operation window for box 2.

As is apparent from a comparison with the operation control example described with reference to FIG. 23, when display control shown in FIG. 32 is executed, the list 1801B does not display any shortcut icon 2201. This is because copy data of document E is created and entity image data having the same contents as those of document E is saved in box 2.

Hence, as shown in FIG. 32, the list 18001A displays information which allows the user to recognize that entity image data of document F is saved in box 2 and document F is copy data of document E.

When the user selects any document via the list 1801B shown in FIG. 32, the control unit 108 effectively displays the keys 1901B to 1905B in the window 1800B of FIG. 32, as described above.

For example, when the user selects document F via the list 1801B shown in FIG. 32, the control unit 108 effectively displays the keys 1901B to 1905B in the window 1800B of FIG. 32 so as to accept a process request for document F from the user. For example, when the user touches the print key 1903B which is effectively displayed in the window 1800B of FIG. 32, the control unit 108 displays the print setting window 200A in FIG. 25 on the display unit 316, as described above. The user can set various printing process conditions for document F corresponding to copy data of document E via the window 2000A.

Original data of document F displayed in the list of FIG. 32 is document E. According to the embodiment, as described above, printing process conditions can be set in advance for document E via the printer driver 1300 of the host 300.

When printing conditions are set for original data in advance in this manner, the parameters are reflected in the window 2000A. The control unit 108 controls the apparatus 100 to allow a user who operates a box to determine, via the window 2000A, whether to print under printing conditions which have been set in advance for the original data, or to print after the conditions are changed. In order to execute this control, job information is saved in the box area 504 in association with document F, as shown in FIG. 31.

Assume that the user selects document F via the list 1801B shown in FIG. 32, completes various settings and confirmation, and touches the print start key 2002A of the window 2000A in FIG. 25. In response to user operation, the control unit 108 reads out, from the storage area 504 of box 2 in the hard disk 107, entity image data which is electronic copy data of document E and is defined with the file name “document F”. If the user touches the key 2002A without changing printing conditions via the display in FIG. 25, the control unit 108 causes the printer unit 104 to print the readout entity image data (copy data of entity image data of document E) under the printing process conditions which have been set in advance by the host 300 for document E. If the user changes the process conditions via the display in FIG. 25 and then touches the key 2002A, the control unit 108 causes the printer unit 104 to print the readout entity image data under the changed printing process conditions.

In executing control of creating copy data, the control unit 108 can also execute the following control of an erase process. For example, the user selects document F via the list 1801B shown in FIG. 32, and touches the erase key 1902B which is effectively displayed in the window 1800B of FIG. 32. In response to this, the control unit 108 accepts an erase process request for document F.

In this case, the control unit 108 controls to erase document F, i.e., copy data of entity image data of document E from the box area 504. In this control example, the control unit 108 permits execution of an erase process for simultaneously distributed data. In executing an erase process, read of document F, i.e., copy data of entity image data of document E from the hard disk 107 is inhibited by, e.g., overwriting real data with arbitrary data, or clearing management data in an FAT table. Job information of the document is also deleted from the area 504.

In executing control of creating copy data, the control unit 108 can also execute the following control of a data transmission process. For example, the user selects document F via the list 1801B shown in FIG. 32, and touches the send key 1904B which is effectively displayed in the window 1800B of FIG. 32. In response to this, the control unit 108 accepts a data transmission process request for document F.

In this case, the control unit 108 controls the computer interface unit 106 to read out document F, i.e., copy data of entity image data of document E from the box area 504 and transmit the readout entity image data to an external apparatus desired by the user in a data format desired by the user. In this fashion, the control unit 108 permits execution of a transmission process for entity image data of simultaneously distributed data.

The control unit 108 controls the apparatus 100 to execute the same process as the above one even when box number 3 corresponding to another distributed box is operated.

For example, when box 3 is selected in the box selection window 601 of FIG. 6 that is displayed on the display unit 316 of the image forming apparatus 100, the control unit 108 displays the document selection window 1800C shown in FIG. 33 as an operation window for box 3 on the display unit 316.

Data having a file name “document G” in the list 1801C of FIG. 33 is copy data of entity image data of document E which is saved at box number 1. The copy data is saved in the box area 505 of box 3.

If the user selects document G corresponding to copy data of entity image data of document E via the list 1801C in FIG. 33, the control unit 108 effectively displays the keys 1901C to 1905C in the window 1800C of FIG. 33. The control unit 108 controls to accept a desired process request for document G from the user.

Also in this example, a user interface for box number 1 at which entity image data of document E is saved is identical to the box setting window 1800A in FIG. 22, and the user of a box which saves original data can execute the same process as the above one. In this example, even when box 1 is selected in the window of FIG. 6, the control unit 108 displays the window 1800A in FIG. 22 on the display unit 316, and executes the same control as the above-described one.

Also in executing an operation sequence of storing electronic copy data of entity image data in a distributed box in the plural-box simultaneous storage mode, various process requests for the data can be separately accepted from the user for each distributed box via a box operation window for the distributed box.

In the embodiment, the operation sequence of storing electronic copy data of entity image data in a distributed box in the plural-box simultaneous storage mode will be called an electronic copy data distribution mode in the plural-box simultaneous storage mode. To the contrary, the above-described operation sequence of saving, in a distributed box, shortcut function data for allowing the user to input an instruction to read out entity image data present in a given box from the memory via the UI of a different box will be called a shortcut function data distribution mode in the plural-box simultaneous storage mode.

The merits of these modes will be explained. Merits common to these two modes will be described. For example, when either mode is executed, the embodiment can deal with a situation in which the same job data is simultaneously distributed and saved in a plurality of boxes desired by the user among a plurality of data storage boxes prepared in the memory of the data processing apparatus having the box function. In addition, this can be implemented by simple operation by a user who wants to distribute and save the same job data in desired boxes. As a result, user friendliness in simultaneously storing data in a plurality of boxes can be improved.

Merits specific to the former mode, i.e., the shortcut function data distribution mode in the plural-box simultaneous storage mode will be explained. If this mode can be executed, the resource necessary for the box function can be saved while the effects common to the two modes are achieved. For example, the embodiment uses the hard disk 107 for the box function, but one box suffices to store entity image data for a job in the plural-box simultaneous storage mode. Therefore, a job in the plural-box simultaneous storage mode can be dealt with at a small memory capacity.

Merits specific to the latter mode, i.e., the electronic copy data distribution mode in the plural-box simultaneous storage mode will be explained. If this mode can be executed, user friendliness of a distributed box can be further improved while the effects common to the two modes are attained.

For example, when the former mode described in the embodiment is to be executed, the control unit 108 can execute the following operation according to the embodiment. For example, the user of box 1 selects document E via an operation window for box 1 and the list 1801A of the window 1800A in FIG. 22, and touches the erase key 1902A which is effectively displayed. In this case, the control unit 108 erases entity image data of document E from the box area 503 of box 1.

As a result, read of the entity image data of document E from the hard disk 107 is inhibited. Even if the user performs box operation, acceptance of a process request for entity image data of document E is inhibited. For example, the list display of information of document E is deleted from the list 1801A of the document selection window 1800A in FIG. 22 that is associated with the box of box number 1. In response to execution of the erase process for entity image data of document E, the list of the operation window of a distributed box such as box 2 or box 3 is also automatically updated.

For example, when the document selection window of box 2 is displayed on the display unit 316 after the erase process for entity image data of document E is executed under the above control, the list display of information of document F associated with document E is automatically deleted from the list of the list 1801B in FIG. 23. Similarly when the document selection window of box 3 is displayed on the display unit 316, the list display of information of document G associated with document E is automatically deleted from the list of the list 1801C in FIG. 28.

As described above, when the apparatus 100 executes an operation like the shortcut function data distribution mode in the plural-box simultaneous storage mode, acceptance of an instruction to erase entity image data is permitted via the operation window of box 1 which saves the entity image data. Upon reception of the instruction, the control unit 108 executes the erase process for the entity image data. Upon the completion of the erase process, the control unit 108 controls the display unit 316 so that a display item for accessing entity image data of document E from a window for box number 2 or box number 3 corresponding to another distributed box is automatically deleted from the list upon the completion of executing the erase process. Under this control, access from another distributed box is inhibited.

In contrast, if the apparatus 100 can execute the electronic copy data distribution mode in the plural-box simultaneous storage mode, the apparatus 100 can perform the following operation under the control of the control unit 108.

For example, the user of box number 1 selects document E via the list 1801A in FIG. 22, and touches the erase key 1902A which is effectively displayed in the window. Then, the control unit 108 erases entity image data and job information of document E from the box area 503 of box 1. At the same time, the control unit 108 updates the display contents of the operation window of box 1 so as to delete a display item corresponding to document E from the list 1801A of the operation window 1800A of box 1. Under this control, acceptance of a process request for entity image data of document E from the user via the operation window 1800A of box 1 is inhibited.

However, even if entity image data and job information of document E are erased from the storage area 503 of box 1, the control unit 108 controls not to erase copy data (entity) of entity image data of document E and job information of the job from the storage area 504 of box 2 and the storage area of box 3 where the copy data of entity image data of document E is saved. The control unit 108 controls the hard disk 107 to leave the copy data of entity image data of document E and its job information in these areas.

Even if the list display of document E is deleted from the list 1801A of the operation window 1800A of box 1 in synchronism with the control, the control unit 108 inhibits deletion of the list display of document F from the list 1801B of the operation window 1800B of box 2. Also, the control unit 108 inhibits deletion of the list display of document G from the list 1801C of the operation window 1800C of box 3.

That is, when the operation window of box number 2 is displayed on the display unit 316 after the list display of document E is deleted from the list 1801A of the operation window 1800A of box number 1 in FIG. 22, the control unit 108 controls the display unit 316 to maintain the display state in FIG. 32. If document F is selected via the list 1801B of the window 1800B of box 2 in FIG. 32, various process requests for copy data of entity image data of document E associated with document F which is saved in the storage area 504 of box 2 can be accepted from the user of box 2. The control unit 108 controls to execute a process corresponding to an instruction from the user of box 2 for the copy data (entity) which is saved in the storage area 504 of box 2.

Similarly, when the operation window of box number 3 is displayed on the display unit 316 after the list display of document E is deleted from the list 1801A of the operation window 1800A of box number 1 in FIG. 22, the control unit 108 controls the display unit 316 to maintain the display state in FIG. 33. If document G is selected via the list 1801C of the window 1800C of box 3 in FIG. 33, various process requests for copy data of entity image data of document E associated with document G which is saved in the storage area 505 of box 3 can be accepted from the user of box 3. The control unit 108 controls to execute a process corresponding to an instruction from the user of box 3 for the copy data (entity) which is saved in the storage area 505 of box 3.

The above control will be further explained. For example, a request to execute an erase process for document F is accepted via the operation window 1800B of box 2 from the user of box 2. In this case, the control unit 108 erases electronic copy data of entity image data of document E and its job information from the storage area 504 of box 2. However, the control unit 108 controls to accept a process request for the entity image data of document E from the user of box 1 via the window 1800A of box 1. The control unit 108 also controls to accept a process request for the copy data of entity image data of document E from the user of box 3 via the window 1800C of box 3.

With the configuration capable of storing job data in a plurality of boxes in the electronic copy data distribution mode in the plural-box simultaneous storage mode, control independent of other boxes can be executed box by box for job data to be simultaneously stored.

The embodiment can, therefore, prevent a problem which may be generated in an apparatus configuration capable of executing an operation such as the shortcut function data distribution mode in the plural-box simultaneous storage mode. For example, in the shortcut function data distribution mode, the embodiment can prevent generation of a situation in which the users of boxes 2 and 3 cannot access entity image data of document E and obtain any output product of data corresponding to the entity image data of document E because the user of box 1 erases document E.

As described above, either the data sharing method using the shortcut function or the electronic copy data creation function for entity image data can be employed. As far as the above-mentioned effects which can be obtained commonly by these methods can be achieved, the embodiment can be applied to any system/apparatus configuration or any data processing method.

In other words, the embodiment adopts various control configurations concerning the box function, as described above. All these configurations are high-value-added specifications which consider user friendliness, use environment, and the like, and all these control configurations need not always be implemented. This is because, by employing at least one of the above-described control configurations, solutions for problems assumed in the background art can be proposed to contribute to improvements in box function and usability.

Considering further enhancement of the effect of flexibly meeting various user needs for the box function, the embodiment may execute the following control.

The above configuration example is a concrete example which is included in the embodiment as far as the apparatus can execute only one of an operation such as the shortcut function data distribution mode in the plural-box simultaneous storage mode and an operation such as the electronic copy data distribution mode in the plural-box simultaneous storage mode. An apparatus which has these two modes is assumed, and the user can select and determine which of the modes is used to operate the apparatus.

The apparatus 100 according to the embodiment will be exemplified. In the apparatus 100, when the user touches the user mode key 311 of the operation unit 102 shown in FIG. 4, the control unit 108 displays, on the display unit 316, a user mode window for allowing the user to register initial settings of various functions of the apparatus 100. As for the settings (e.g., a setting for registering a box name) of various box functions described above, their initial settings can also be registered by the user in the user mode.

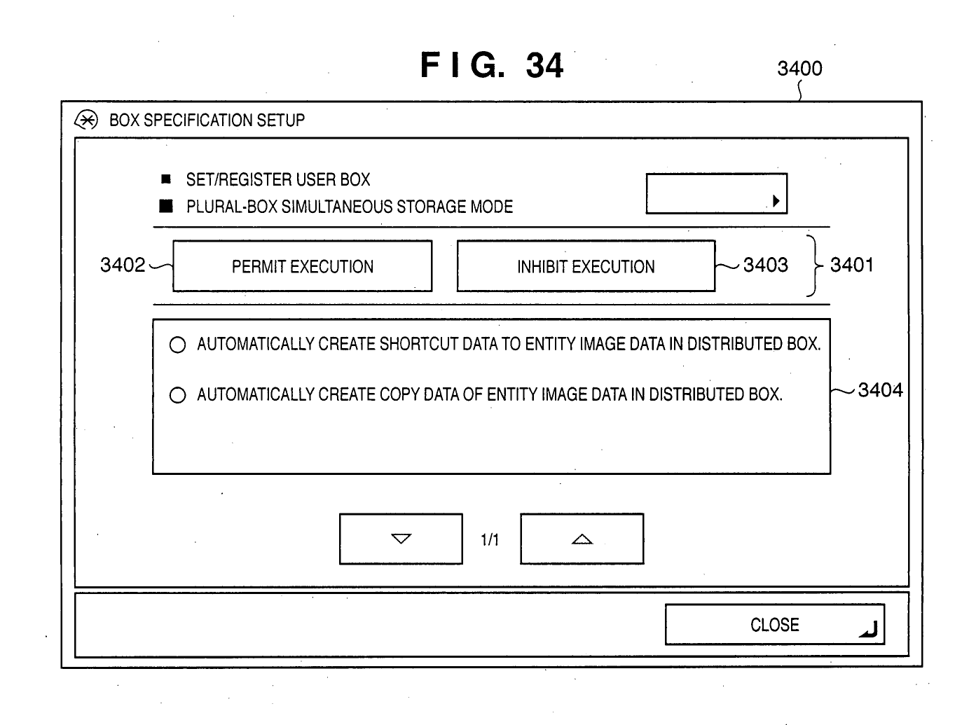

When the user mode is selected and the user performs initial settings of the box function, the control unit 108 controls the display unit 316 to display a window shown in FIG. 34.

A window 3400 is a display window for performing initial settings of the box function. The control unit 108 controls to allow the user to select in advance whether to permit or inhibit execution of the above-described plural-box simultaneous storage mode via keys 3402 and 3403 in a selection item 3401 of the window 3400.

The example of FIG. 34 corresponds to a state in which the key 3403 is set to inhibit execution of the plural-box simultaneous storage mode. If this setting is selected for the image forming apparatus 100, the control unit 108 transmits the setting information to the data generation apparatus. That is, even the host 300 corresponding to an example of the data generation apparatus is notified of the box setting information.

With this setting, for example, the control unit of the host 300 controls not to accept a request to execute the plural-box simultaneous storage mode from the user of the host 300. For example, when the box setting window 1600 in FIG. 16 is displayed on the display unit of the host 300, only one box can be selected, and selection of a plurality of boxes is inhibited. That is, a box selection setting in the list 1600 as shown in FIG. 17 is permitted, but selection of a plurality of boxes in the list 1600 as shown in FIG. 21 is inhibited. Under this control, execution of the plural-box simultaneous storage mode is inhibited, but execution of the single-box storage mode is permitted.

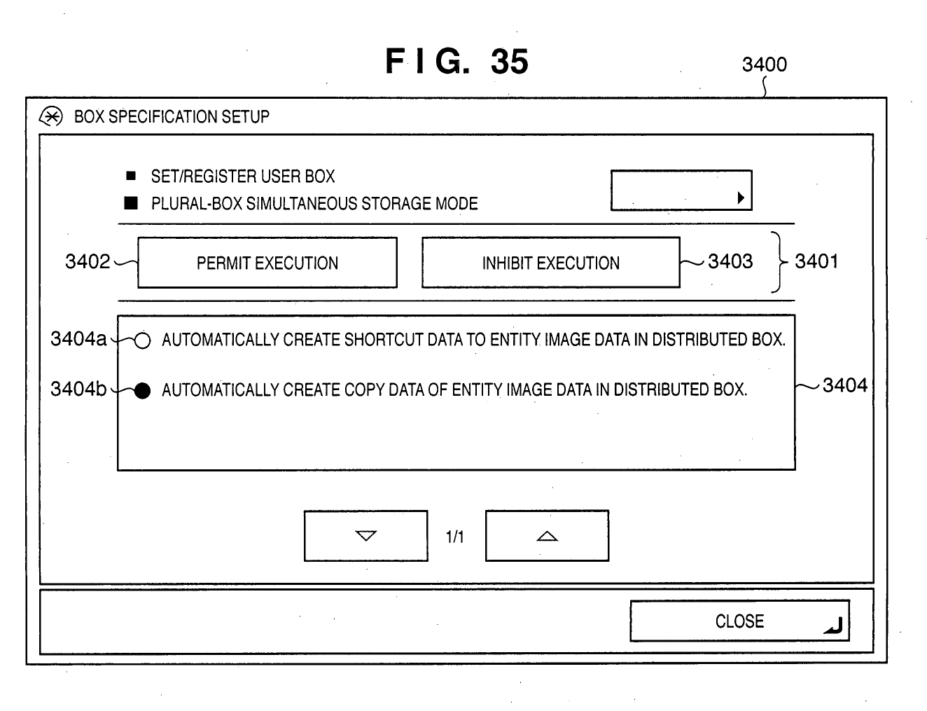

To the contrary, when the user touches the key 3402 in the window 3400 of FIG. 34 to make a setting of permitting execution of the plural-box simultaneous storage mode, the control unit 108 controls the display unit 316 to change the display contents of the window 3400 to those as shown in FIG. 35. Also when this setting is made for the image forming apparatus 100, the control unit 108 transmits the setting information to the data generation apparatus. That is, even the host 300 corresponding to an example of the data generation apparatus is notified of the box setting information.

With this setting, for example, the host 300 can execute various control operations described above. More specifically, only one box can be selected via the box setting window 1600 as shown in FIG. 17, and a target job can be processed by the apparatus 100 in the single-box storage mode (see a control example when document C is input). Moreover, a plurality of boxes can be selected by the user via the box setting window 1600 as shown in FIG. 21, and target job data can be processed by the apparatus 100 in the plural-box simultaneous storage mode (see a control example when document E is input).

When the setting of inhibiting execution of the plural-box simultaneous storage mode is made, the control unit 108 grays out a selection item 3404 in the window 3400, as shown in FIG. 34. This control inhibits the user from inputting any instruction via the item 3404.

When the setting of permitting execution of the plural-box simultaneous storage mode is made, the control unit 108 effectively displays the selection item 3404 in the window 3400, as shown in FIG. 35. This control permits the user to input an instruction via the item 3404.

In the embodiment, when the plural-box simultaneous storage mode is executed, the control unit 108 controls to prompt the user to select either of selection columns 3404a and 3404b in the selection item 3505. The user can, therefore, determine in advance which of the shortcut function data distribution mode and electronic copy data distribution mode is executed by the apparatus 100 in the plural-box simultaneous storage mode.

The display state in FIG. 35 represents an example when the shortcut function data distribution mode is selected by selecting the selection column 3404a. When the shortcut function data distribution mode is set for the apparatus 100 in executing the plural-box simultaneous storage mode, the control unit 108 can execute various control operations explained in the description of the shortcut function data distribution mode (see the descriptions of FIGS. 10 and 22 to 30).

Alternatively, the electronic copy data distribution mode can be set when the user selects the selection column 3404b of the selection item 3404 shown in FIG. 35. When the electronic copy data distribution mode is set for the apparatus 100 in executing the plural-box simultaneous storage mode, the control unit 108 can execute various control operations explained in the description of the electronic copy data distribution mode (see the descriptions of FIGS. 31, 22, and 31 to 33).

This configuration can implement the plural-box simultaneous storage mode in a mode desired by the user among the shortcut function data distribution mode and electronic copy data distribution mode. Optimal operation can, therefore, be selected in consideration of the merits of these two modes. The effect of flexibly meeting various user needs for the box function can be further enhanced. However, this control is a specification which considers user merits in the box function, and need not always be employed.

In the embodiment, as described in detail above, the configuration is common to both the shortcut function data distribution mode and electronic copy data distribution mode in at least the following points.

A data processing system including a data processing apparatus (e.g., the image forming apparatus 100) having a storage unit (e.g., the hard disk 107) capable of storing data in a plurality of boxes including the first and second boxes is configured as follows.

When the first job data transmitted from the data generation apparatus is stored in the storage unit without performing any predetermined operation via the user interface unit of the data generation apparatus such as the host 300, the embodiment controls the data processing apparatus to permit acceptance of a process request for the first job data from the user via the first display associated with the first box.

This configuration corresponds to a control example when only the box of box number 2 is selected as a save destination by the user of the host 300 via the box setting window 1600 of the host 300 as shown in FIG. 17 without selecting a plurality of boxes, and then the apparatus 100 receives job data of document C from the host 300. After analyzing the received data, the control unit 108 saves the job data in the box area 504 of box 2 in the hard disk 107. In this case, a process request for entity image data of document C can be accepted from the user via an operation window necessary to use the box of box number 2. A process desired by the user can be executed for the entity image data of document C (see FIGS. 18 to 20, and the like).

Similarly, the above configuration corresponds to a control example when only the box of box number 1 is selected as a save destination by the user of the host 300 via the box setting window 1600 of the host 300 without selecting a plurality of boxes, and then the apparatus 100 receives job data of document A from the host 300. After analyzing the received data, the control unit 108 saves the job data in the box area 503 of box 1 in the hard disk 107. In this case, a process request for entity image data of document A can be accepted from the user via the operation window of the box of box number 1. A process desired by the user can be executed for the entity image data of document A (see FIG. 22 and the like).

In other words, the control unit 108 inhibits manipulation of entity image data of document A via a user interface window for a box (e.g., box 2 or 3) other than box 1. This configuration also corresponds to a control example when only the box of box number 1 is selected as a save destination by the user of the host 300 via the box setting window 1600 of the host 300 without selecting a plurality of boxes, and then the apparatus 100 receives job data of document B from the host 300.

Similarly, the above configuration corresponds to a control example when only the box of box number 3 is selected as a save destination by the user of the host 300 via the box setting window 1600 of the host 300 without selecting a plurality of boxes, and then the apparatus 100 receives job data of document D from the host 300. After analyzing the received data, the control unit 108 saves the job data in the box area 505 of box 3 in the hard disk 107. In this case, a process request for entity image data of document D can be accepted from the user via the operation window of the box of box number 3. A process desired by the user can be executed for the entity image data of document D (see FIGS. 28, 29, and the like). In other words, the control unit 108 inhibits manipulation of entity image data of document D via a user interface window for a box (e.g., box 1 or 2) other than box 3.

A job which is input from the data generation apparatus after only one box is designated as a save destination without selecting a plurality of boxes will be called the first job. In other words, a job to be processed in the single-box storage mode will be called the first job. In this connection, a box which saves entity image data will be called the first box.

The embodiment is premised on this configuration, and further provides the following configuration.

When the second job data transmitted from the data generation apparatus is stored in the storage unit upon performing predetermined operation via the user interface unit of the data generation apparatus such as the host 300, the embodiment controls the data processing apparatus to accept a process request for the second job data via the first display associated with the first box, and accept a process request for the second job data via the second display associated with the second box.

This configuration corresponds to a control example when boxes 1, 2, and 3 are selected as save destinations by the user of the host 300 via the box setting window 1600 of the host 300 as shown in FIG. 21 in plural-box selection operation, and then the apparatus 100 receives job data of document E from the host 300. After analyzing the received data, the control unit 108 saves the job data in the box areas 503, 504, and 505 of boxes 1, 2, and 3 in the hard disk 107. In the shortcut function data distribution mode, document F corresponding to data functioning as a shortcut for reading put entity image data of document E is saved in box 2. Similarly, document G corresponding to data functioning as a shortcut for reading out entity image data of document E is saved in box 3. In the electronic copy data distribution mode, entity image data corresponding to copy data of entity image data of document E is saved as document F in box 2. Similarly, entity image data corresponding to copy data of entity image data of document E is saved as document G in box 3. In either mode, original entity image data of document E is saved in box 1 (see FIGS. 10 and 31).

In this case, a process request for entity image data of document E can be accepted from the user via an operation window necessary to use the box of box number 1. A process desired by the user of box 1 can be executed for the entity image data of document E (see FIG. 22 and the like).

Similarly, process requests for entity image data of document E (or entity image data corresponding to copy data of entity image data of document E) can be accepted from the users of boxes 2 and 3 via the user interfaces of boxes 2 and 3 which do not save any original entity image data of document E. Processes desired by the users of boxes 2 and 3 can be executed for the entity image data of document E (see FIGS. 23 to 27, 28, 29, 30, 32, 33, and the like).

A job which is input from the data generation apparatus after a plurality of boxes are selected as save destinations by the user of the data generation apparatus will be called the second job. In other words, a job to be processed in the plural-box simultaneous storage mode will be called the second job. In this connection, a box which saves original entity image data will be called the first box, and a box which does not save any original entity image data will be called the second box.

The embodiment is premised on this configuration, and allows the user of the data generation apparatus to select a plurality of boxes which are to simultaneously save job data of the same contents from a plurality of data boxes (100 boxes in the embodiment) in the memory of the data processing apparatus.

As an example of this configuration, as shown in FIG. 21, the control unit of the host 300 controls the display unit of the host 300 to display the box setting window 1600 for allowing the user of the host 300 to select a plurality of boxes which are to simultaneously save image data of the same contents. The user of the host 300 can select a plurality of boxes such as boxes 1 to 3 via the window.

Moreover, the embodiment is premised on the above configuration, and controls to allow the user of the data generation apparatus to select which of boxes is to save entity image data when the same job data is simultaneously stored in a plurality of boxes.

As an example of this configuration, as shown in FIG. 21, entity image data can be saved in a box which is selected first by the user of the host 300 via the box setting window 1600.

In order to further improve user friendliness for a job to be processed in the plural-box simultaneous storage mode according to the embodiment, the embodiment may execute the following control.

For example, the user of the host 300 clicks an OK key via the printer driver window 1300 of the host 300 after making a setting of saving job data of document E in boxes 1 to 3. Upon reception of the job input instruction, the control unit of the host 300 transmits the job data to the image forming apparatus 100 page by page in an order from the first page if the document is made up of a plurality of pages. The image forming apparatus 100 sequentially bitmaps the job data transmitted from the host 300 into bitmap images of respective pages, and then saves the entity image data in the boxes. Finally, the job data is saved in all the boxes designated by the user of the host 300.

The period of a series of work operations is generated as a period until a data save process for job data in a plurality of boxes by the data processing apparatus is completed after the data processing apparatus accepts a job data process start request from the user in the plural-box simultaneous storage mode. The period of the series of work operations becomes longer as the number of boxes to save the same job data becomes larger.

In this situation, assume that the user of the data generation apparatus notices that job data should not be distributed to each box immediately after a request to execute a target job in the plural-box simultaneous storage mode is input to the data generation apparatus. For example, the user of the host 300 tries to store job data of document E in a plurality of boxes but erroneously inputs another document. Alternatively, the user inputs document E but sets improper printing process conditions. In this case, the user of the data generation apparatus may want to cancel the job. It is considered preferable to flexibly cope with such a situation, and thus the embodiment may execute the following control.

For example, as shown in FIG. 21, the user of the host 300 selects a plurality of boxes via the box setting window 1600, and clicks the OK key 1302 of the basic window 1300 of the printer driver in FIG. 13. Then, the control unit of the host 300 determines that an output start request has been accepted, and transmits job data of document E to be processed in the plural-box simultaneous storage mode to the image forming apparatus 100. After the image forming apparatus 100 receives the job data, the control unit 108 analyzes command data of the job data and determines the process request which has been input by the user via the user interface of the host 300. The control unit 108 determines that job data of document E is a job to be saved in boxes 1, 2, and 3, similar to the above example. The control unit 108 controls the hard disk 107 to start and execute a series of data storage processes, similar to the above example.

More specifically, entity image data (all bitmap image data of four pages) of document E, and job information (containing a series of printing process condition data designated by the host 300 for document E) of document E are saved in the box area 503 of box number 1. In addition, shortcut function data of entity image data of document E (in the electronic copy data distribution mode, electronic copy data of entity image data of document E), and the job information of document E are saved in the box area 504 of box number 2. Also, the shortcut function data of entity image data of document E (in the electronic copy data distribution mode, electronic copy data of entity image data of document E), and the job information of document E are saved in the box area 505 of box number 3.

Upon the completion of all processes for the three boxes, the control unit 108 determines that all work for the job of document E from the host 300 has been completed (in the example of FIG. 11, this state corresponds to the end of the process in FIG. 11 for NO in step S1103).

If all processes of the job are not completed, the control unit 108 controls the hard disk 107 to keep executing the data storage process for the job till the completion of the job processes (in the example of FIG. 11, this control corresponds to a loop process of repeating processes in steps S1104 to S1106 for YES in step S1103).

The control unit 108 monitors various operation states of the apparatus 100, a process request input from the user via the operation unit 102, and the like even during the period until a series of processes for the job are completed after the hard disk 107 starts a series of data storage processes for the job of document E to be processed in the plural-box simultaneous storage mode. The control unit 108 accepts input of various data from an external apparatus even during execution of the job.

Further, the control unit 108 monitors the process status of the job (progress of the job). For example, the control unit 108 confirms whether a series of processes of storing job data to be processed in the plural-box simultaneous storage mode in all boxes selected by the user of the data generation apparatus are uncompleted.

The control unit 108 controls to accept, from the user via a user interface, an instruction to cancel the process of a job while monitoring the process status of the job.

In the above example, the computer interface unit 106 can accept an instruction to cancel a plural-box simultaneous storage process for job data of document E that is input by the user of the host 300 via a setting window on the display unit of the host 300 corresponding to a transmitting side for a job of document E. Also, an instruction to cancel the job can be accepted from the user of the image forming apparatus 100 via the operation unit 102 corresponding to the user interface of the apparatus 100.

In this configuration, for example, an instruction (to be also referred to as an abort instruction or stop instruction) to cancel a job of document E is input via the user interface while a box storage process for the job of document E is executed by the image forming apparatus 100.

The progress of a job upon input of the job cancel instruction is as follows.

(1) A data storage process for box 1 has ended. That is, a process of saving entity image data (all bitmap image data of four pages) of document E, and job information (containing a series of printing process condition data designated by the host 300 for document E) of document E in the box area 503 of box number 1 has ended.

(2) A data storage process for box 2 is in execution. That is, a process of saving shortcut function data of entity image data of document E (in the electronic copy data distribution mode, electronic copy data of entity image data of document E), and job information of document E in the box area 504 of box number 2 is in progress.

(3) A data storage process for box 3 does not start yet because the process for box 2 has not ended. That is, a process of saving shortcut function data of entity image data of document E (in the electronic copy data distribution mode, electronic copy data of entity image data of document E), and job information of document E in the box area 505 of box number 3 does not start yet.

As described above, a storage process for job data of document E in box 1 has been completed as the process status of the job upon acceptance of the job cancel instruction. A storage process for job data of document E in box 2 is in progress. A storage process for job data of document E in box 3 does not start.

When the control unit determines the above status on the basis of job process status information from the hard disk 107, it causes the apparatus 100 to execute a process of canceling the job of document E.

In order to further improve the effect of flexibly meeting various needs from users, the cancel process to be executed is desirably any one of the following control operations.

[Cancel Control 1: Plural-Box All Cancel Mode]

In executing this control, the control unit 108 cancels (invalidates) a job data save process for all boxes selected by the user of the data generation apparatus including even a box in which job data to be canceled has been stored, among a plurality of boxes selected by the user.

This control will be called a “plural-box all cancel mode” for a job to be processed in the plural-box simultaneous storage mode.

Control operation in executing this mode will be explained using the above example. Assume that at least part of shortcut function data of entity image data of document E (in the electronic copy data distribution mode, electronic copy data of entity image data of document E), and at least part of job information of document E have been saved in the box area 504 of box number 2 in process. Incomplete data on a job of document E that is stored in the box area 504 of box number 2 is erased from the area 504. However, the control unit 108 controls not to erase but to leave data of another job which has been saved in box 2. That is, data of document C is kept saved in the area 504 of box 2.

While executing this control, the control unit 108 also controls the operation unit 102. More specifically, the control unit 108 executes the list display of document C in the list 1801B of the document selection window 1800B for operating the box of box number 2, as shown in FIG. 23 or 32. However, the control unit 108 controls not to execute the list display of document F. Accordingly, the control unit 108 permits acceptance of a process request for data of document C from the user via the window 1800B of box 2, but inhibits acceptance of a process request for data of document F.

In executing the all cancel mode, the control unit 108 controls to erase all job data of document E from the box area 503 of box number 1 where the job data of document E has been stored. That is, entity image data (all bitmap image data of four pages) of document E, and job information (containing a series of printing process condition data designated by the host 300 for document E) of document E are erased from the box area 503 of box number 1. However, the control unit 108 controls not to erase but to leave data of another job which has been saved in box 1. That is, job data of documents A and B are kept saved in the area 503 of box 1.

While executing this control, the control unit 108 also controls the operation unit 102. More specifically, the control unit 108 executes the list display of documents A and B in the list 1801A of the document selection window 1800A for operating the box of box number 1, as shown in FIG. 22. However, the control unit 108 controls not to execute the list display of document E. Consequently, the control unit 108 permits acceptance of a process request for data of documents A and B from the user via the window 1800A of box 1, but inhibits acceptance of a process request for data of document E.

After the above process is executed, the control unit 108 determines that the cancel process for the job of document E has been completed, and ends the process without executing a further process for the job of document E by the apparatus 100.

As for box 3 which does not save any job data of document E, the control unit 108 ends the process directly. The control unit 108 controls the operation unit 102 in correspondence with the control. More specifically, the control unit 108 executes the list display of document D in the list 1801C of the document selection window 1800C for operating the box of box number 3, as shown in FIG. 28 or 33. However, the control unit 108 controls not to execute the list display of document G. Hence, the control unit 108 permits acceptance of a process request for data of document D from the user via the window 1800C of box 3, but inhibits acceptance of a process request for data of document E. The above operation is an example of the all cancel mode.

[Cancel Control 2: Plural-Box Individual Cancel Mode A]

In executing this control, the control unit 108 operates the apparatus 100 as follows. When a storage process for job data to be canceled has ended in any one of boxes selected by the user of the data generation apparatus, the job data is left in the box. For a box in which a storage process for job data to be canceled is not completed (e.g., a box during the storage process for the job data or an unprocessed box in which no storage process for the job data does not start yet), the control unit 108 cancels (invalidates) a job data save process.

This control will be called a “plural-box all cancel mode” for a job to be processed in the plural-box simultaneous storage mode.

Control operation in executing this mode will be explained using the above example. Assume that at least part of shortcut function data of entity image data of document E (in the electronic copy data distribution mode, electronic copy data of entity image data of document E), and at least part of job information of document E have been saved in the box area 504 of box number 2. Incomplete data on a job of document E that is stored in the box area 504 of box number 2 is erased from the area 504. However, the control unit 108 controls not to erase but to leave data of another job which has been saved in box 2. That is, data of document C is kept saved in the area 504 of box 2.

While executing this control, the control unit 108 also controls the operation unit 102. More specifically, the control unit 108 executes the list display of document C in the list 1801B of the document selection window 1800B for operating the box of box number 2, as shown in FIG. 23 or 32. However, the control unit 108 controls not to execute the list display of document F. Accordingly, the control unit 108 permits acceptance of a process request for data of document C from the user via the window 1800B of box 2, but inhibits acceptance of a process request for data of document F.

In executing the individual cancel mode A, the control unit 108 controls not to erase but to leave job data of document E in the box area 503 of box number 1 where the job data of document E has been stored. That is, entity image data (all bitmap image data of four pages) of document E, and job information (containing a series of printing process condition data designated by the host 300 for document E) of document E are kept saved in the box area 503 of box number 1. In this way, when the mode A is executed, even job data to be canceled is not erased but is kept saved in a box in which data has been stored. Needless to say, another job data which has been saved in box 1 is also kept saved. That is, job data of documents A and B are also kept saved in the area 503 of box 1.

While executing this control, the control unit 108 also controls the operation unit 102. More specifically, the control unit 108 executes the list display of documents A and B in the list 1801A of the document selection window 1800A for operating the box of box number 1, as shown in FIG. 22. At the same time, the control unit 108 controls to execute the list display of document E. As a result, the control unit 108 permits acceptance of a process request for data of documents A and B from the user via the window 1800A of box 1, and also permits acceptance of a process request for data of document E.

After the above process is executed, the control unit 108 determines that the cancel process for the job of document E has been completed, and ends the cancel process without executing a further process for the job of document E by the apparatus 100.

As for box 3 which does not save any job data of document E, the control unit 108 ends the process directly. The control unit 108 controls the operation unit 102 in correspondence with the control. Control for box 3 is the same as that in the all cancel mode.

The above operation is the plural-box individual cancel mode A.

[Cancel Control 3: Plural-Box Individual Cancel Mode B]

In executing this control, the control unit 108 operates the apparatus 100 as follows. For example, job data to be canceled is kept saved in a box in which the job data to be canceled has already been stored when a cancel instruction is input. For a box in process in which a storage process for job data to be canceled starts, the job data storage process continues to save the job data to be canceled. After the end of saving the data in the box in which the data save process has proceeded, the job process ends. In other words, the control unit 108 cancels (invalidates) a job data save process for an unprocessed box in which no storage process for job data to be canceled does not start yet.

Control operation in executing this mode will be explained using the above example. Assume that at least part of shortcut function data of entity image data of document E (in the electronic copy data distribution mode, electronic copy data of entity image data of document E), and at least part of job information of document E have been saved in the box area 504 of box number 2. The job data storage process continues in the box area 504 of box number 2 until complete data on the job of document E is saved in the box area 504 of box 2. The data of document E, and data of document C which has been saved in box 2 and corresponds to another job data are kept saved in the area 504 of box 2.

While executing this control, the control unit 108 also controls the operation unit 102. More specifically, the control unit 108 executes the list display of document C in the list 1801B of the document selection window 1800B for operating the box of box number 2, as shown in FIG. 23 or 32. Also, the control unit 108 controls to execute the list display of document F. With this setting, the control unit 108 permits acceptance of a process request for data of document C from the user via the window 1800B of box 2, and also permits acceptance of a process request for data of document F.

In executing the individual cancel mode B, the control unit 108 controls not to erase but to leave job data of document E in the box area 503 of box number 1 where the job data of document E has been stored. That is, entity image data (all bitmap image data of four pages) of document E, and job information (containing a series of printing process condition data designated by the host 300 for document E) of document E are kept saved in the box area 503 of box number 1. As a matter of course, another job data which has been saved in box 1 is also kept saved. That is, job data of documents A and B are kept saved in the area 503 of box 1.

While executing this control, the control unit 108 also controls the operation unit 102. More specifically, the control unit 108 executes the list display of documents A and B in the list 1801A of the document selection window 1800A for operating the box of box number 1, as shown in FIG. 22. At the same time, the control unit 108 controls to execute the list display of document E. Accordingly, the control unit 108 permits acceptance of a process request for data of documents A and B from the user via the window 1800A of box 1, and also permits acceptance of a process request for data of document E.

After the above process is executed, the control unit 108 determines that the cancel process for the job of document E has been completed, and ends the process without executing a further process for the job of document E by the apparatus 100.

As for box 3 which does not save any job data of document E, the control unit 108 ends the process directly. The control unit 108 controls the operation unit 102 in correspondence with the control. Control for box 3 is the same as those in the all cancel mode and mode A.

The above operation is the plural-box individual cancel mode B.

The above effects can be expected by executing at least one of these three control modes by the apparatus of the embodiment.

The embodiment can also be applied when at least one of these three control modes is executed. From examination of the user status, however, it is estimated that the user is highly likely to cancel a job for the above-mentioned reason. At this time, the apparatus desirably executes, e.g., the all cancel mode.

Considering the fact that what is convenient for the user changes for each user, a cancel mode to be executed by the apparatus 100 may be selected from the three cancel modes by the user in advance. Alternatively, any mode may be selected from at least two of the three modes by the user in advance as a cancel mode to be executed by the apparatus 100.

The configuration which allows the user to designate a cancel mode to be executed can further improve the effects. In mode selection, the control unit 108 controls the operation unit 102 of the apparatus 100 or the display unit of an external apparatus such as the host 300 to execute a user interface window for allowing the user to execute initial settings of the box function, as shown in FIG. 34. The user can designate a desired cancel mode via the window. However, this configuration is also a requirement for further improving user merits, and is not indispensable.

Although the embodiment can be applied to an apparatus which executes any one of the three cancel modes, the following control is more desirably executed.

In the above example, the control unit 108 causes the apparatus 100 to execute a cancel process in accordance with an explicit cancel instruction which is input by the user via a user interface unit such as the operation unit 102 of the apparatus 100 or the display unit of an external apparatus such as the host 300.

According to the embodiment, the control unit 108 can control to execute the above-described cancel process under operation conditions other than the above ones. More specifically, the control unit 108 can execute the cancel process when it detects generation of any trouble in the apparatus 100.

For example, the user presses the power key 301 during a series of processes of storing, in a plurality of boxes designated by the user, job data of document E to be processed in the plural-box simultaneous storage mode. In response to this, the state of the apparatus 100 shifts from the power ON state to the power OFF state (power disconnection state). Upon detection of an event which shifts the apparatus 100 to the power disconnection state (in this example, detection of the press of the power key 301 by the user), the control unit 108 executes the job cancel process.

Alternatively, the memory of the hard disk 107 becomes full during a series of processes of storing, in a plurality of boxes designated by the user, job data of document E to be processed in the plural-box simultaneous storage mode. Upon detection of an error event in the unit of the apparatus 100 (in this example, detection of a hard disk-full error), the control unit 108 executes the job cancel process.

This control can also be adopted to prevent a situation in which the user believes that the process has been completed, but cannot obtain any desired result and is confused. This control can further enhance the above-described effects.

When the control unit 108 executes a job cancel process in accordance with an explicit cancel instruction from the user or automatically executes the job cancel process upon generation of an event in the apparatus 100 without any explicit instruction from the user, as described above, the control unit 108 controls the apparatus 100 to notify the data generation apparatus serving as a job generation source of status information to this effect.

For example, if a job of document E is canceled, the control unit 108 notifies the host 300 of information on the result of the cancel process. The control unit of the host 300 can display the information on the display unit of the host 300. For example, the control unit of the host 300 displays, on the display unit of the host 300, a message that a process of simultaneously storing job data of document E in a plurality of boxes has failed. Accordingly, the information can be fed back to the user of the host 300.

Not only when a plural-box simultaneous storage process fails but also when the process is normally completed (successful), the control unit of the host 300 may notify the data generation apparatus serving as a job input source of a message to this effect. This configuration can further improve the above effects.

However, these configurations are requirements for further improving user merits, and are not indispensable.

Points common to all the forms described above will be listed.

In the above example, a job from the host 300 is processed. However, in the data processing system according to the embodiment, the data generation apparatus is not limited to an external apparatus such as the host 300. For example, the reader unit 103 of the apparatus 100 also serves as the data generation apparatus because the reader unit 103 performs a read process for document image data, and generates job data which can be transferred to the image memory unit 107, printer unit 104, and computer interface unit 106. In addition, the reader unit 103 has, on the upper surface of the housing, the operation unit 102 (FIG. 4) corresponding to an example of the user interface of the embodiment.

The embodiment can execute the same control as the above-described control example even when image data of a job which is acquired in a read process by the reader unit 103 is saved in a plurality of boxes. A user interface used to store a scan job in a box is naturally the operation unit 102.

The user of the apparatus 100 can execute, via a box mode setting window displayed on the display unit 316 of the operation unit 102, user settings upon input to various boxes, such as a setting of whether to process job data input from the reader unit 103 in the plural-box simultaneous storage mode or single-box storage mode.

For example, after the user touches the box mode selection key in the window of FIG. 12 that is displayed on the display unit 316, the control unit 108 displays, on the display unit 316, the same list as the box selection list 1602 of the box setting window 1600 as shown in FIG. 16. The user of the apparatus 100 can select, via the box selection list displayed on the display unit 316, at least one box as a save destination of job data read by the reader unit 102. The user of the apparatus 100 can also set a series of printing conditions for job data to be stored in the box, via, e.g., a printing process condition setting window displayed on the display unit 316. When the user selects only one box via the box selection list displayed on the display unit 316, the control unit 108 determines that the single-box storage mode is selected. When the user selects a plurality of boxes via the list, the control unit 108 determines that the plural-box simultaneous storage mode is selected.

After box selection operation by the user via the operation unit 102 is done, the user inputs a job process start request via the start key 307 in FIG. 4 or the like. In accordance with the request, the control unit 108 causes the reader unit 103 to execute a read process for a target job. The control unit 108 controls to save the scan job data which is obtained by the read process and has a series of document image data, in one or a plurality of boxes designated by the user via the operation unit 102.

Control other than the above one is the same as control described in detail above (e.g., control which has been described with reference to FIGS. 6, 18 to 20, 22 to 35, and the like and is executed by the control unit 108, except control executed by the control unit of the host 30), and a description thereof will be omitted.

In this manner, the embodiment can be applied not only when data is stored in the box of the apparatus 100 from an external apparatus other than the apparatus 100, but also when a job from the data generation apparatus of the apparatus 100 is stored in a box. However, these configurations are also requirements for further improving user merits, and are not indispensable, but at least one of them is implemented.

In order to enhance various functions associated with the box function described in detail in the embodiment, the following control may be executed.

As described with reference to FIG. 34, according to the embodiment, the user can explicitly select, via the setting item 3401 of the window 3400 in FIG. 34, whether to permit or inhibit execution of the plural-box simultaneous storage mode. As another method, for example, whether to permit or inhibit execution of the plural-box simultaneous storage mode can be determined on the basis of box settings which are executed by the user when job data to be processed is input to a box.

For example, the number of data storage boxes prepared in the hard disk 107 of the apparatus 100 according to the embodiment is 100. The above example is a control example in which job data of document E is simultaneously stored in three of the 100 boxes. User needs will be examined. Although 100 boxes are prepared, there are little needs for, e.g., distributing and storing the same job data in all the 100 boxes. This operation may give some load on the apparatus in consideration of the operability of the apparatus 100, or may influence the productivity of another job. Even if the user designates the 100 boxes, the user operation may be wrong operation or a setting error by the user at high possibility.

Considering this situation, the embodiment controls to limit the number of boxes for which simultaneous storage is permitted when, e.g., a setting of storing the same job data in a plurality of boxes is made.

For example, the number of boxes which can be selected by the user via an operation window for allowing the user to select a plurality of boxes in which the same job data is to be simultaneously stored is controlled to be N at maximum. In the embodiment, the value N is at least 100 or less because the hard disk 100 prepares only 100 boxes in the embodiment.

This control will be exemplified with reference to the example in FIG. 16. For example, the number of boxes which can be selected by the user via the box selection list 1602 of the box setting window 1600 is set to five at maximum. The control unit of the host 300 controls the display unit of the host 300 to inhibit the user from selecting five or more boxes.

When scan job data from the reader unit 103 is stored in a box, the control unit 108 performs the following control. For example, when the display unit 316 displays a box selection list for prompting the user of the apparatus 100 to select and designate boxes in which scan job data from the reader unit 103 is to be saved, the number of boxes which can be selected by the user via the list is limited to five at maximum. The control unit 108 controls the control unit 108 to inhibit the user from selecting five or more boxes.

In other words, according to these control operations, execution of the plural-box simultaneous storage mode is inhibited when five or more boxes are selected.

This configuration permits execution of the plural-box simultaneous storage mode when the number of boxes selected by the user via the user interface of the data generation apparatus is five or less (e.g., three boxes are selected, similar to the above example). To the contrary, the configuration inhibits execution of the plural-box simultaneous storage mode when the number of boxes selected by the user via the user interface of the data generation apparatus is five or more. Alternatively, the configuration inhibits the user from selecting five or more boxes. Accordingly, the configuration inhibits the apparatus 100 from executing a process of simultaneously saving the same job data in five or more boxes.

The value “5” is a maximum permissible box count (N) representing the number of boxes which can be selected by the user when the same job data is simultaneously stored in a plurality of boxes. The value “5” is a concrete example of the value N, and N may be an arbitrary value other than “5”.

In order to further improve the above effects, the user may set an arbitrary value as the value N via a setting window for allowing the user to make initial settings of the box function, as shown in FIG. 34 or 35. These initial settings are more preferably made by a user (e.g., administrator) who is authorized to a certain degree.

These configurations can further enhance the above-described effects. However, these configurations are also requirements for further improving the effects, and are not indispensable.

The embodiment has mainly described the image forming apparatus 100 as an example of the data processing apparatus. In addition to an apparatus of this type, the embodiment can also be applied to the following configuration. For example, the embodiment can be applied to an apparatus which has a storage unit capable of storing data in a plurality of data boxes, can accept a process request for data in the data boxes from the user via the user interface unit of the apparatus, and can execute an output process such as a transmission process or printing process for data saved in the data boxes. Examples of this apparatus are a facsimile apparatus, cell phone, digital camera, and personal computer.

A more preferable example of this apparatus is a product which may be requested by the user to, e.g., simultaneously store job data of the same contents in a plurality of data storage boxes prepared in the storage unit of a given apparatus, and implement this by simple operation. Each box is further preferably used to save contents for different users or different purposes.

From this viewpoint, the data generation apparatuses (200, 300, 400, 500, and 600) shown in FIG. 1 and the reader unit 103 shown in FIG. 2 have mainly been explained as examples of the data generation apparatus in the embodiment, but an apparatus of another type (e.g., cell phone or digital camera) can also be applied to as the data generation apparatus. Note that the apparatus must be able to communicate data with the data processing apparatus, and must have a user interface unit which allows the user to select which of a plurality of data storage boxes prepared in the storage unit of the data processing apparatus is to save data. As described above, a more preferable apparatus is a product for which the above-mentioned user needs may arise.

The embodiment has been described in detail. The present invention can be implemented as a system, apparatus, method, program, storage medium (recording medium), or the like. More specifically, the present invention may be applied to a system including a plurality of devices or an apparatus formed by a single device.

The present invention is also achieved by supplying a software program (in the above embodiment, a program corresponding to the flowcharts shown in FIGS. 8A, 8B, and 11) for implementing the functions of the above-described embodiment to a system or apparatus directly or from a remote place, and reading out and executing the supplied program codes by the computer of the system or apparatus.

The present invention is therefore implemented by program codes installed in the computer in order to implement functional processes of the present invention by the computer. That is, the present invention includes a computer program for implementing functional processes of the present invention.

In this case, the present invention can be implemented as a program such as an object code, a program executed by an interpreter, or script data supplied to an OS as long as a program function is attained.

A recording medium for supplying the program includes a floppy® disk, hard disk, optical disk, magnetooptical disk, MO, CD-ROM, CD-R, CD-RW, magnetic tape, nonvolatile memory card, ROM, and DVD (DVD-ROM and DVD-R).

As another program supply method, the program can be supplied by connecting a client computer to an Internet Web page via the browser of the client computer, and downloading the computer program of the present invention or a compressed file containing an automatic installing function from the Web page to a recording medium such as a hard disk. The program can also be implemented by grouping program codes which form the program of the present invention into a plurality of files, and downloading the files from different Web pages. That is, the present invention also includes a WWW server which allows a plurality of users to download the program files for implementing functional processes of the present invention by a computer.

The program of the present invention can be encrypted, stored in a storage medium such as a CD-ROM, and distributed to the user. A user who satisfies predetermined conditions is prompted to download decryption key information from a homepage via the Internet. The user executes the encrypted program by using the key information, and installs the program in the computer.

The functions of the above-described embodiment are implemented when the computer executes the readout program codes. Also, the functions of the above-described embodiment are implemented when an OS or the like running on the computer performs some or all of actual processes on the basis of the instructions of the program.

The functions of the above-described embodiment are implemented when the program read out from the recording medium is written in the memory of a function expansion board inserted into the computer or the memory of a function expansion unit connected to the computer, and the CPU of the function expansion board or function expansion unit performs some or all of actual processes on the basis of the instructions of the program codes.

Concrete examples of these points have been described in relation to the printer driver of the host 300 with reference to FIGS. 13 to 17, 21, and the like.

As has been described above, the configuration of the above embodiment can solve problems assumed in the background art. For example, the embodiment can flexibly meet user needs of, e.g., distributing and storing the same job data in a plurality of boxes desired by the user among a plurality of data storage boxes prepared in the storage unit of a data processing apparatus such as an image forming apparatus. This can be implemented by simple user operation. As a result, the user can be provided with a convenient environment in which the burden on a user who utilizes the box function is minimized to improve operability while the box function is improved. For example, a job to process image data can be preferably recorded in a plurality of boxes by one job, and the amount of data recorded in each box can be reduced to efficiently use the memory. The embodiment can provide a user-friendly, convenient system which can flexibly meet various needs from various users for the box function provided by the data processing apparatus.

As described above, the present invention can improve user friendliness of the box function. The present invention can flexibly cope with a situation in which the same job data is distributed and stored in a plurality of boxes desired by the user among a plurality of boxes prepared in the storage unit of the data processing apparatus. The present invention can provide a mechanism capable of distributing and saving the same job data to a plurality of boxes desired by the user by simple operation. In addition, the present invention can minimize the burden on the user to improve operability. Further, the present invention can preferably record a job to process image data in a plurality of boxes by one job, and reduce the amount of data recorded in each box to efficiently use the memory. The present invention can provide a user-friendly, convenient system which can flexibly meet various needs from various users for the box function provided by the data processing apparatus.

The present invention is not limited to the above embodiment, and can be modified without departing from the spirit and scope of the invention. To make the scope of the present invention public, the following claims are appended.

### CLAIM OF PRIORITY

This application claims priority from Japanese Patent Application No. 2004-217773 filed on Jul. 26, 2004 and Japanese Patent Application No. 2005-196815 filed on Jul. 5, 2005, which are hereby incorporated by reference herein.

1. A job processing method for a system including a data processing apparatus having storage means capable of storing data in a plurality of data storage boxes including a first box and a second box, comprising the steps of:
when first job data transmitted from a data generation apparatus is stored in the storage means without performing any predetermined operation by a user in the data generation apparatus, permitting acceptance of a process request for the first job data from a first user via first display which is executed by user interface means and associated with the first box; and,
when the predetermined operation is performed by the user in the data generation apparatus and second job data transmitted from the data generation apparatus is stored in the storage means, permitting acceptance of a process request for the second job data from the first user via the first display which is executed by the user interface means and associated with the first box, and permitting acceptance of a process request for the second job data from a second user via second display which is executed by the user interface means and associated with the second box.

2. The job processing method according to claim 1, wherein, when the predetermined operation is performed by the user in the data generation apparatus, the second job data transmitted from the data generation apparatus is stored in the storage means, and shortcut function data for reading out entity image data of the second job that can be selected by the first user via the first display is selected by the second user via the second display, a process for the entity image data of the second job can be executed by the data processing apparatus.

3. The job processing method according to claim 1, wherein, when the predetermined operation is performed by the user in the data generation apparatus, and the second job data transmitted from the data generation apparatus is stored in the storage means, acceptance of a process request for entity image data of the second job from the first user via the first display is permitted, and acceptance of a process request for the entity image data of the second job from the second user via the second display is permitted.

4. The job processing method according to claim 1, wherein, when the first job data transmitted from the data generation apparatus is stored in the storage means without performing any predetermined operation by the user in the data generation apparatus, acceptance of a process request for entity image data of the first job from the first user via the first display is permitted, and acceptance of a process request for the entity image data of the first job from the second user via the second display is inhibited.

5. The job processing method according to claim 1, wherein,
as a process request for entity image data of the second job from the first user via the first display, acceptance of at least one of a plurality of process requests including a printing process request for the entity image data of the second job, a transmission process request for the entity image data of the second job, an erase process request for the entity image data of the second job, and a preview display process request for the entity image data of the second job is permitted, and,
as a process request for the entity image data of the second job from the second user via the second display, acceptance of at least one of a plurality of process requests including a printing process request for the entity image data of the second job, a transmission process request for the entity image data of the second job, and a preview display process request for the entity image data of the second job is permitted.

6. The job processing method according to claim 5, wherein, as a process request for the entity image data of the second job from the second user via the second display,
acceptance of at least one of a plurality of process requests including a printing process request for the entity image data of the second job, a transmission process request for the entity image data of the second job, and a preview display process request for the entity image data of the second job is permitted, and
acceptance of an erase process request for the entity image data of the second job from the second user via the second display is inhibited.

7. The job processing method according to claim 1, wherein,
when the predetermined operation is performed by the user in the data generation apparatus, and the second job data transmitted from the data generation apparatus is stored in the storage means, acceptance of a process request for entity image data of the second job from the first user via the first display is permitted, and acceptance of a process request for the entity image data of the second job from the second user via the second display is permitted, and,
when a process request for the entity image data of the second job is accepted from the first user and a process request for the entity image data of the second job is accepted from the second user, process conditions for the entity image data of the second job can be set individually for the first user and the second user.

8. The job processing method according to claim 1, wherein, when a process request for entity image data of the second job is accepted from the first user and a process request for the entity image data of the second job is accepted from the second user, a process condition which has been set in advance by the data generation apparatus for the entity image data of the second job can be utilized.

9. The job processing method according to claim 1, wherein, when a process request for entity image data of the second job is accepted from the first user and a process request for the entity image data of the second job is accepted from the second user, whether to utilize a process condition which has been set in advance by the data generation apparatus for the entity image data of the second job or to change the preset process condition can be determined individually for the first user and the second user.

10. The job processing method according to claim 1, wherein, when the predetermined operation is performed by the user in the data generation apparatus, the second job data transmitted from the data generation apparatus is stored in the storage means, and electronic copy data of entity image data of the second job that can be selected by the first user via the first display is selected by the second user via the second display, a process for the electronic copy data of the entity image data of the second job can be executed by the data processing apparatus.

11. The job processing method according to claim 10, wherein, when the predetermined operation is performed by the user in the data generation apparatus, and the second job data transmitted from the data generation apparatus is stored in the storage means, acceptance of a process request for entity image data of the second job from the first user via the first display is permitted.

12. The job processing method according to claim 10, wherein, when the first job data transmitted from the data generation apparatus is stored in the storage means without performing any predetermined operation by the user in the data generation apparatus, acceptance of a process request for entity image data of the first job from the first user via the first display is permitted, and acceptance of a process request for the entity image data of the first job from the second user via the second display is inhibited.

13. The job processing method according to claim 10, wherein,
as a process request for entity image data of the second job from the first user via the first display, acceptance of at least one of a plurality of process requests including a printing process request for the entity image data of the second job, a transmission process request for the entity image data of the second job, an erase process request for the entity image data of the second job, and a preview display process request for the entity image data of the second job is permitted, and,
as a process request for electronic copy data of the entity image data of the second job from the second user via the second display, acceptance of at least one of a plurality of process requests including a printing process request for the electronic copy data of the entity image data of the second job, a transmission process request for the electronic copy data of the entity image data of the second job, a preview display process request for the electronic copy data of the entity image data of the second job, and an erase process request for the electronic copy data of the entity image data of the second job is permitted.

14. The job processing method according to claim 1, wherein, when the predetermined operation is performed by the user in the data generation apparatus, and the second job data transmitted from the data generation apparatus is stored in the storage means, acceptance of a process request for entity image data of the second job from the first user via the first display is permitted, and acceptance of a process request for electronic copy data of the entity image data of the second job from the second user via the second display is permitted.

15. The job processing method according to claim 14, wherein, when a process request for the entity image data of the second job is accepted from the first user and a process request for the electronic copy data of the entity image data of the second job is accepted from the second user, process conditions for the entity image data of the second job can be set individually for the first user and the second user.

16. The job processing method according to claim 14, wherein, when a process request for the entity image data of the second job is accepted from the first user and a process request for the electronic copy data of the entity image data of the second job is accepted from the second user, a process condition which has been set in advance by the data generation apparatus for the entity image data of the second job can be utilized.

17. The job processing method according to claim 14, wherein, when a process request for the entity image data of the second job is accepted from the first user and a process request for the electronic copy data of the entity image data of the second job is accepted from the second user, whether to utilize a process condition which has been set in advance by the data generation apparatus for the entity image data of the second job or to change the preset process condition can be determined individually for the first user and the second user.

18. The job processing method according to claim 1, wherein,
as the first display, a list of a plurality of data on the first box among a plurality of data stored in the storage means is displayed on the user interface means, and,
as the second display, a list of a plurality of data on the second box among a plurality of data stored in the storage means is displayed on the user interface means.

19. The job processing method according to claim 18, wherein,
when the list of a plurality of data on the second box is displayed on the user interface means, an icon for shortcut function data for reading out entity image data of the second job from the storage means is displayed on the user interface means, and,
when the list of a plurality of data on the first box is displayed on the user interface means, the icon is not displayed on the user interface means.

20. The job processing method according to claim 19, wherein erase of the entity image data of the second job from the storage means on the basis of a request from the second user is inhibited, and, when the list of a plurality of data on the second box is displayed on the user interface means, display of the icon on the basis of a request from the second user is inhibited.

21. The job processing method according to claim 1, wherein,
as the first display, the user interface means executes display for allowing the first user to input an instruction to read out entity image data of the second job from the storage means, and,
as the second display, the user interface means executes display for allowing the second user to input an instruction to read out electronic copy data of the entity image data of the second job from the storage means.

22. The job processing method according to claim 1, wherein,
when as the predetermined operation, plural-box selection operation for selecting a plurality of boxes including the first box and the second box is executed by the user via the user interface of the data generation apparatus, and the second job data transmitted from the data generation apparatus is stored in the storage means of the data processing apparatus, acceptance of a process request for the second job data from the first user via the first display which is executed by the user interface means of the data processing apparatus and associated with the first box is permitted, and acceptance of a process request for the second job data from the second user via the second display which is executed by the user interface means of the data processing apparatus and associated with the second box is permitted, and,
when only the first box is selected by the user via the user interface means of the data generation apparatus without executing the plural-box selection operation, and the first job data transmitted from the data generation apparatus is stored in the storage means of the data processing apparatus, acceptance of a process request for the first job data from the first user via the first display which is executed by the user interface means of the data processing apparatus and associated with the first box is permitted.

23. The job processing method according to claim 1, wherein, when plural-box selection operation for selecting a plurality of boxes including the first box and the second box from the plurality of data storage boxes is executed by the user via the user interface means of the data generation apparatus, a plural-box simultaneous storage mode in which data on the job is saved in the storage means so as to utilize job data transmitted from the data generation apparatus in a plurality of boxes selected by the user can be executed by the data processing apparatus.

24. The job processing method according to claim 1, wherein, when box selection operation for selecting one box from the plurality of data storage boxes is executed by the user via the user interface means of the data generation apparatus, a single-box storage mode in which data on the job is saved in the storage means so as to utilize the job data transmitted from the data generation apparatus in a box selected by the user can be executed by the data processing apparatus.

25. The job processing method according to claim 23, wherein whether to execute the plural-box simultaneous storage mode can be selected.

26. The job processing method according to claim 23, wherein execution of the plural-box simultaneous storage mode is inhibited on the basis of a user setting via the user interface means.

27. The job processing method according to claim 23, wherein, when not less than a predetermined number of boxes are selected by the user via the user interface means of the data generation apparatus, execution of the plural-box simultaneous storage mode is inhibited.

28. The job processing method according to claim 23, wherein, when the plural-box simultaneous storage mode is executed, the number of boxes selectable by the user is so controlled as to be limited via the user interface means of the data generation apparatus.

29. The job processing method according to claim 23, wherein, when the plural-box simultaneous storage mode is executed, selection of not less than a predetermined number of boxes by the user is inhibited.

30. The job processing method according to claim 23, wherein, when the plural-box simultaneous storage mode is executed by the data processing apparatus, an automatic shortcut data creation mode in which entity image data of a job to be processed is saved for the first box, and shortcut function data for reading out the entity image data of the job from the storage means is saved for the second box can be executed by the data processing apparatus.

31. The job processing method according to claim 30, wherein whether to save the shortcut function data for the first box or the second box can be determined on the basis of a box selection order of the first box and the second box by the user in the data generation apparatus.

32. The job processing method according to claim 23, wherein, when the plural-box simultaneous storage mode is executed by the data processing apparatus, an automatic electronic copy data creation mode in which entity image data of a job to be processed is saved for the first box, and electronic copy data of the entity image data of the job is saved for the second box can be executed by the data processing apparatus.

33. The job processing method according to claim 32, wherein whether to save the electronic copy data of the entity image data of the job to be processed for the first box or the electronic copy data for the second box can be determined on the basis of a box selection order of the first box and the second box by the user in the data generation apparatus.

34. The job processing method according to claim 23, wherein, when the plural-box simultaneous storage mode is executed by the data processing apparatus, the data processing apparatus can selectively execute an automatic shortcut data creation mode in which entity image data of a job to be processed is saved for the first box, and shortcut function data for reading out the entity image data of the job from the storage means is saved for the second box, and an automatic electronic copy data creation mode in which electronic copy data of the entity image data of the job is saved for the second box.

35. The job processing method according to claim 23, wherein a cancel process for the job to be processed in the plural-box simultaneous storage mode can be executed before a series of data storage processes for all boxes selected by the user of the data generation apparatus are completed.

36. The job processing method according to claim 35, wherein the job cancel process can be executed in accordance with an instruction from the data generation apparatus.

37. The job processing method according to claim 35, wherein the job cancel process can be automatically executed upon generation of a trouble in the data processing apparatus.

38. The job processing method according to claim 35, wherein a process of erasing data on the job from, among a plurality of boxes selected by the user of the data generation apparatus, both of a box in which a storage process for data on the job is completed and a box in which the storage process for the data on the job is not completed can be executed as the job cancel process.

39. The job processing method according to claim 35, wherein, while leaving data on the job that exists in a box in which a storage process for the data on the job is completed among a plurality of boxes selected by the user of the data generation apparatus, a process of ending a process for the job can be executed as the job cancel process.

40. The job processing method according to claim 35, wherein a storage process for the job continues till completion of the storage process for a box in which the storage process for data on the job proceeds among a plurality of boxes selected by the user of the data generation apparatus, and upon the completion of the storage process, a process of ending a process for the job can be executed as the job cancel process.

41. The job processing method according to claim 35, wherein any mode can be selected from a plurality of cancel modes including at least any of
a first cancel mode in which a process of erasing all data on the job from, among a plurality of boxes selected by the user of the data generation apparatus, both of a box in which a storage process for data on the job is completed and a box in which the storage process for the data on the job is not completed can be executed as the job cancel process,
a second cancel mode in which, while leaving data on the job that exists in a box in which a storage process for the data on the job is completed among a plurality of boxes selected by the user of the data generation apparatus, a process of ending a process for the job can be executed as the job cancel process, and
a third cancel mode in which a storage process for the job continues till completion of the storage process for a box in which the storage process for data on the job proceeds among a plurality of boxes selected by the user of the data generation apparatus, and upon the completion of the storage process, the process of ending the process for the job can be executed as the job cancel process.

42. The job processing method according to claim 23, wherein, when a storage process for the job to be processed is completed in the plural-box simultaneous storage mode, the data generation apparatus which has transmitted the job is notified of a message representing an end of the job.

43. The job processing method according to claim 23, wherein, when a storage process for the job to be processed cannot be completed in the plural-box simultaneous storage mode, the data generation apparatus which has transmitted the job is notified of a message representing incompleteness of the job.

44. The job processing method according to claim 1, wherein the data generation apparatus includes an external apparatus other than the data processing apparatus.

45. The job processing method according to claim 1, wherein the data generation apparatus includes an apparatus mounted in the data processing apparatus.

46. The job processing method according to claim 1, wherein the data generation apparatus is an apparatus having at least data communication means, user interface means, and at least one of a document reading apparatus, a host computer, a cell phone, and a digital camera.

47. The job processing method according to claim 1, wherein the data processing apparatus is an apparatus having at least the storage means, data communication means, user interface means, and at least one of an image forming apparatus, a facsimile apparatus, a cell phone, a digital camera, and a computer.

48. The job processing method according to claim 1, wherein
the data processing apparatus is an image forming apparatus,
when the first job data transmitted from the data generation apparatus is stored in the storage means of the image forming apparatus without performing any predetermined operation by the user in the data generation apparatus, acceptance of a process request for the first job data from the first user via the first display which is executed by the user interface means of the image forming apparatus and associated with the first box is permitted, and,
when the predetermined operation is performed by the user in the data generation apparatus and the second job data transmitted from the data generation apparatus is stored in the storage means of the image forming apparatus, acceptance of a process request for the second job data from the first user via the first display which is executed by the user interface means of the image forming apparatus and associated with the first box is permitted, and acceptance of a process request for the second job data from the second user via the second display which is executed by the user interface means of the image forming apparatus and associated with the second box is permitted.

49. The job processing method according to claim 48, wherein, when plural-box selection operation for selecting a plurality of boxes including the first box and the second box from the plurality of data storage boxes is executed by the user via the user interface of the data generation apparatus, a plural-box simultaneous storage mode in which data on a job is saved in the storage means so as to utilize job data transmitted from the data generation apparatus in a plurality of boxes selected by the user can be executed by the image forming apparatus.

50. The job processing method according to claim 49, wherein the data generation apparatus includes at least one of a host computer which can communicate data with the image forming apparatus, and a document reading apparatus of the image forming apparatus.

51. A data processing system that executes a job processing method defined in claim 1.

52. A data processing apparatus that executes a job processing method defined in claim 1.

53. A computer program product incorporating a program for causing a computer to execute a job processing method defined in claim 1.

54. A computer-readable storage medium storing a computer program for causing a computer to execute a job processing method defined in claim 1.
